(19) United States
(12) Patent Application Publication
(10) Pub. No.: US 2026/0348177 A1
(43) Pub. Date: Nov. 5, 2026

(54) CONTROL SYSTEM FOR A ROBOTIC BLOCK LAYING MACHINE

(71) Applicant: Fastbrick IP Pty Ltd, High Wycombe (AU)

(72) Inventors: Paul David Lawrence HOLMES, High Wycombe (AU); Nayeem Raymond SATAR, High Wycombe (AU)

(73) Assignee: Fastbrick IP Pty Ltd, High Wycombe (AU)

(21) Appl. No.: 19/124,465

(22) PCT Filed: Oct. 25, 2023
(86) PCT No.: PCT/AU2023/051072

§ 371 Date: Apr. 25, 2025

(30) Foreign Application Priority Data
Oct. 26, 2022 (AU) 2022903173
Aug. 21, 2023 (AU) 2023902647

(51) Int. Cl. E04G 21/22; B25J 11/00; B60P 1/48; G05D 1/225; G05D 1/244; G05D 1/698; G05D 105/28; G05D 107/00; G05D 107/90; G05D 109/10

(52) U.S. Cl. CPC E04G 21/22; B25J 11/00; G05D 1/225; G05D 1/2446; G05D 1/6987; B60P 1/48; G05D 2105/28; G05D 2107/90; G05D 2107/95; G05D 2109/14

(57) ABSTRACT

A control system for a robotic block laying machine including processing devices configured to: control a shuttle to cause the shuttle to move from the base to the block laying robot via the boom to thereby transport a block to the block laying robot; control the boom to cause the boom to move the block laying robot to a position required to lay a block; control the block laying robot to cause the block laying robot to: position an end effector adjacent a distal end of the boom to receive the shuttle; position the shuttle proximate a block laying location so that the shuttle can release the block and thereby lay the block; position the end effector adjacent the distal end of the boom to allow the shuttle to return to the boom; and, control the shuttle to cause the empty shuttle to return along the boom to the base.

### PRIORITY DOCUMENTS

The present application claims priority from Australian Provisional Application No. 2022903173 titled “ROBOTIC CONSTRUCTION MACHINE” and filed on 26 Oct. 2022 and Australian Provisional Application No. 2023902647 titled “ROBOTIC CONSTRUCTION MACHINE” and filed on 21 Aug. 2023, the content of which is hereby incorporated by reference in its entirety.

### BACKGROUND OF THE INVENTION

The present invention relates to a control system for a robotic block laying machine used in constructing a block structure.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Autonomous and semi-autonomous industrial robotic equipment is increasingly being used in outside work environments such as on construction sites, building sites, mining sites, and industrial sites. For example, WO 2007/076581 describes an automated brick laying system for constructing a building from a plurality of bricks comprising a robot provided with a brick laying and adhesive applying head, a measuring system, and a controller that provides control data to the robot to lay the bricks at predetermined locations. The measuring system measures in real time the position of the head and produces position data for the controller. The controller produces control data on the basis of a comparison between the position data and a predetermined or pre-programmed position of the head to lay a brick at a predetermined position for the building under construction. The controller can control the robot to construct the building in a course-by-course manner where the bricks are laid sequentially at their respective predetermined positions and where a complete course of bricks for the entire building is laid prior to laying of the bricks for the next course.

In Applicant's earlier publication WO2018/009981, there is provided a self-contained truck-mounted brick laying machine. A truck supports the brick laying machine which is mounted on a frame on the truck chassis. The frame supports packs or pallets of bricks loaded into the machine into loading bays. Dehacker robots then dehack (i.e. remove) entire rows of bricks from the pallets and place them onto a platform. A transfer robot can then pick up an individual brick from the platform and move it to, or between either a saw or a router or a carousel. The carousel is located coaxially with a tower, at the base of the tower. The carousel transfers the brick via the tower to a boom comprising articulated telescopic boom and stick elements. The bricks are conveyed through the articulated and telescoping boom by linearly moving shuttles in each element, to reach a brick laying and adhesive applying head where the brick is transferred to a gripper of a laying robot and laid in accordance with a build datafile. The machine described in WO2018/009981 has a laying rate of approximately 180-240 bricks per hour.

In the above-described arrangement, an individual block is transferred between many modules which each clamp the block resulting in the block being handled many times prior to laying. It would be desirable to reduce the number of handling operations in order to improve reliability of the machine.

It is also desirable to simplify the overall architecture of the machine and increase the laying rate and ability of the machine to operate at more building sites. It would also be desirable for the machine to be capable of transporting other building elements such as tiles for roofing or flooring.

### SUMMARY OF THE PRESENT INVENTION

In one broad form, an aspect of the present invention seeks to provide a control system for a robotic block laying machine used in constructing a block structure, the robotic block laying machine including a plurality of shuttles that transport blocks from a base of the machine to a block laying robot via a boom, the control system including one or more processing devices configured to: control a shuttle to cause the shuttle to move from the base to the block laying robot via the boom to thereby transport a block to the block laying robot; control the boom to cause the boom to move the block laying robot to a position required to lay a block; control the block laying robot to cause the block laying robot to: position an end effector adjacent a distal end of the boom to receive the shuttle; position the shuttle proximate a block laying location so that the shuttle can release the block and thereby lay the block; and, position the end effector adjacent the distal end of the boom to allow the shuttle to return to the boom; and, control the shuttle to cause the empty shuttle to return along the boom to the base.

In one embodiment, the shuttles travel along tracks disposed between the base and block laying robot.

In one embodiment, the tracks comprise send and return tracks to accommodate shuttles travelling to the block laying robot and returning to the base.

In one embodiment, the tracks comprise fixed and movable track sections.

In one embodiment, the movable track sections comprises tracks that one of translate or rotate.

In one embodiment, the one or more processing devices includes a: central controller configured to manage a schedule of jobs that the robotic block laying machine is required to perform for a given build; and, a shuttle fleet controller that: communicates with the central controller including: receiving instructions indicative of job requests for shuttles; and, providing shuttle status information to the central controller; and, communicates wirelessly with each shuttle in the fleet including: sending instructions to a shuttle to perform the job requested by the central controller; and, receiving status information from the shuttle.

In one embodiment, the one or more processing devices further include at least one shuttle controller provided in each shuttle, the at least one shuttle controller being configured to control the shuttle in accordance with commands from the shuttle fleet controller.

In one embodiment, the at least one shuttle controller is configured to control a drive system on-board the shuttle to execute a movement request.

In one embodiment, the at least one shuttle controller is configured to manage charging of batteries on-board the shuttle and report charge status information to the shuttle fleet controller.

In one embodiment, the at least one shuttle controller is configured to cause clamps to open or close in accordance with instructions received from the shuttle fleet controller.

In one embodiment, the at least one shuttle controller causes status information to be provided to the shuttle fleet controller.

In one embodiment, the control system includes sensors that detect a position of the shuttle in the machine, and wherein the one or more processing devices are configured to control the shuttles in accordance with signals from the sensors.

In one embodiment, the sensors are distributed along the tracks and used to confirm a presence of a shuttle at a designated location.

In one embodiment, each shuttle further includes one or more sensors for use in referencing a shuttle position along the track, the sensors detecting striker targets distributed along the track wherein the detection causes the shuttle controller to capture an encoder position of a shuttle drive motor.

In one embodiment, the one or more sensors are one of: an inductive proximity sensor on each shuttle that detects metallic striker targets installed along the track, and, an optical sensor on each shuttle that detects reflective striker targets installed along the track.

In one embodiment, status information including shuttle position is sent from each shuttle to the shuttle fleet controller which provides this information to the central controller to enable it to coordinate movement of track sections and other modules of the machine.

In one embodiment, the shuttle further includes: a wireless transmitter used to send the status signal to the shuttle fleet controller over a wireless communication network such as Wi-Fi; and, a wireless receiver used to receive commands from the shuttle fleet controller over a wireless communications network such as Wi-Fi.

In one embodiment, the shuttle reports its position to the shuttle fleet controller as distance travelled relative to the last position reference it captured.

In one embodiment, each position reference has a unique identifier and wherein when the central controller issues a job request for a shuttle to move from its current position to a final position, the central controller provides to the shuttle fleet controller a list of position reference identifiers including a starting position reference identifier, a requested final position reference identifier and any intermediate position reference identifiers that the shuttle will detect between its current position and its requested final position.

In one embodiment, during movement, the shuttle controller tracks which position reference identifier was most recently detected and the list of position reference identifiers it is expected to detect whilst completing a current movement request.

In one embodiment, the one or more processing devices further include: a boom controller configured to control the boom in accordance with commands from the central controller; and, a block laying robot controller configured to control the block laying robot in accordance with commands from the central controller.

In one embodiment, the one or more processing devices are configured to control at least one transfer robot to: pick individual blocks from a pack of blocks; and transfer each block to a respective one of the plurality of shuttles located at a loading position in a base of the machine.

In one embodiment, a pair of transfer robots are provided to concurrently pick blocks from packs and transfer them to shuttles.

In one embodiment, the one or more processing devices include a transfer robot controller configured to control the transfer robot in accordance with commands from the central controller.

In one embodiment, the one or more processing devices are configured to control a plurality of pack conveyers that move packs of blocks forward in the base of the machine to an empty pack station.

In one embodiment, the one or more processing devices include a pack conveyer controller configured to control the pack conveyers in accordance with commands from the central controller.

In one embodiment, the one or more processing devices are configured to control a shuttle sequencing system provided in the base of the machine, the shuttle sequencing system including a shuttle storage bay including multiple levels of tracks on which shuttles are driven and stored when not in use; one or more shuttle elevators controlled to move shuttles to a different level track of the storage bay; and, a shuttle translator controlled to move shuttles into and out of the shuttle storage bay.

In one embodiment, the one or more processing devices include: at least one shuttle elevator controller configured to move a shuttle between levels of the storage bay in accordance with commands from the central controller; and, a shuttle translator controller configured to move shuttles into and out of the storage bay.

In one embodiment, the robotic block laying machine includes: a tower rotatably mounted to the base about a boom slew axis, the tower supporting the boom and wherein the boom is pivotally connected to the tower; and, a carousel aligned concentrically with the boom slew ring at the base of the tower, the carousel being rotatable about the tower and including a plurality of radially spaced apart carousel rotators, each configured with two pairs of tracks, wherein the control system is configured to control the rotators to: receive a loaded shuttle from the shuttle translator and enable the loaded shuttle to drive onto a tower track section; and, receive an empty shuttle from a tower track section and enable the empty shuttle to drive onto the shuttle translator.

In one embodiment, the one or more processing devices include: a carousel slew controller configured to control rotation of the carousel about the tower; and; one or more carousel rotator controllers configured to control rotation of the carousel rotators to enable transfer of shuttles between the carousel and tower and shuttle translator respectively.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:

FIG. 1A is a schematic perspective view of an example of a vehicle which incorporates a robotic block laying machine in a transport configuration;

FIG. 1B is a schematic perspective view of the vehicle of FIG. 1A in a deployed configuration constructing the wall of the building;

FIG. 1C is a schematic rear perspective view of the vehicle of FIG. 1B in a deployed configuration;

FIG. 1D is a further schematic rear perspective view of the vehicle shown in FIG. 1B showing transfer robots picking up blocks from pallets;

FIG. 1E is a schematic perspective view inside the base of the vehicle of FIG. 1B showing a transfer robot loading a block onto a shuttle;

FIG. 1F is a schematic perspective view inside the base of the vehicle of FIG. 1B showing shuttles on a carousel adjacent the tower;

FIG. 1G is schematic perspective view of the machine of FIG. 1B showing a shuttle travelling along a boom towards the block laying robot;

FIG. 2 is a schematic perspective view of a truck chassis used by the vehicle of FIG. 1A;

FIG. 3A is an underside schematic perspective view of a support frame of the vehicle of FIG. 1A;

FIG. 3B is a top view of the support frame of FIG. 3A;

FIG. 3C is a schematic perspective view of the support frame of FIG. 3A with skin panels and doors installed;

FIG. 4A is a schematic perspective view of the vehicle of FIG. 1B showing jacks deployed on a road side of the vehicle;

FIG. 4B is a detailed schematic perspective view of rear outriggers and jacks shown in FIG. 4A;

FIG. 4C is a schematic perspective view of the vehicle of FIG. 4A showing outriggers deployed on a building side of the vehicle;

FIG. 5A is schematic perspective view of a pack conveyer;

FIG. 5B is a schematic top view of series of pack conveyers;

FIG. 5C is a detailed schematic perspective view of the transition between adjacent pack conveyers;

FIG. 5D is a rear schematic perspective view showing a pack conveyer installed in the base of the vehicle of FIG. 1B;

FIG. 6A is a schematic perspective view of a pallet ejector;

FIG. 6B is a schematic rear perspective view of the pallet ejector of FIG. 6A;

FIG. 6C is a detailed schematic perspective view of the pallet ejector of FIG. 6A;

FIG. 6D is schematic front view of the pallet ejector of FIG. 6A;

FIG. 6E is a rear schematic perspective view showing the pallet ejector of FIG. 6A installed in the base of the vehicle of FIG. 1B;

FIG. 6F is a schematic perspective view of the pallet ejector of FIG. 6A in operation clamping an empty pallet;

FIG. 6G is a schematic perspective view of the pallet ejector of FIG. 6A lifting an empty pallet;

FIG. 7A is a schematic perspective view of a transfer robot;

FIG. 7B is a further schematic perspective view of the transfer robot of FIG. 7A;

FIG. 7C is a schematic perspective view of the transfer robot of FIG. 7A in a raised position;

FIG. 7D is a detailed schematic perspective view of the clamp assembly of a transfer robot arm of the transfer robot of FIG. 7A;

FIG. 7E is schematic perspective view of the transfer robot arm;

FIG. 7F is a further schematic perspective view of the transfer robot arm;

FIG. 7G is a schematic perspective view of two transfer robots operating in the base of the vehicle of FIG. 1B;

FIG. 7H is a schematic perspective view of the transfer robot placing a block into a saw module in the base of the vehicle of FIG. 1B;

FIG. 8A is a schematic perspective view of an example of a shuttle for transporting a block through the machine;

FIG. 8B is a schematic perspective view of the shuttle of FIG. 8A clamping a block;

FIG. 8C is a schematic side view of the shuttle of FIG. 8A;

FIG. 8D is a schematic top view of the shuttle of FIG. 8A;

FIG. 8E is a schematic bottom view of the shuttle of FIG. 8A;

FIG. 8F is a detailed schematic perspective view of the shuttle of FIG. 8A showing a drive assembly;

FIG. 8G is a detailed schematic perspective view of the shuttle of FIG. 8A showing a front wheel assembly;

FIG. 8H is a schematic perspective view of the front wheel assembly of the shuttle of FIG. 8A;

FIG. 8I is a schematic perspective view of a clamp assembly of the shuttle of FIG. 8A;

FIG. 8J is a schematic underside perspective view of the clamp assembly of FIG. 8I;

FIG. 8K is a schematic perspective view of the shuttle of FIG. 8A with the clamp assembly in an offset position;

FIG. 8L is a schematic underside perspective view of the shuttle of FIG. 8K;

FIG. 9A is a schematic perspective view of a shuttle sequencing system;

FIG. 9B is a schematic perspective view of a rear shuttle elevator of the shuttle sequencing system of FIG. 9A;

FIG. 9C is a schematic perspective view of a front shuttle elevator of the shuttle sequencing system of FIG. 9A;

FIG. 9D is a schematic perspective view of a shuttle translator of the shuttle sequencing system of FIG. 9A;

FIG. 9E is a schematic side view of the shuttle translator of FIG. 9D;

FIG. 9F is a schematic rear perspective view of the shuttle translator of FIG. 9D;

FIG. 9G is a schematic rear side perspective view of a shuttle storage bay of the shuttle sequencing system of FIG. 9A;

FIG. 9H is a schematic side view of the shuttle storage bay of FIG. 9G;

FIG. 9I is a schematic rear view of the shuttle storage bay of FIG. 9G;

FIG. 9J is a detailed schematic perspective view of the shuttle storage bay of FIG. 9G;

FIG. 9K is a schematic perspective view of the shuttle translator aligned with the carousel;

FIG. 9L is a schematic perspective view of a shuttle driving from the shuttle translator onto a carousel rotator;

FIG. 10A is a schematic perspective view of a carousel;

FIG. 10B is a schematic underside perspective view of the carousel of FIG. 10A;

FIG. 10C is a schematic perspective view of a loaded shuttle on the carousel in a carousel rotator;

FIG. 10D is a schematic perspective view of a carousel rotator aligned with tower tracks on the tower;

FIG. 11A is a schematic perspective view of a tower;

FIG. 11B is a further schematic perspective view of the tower of FIG. 11A;

FIG. 11C is a schematic perspective view of a shuttle on tower tracks proximate a tower rotator;

FIG. 11D is a schematic perspective view of a shuttle being rotated in the tower rotator;

FIG. 11E is a schematic perspective view of the tower rotator rotating into alignment with the boom;

FIG. 12A is a schematic side view of a boom system of the vehicle of FIG. 1A;

FIG. 12B is a schematic perspective view of the boom system of the vehicle of FIG. 1A;

FIG. 12C is a further schematic perspective view of the boom system of the vehicle of FIG. 1A;

FIG. 13A is a schematic perspective view of a first boom element of the boom system of FIG. 12A;

FIG. 13B is a further schematic perspective view of the first boom element of FIG. 13A;

FIG. 13C is a schematic front view of the first boom element of FIG. 13A;

FIG. 13D is a detailed schematic perspective view of a proximal end of the first boom element of FIG. 13A;

FIG. 13E is a detailed schematic perspective view of a distal end of the first boom element of FIG. 13A;

FIG. 14A is a schematic perspective view of a second boom element of the boom system of FIG. 12A;

FIG. 14B is a detailed schematic perspective view of a proximal end of the second boom element of FIG. 14A;

FIG. 14C is a detailed schematic perspective view of a distal end of the second boom element of FIG. 14A;

FIG. 14D is a further detailed schematic perspective view of a distal end of the second boom element of FIG. 14A showing a shuttle travelling along a top track thereof;

FIG. 14E is a further detailed schematic perspective view of a distal end of the second boom element of FIG. 14A showing a shuttle travelling along a top track thereof;

FIG. 14F is a schematic rear view of the second boom element of FIG. 14A;

FIG. 14G is a further schematic rear view of the second boom element of FIG. 14A showing a loaded shuttle on a top track and an empty shuttle on a bottom track thereof;

FIG. 14H is a further detailed schematic perspective view of a proximal end of the second boom element of FIG. 14A;

FIG. 14I is a schematic perspective view of a luff rotator;

FIG. 15A is a schematic perspective view of a first stick element of the boom system of FIG. 12A;

FIG. 15B is a detailed schematic underside perspective view of a proximal end of the first stick element of FIG. 15A;

FIG. 15C is a detailed schematic perspective view of the luff joint between the second boom element and the first stick element in a folded configuration;

FIG. 15D is a schematic perspective view of the distal end of the first stick element of FIG. 15A;

FIG. 16A is a schematic perspective view of a second stick element of the boom system of FIG. 12A;

FIG. 16B is a detailed schematic perspective view of a proximal end of the second stick element of FIG. 16A;

FIG. 16C is a detailed schematic perspective view of a distal end of the second stick element of FIG. 16A;

FIG. 17A is a schematic perspective view of a laying head of the vehicle of FIG. 1B;

FIG. 17B is a schematic top view of the laying head of FIG. 17A;

FIG. 17C is a detailed schematic perspective view of the bottom of a support tower of the laying head of FIG. 17A;

FIG. 17D is a further detailed schematic perspective view of the bottom of the support tower of the laying head of FIG. 17A;

FIG. 17E is a detailed underside schematic perspective view of the laying head of FIG. 17A showing track sections associated therewith;

FIG. 17F is an upper schematic perspective view of the laying head of FIG. 17A;

FIG. 17G is a schematic perspective view of a shuttle rotator of the laying head of FIG. 17A;

FIG. 17H is a schematic perspective view of a block laying robot of the laying head of FIG. 17A;

FIG. 17I is a further schematic perspective view of the block laying robot of FIG. 17H;

FIG. 17J is a schematic perspective view of a laying wrist of the block laying robot of FIG. 17H;

FIG. 17K is a further schematic perspective view of the laying wrist of the block laying robot of FIG. 17H;

FIG. 17L is a schematic perspective view of an end effector of the block laying robot of FIG. 17H;

FIG. 17M is a schematic perspective rear view of the end effector of FIG. 17L;

FIG. 18A is a schematic perspective view of an adhesive application system which forms part of the laying head of FIG. 17A;

FIG. 18B is a further schematic perspective view of the adhesive application system of FIG. 18A;

FIG. 18C is a schematic front view of the adhesive application system of FIG. 18A;

FIG. 19A is a schematic perspective view of a saw module of the vehicle of FIG. 1A;

FIG. 19B is a further schematic perspective view of the saw module of FIG. 19A;

FIG. 19C is a schematic perspective view of the saw module of FIG. 19A with some skin panels removed for clarity;

FIG. 19D is a further schematic perspective view of the saw module of FIG. 19A with some skin panels removed for clarity;

FIG. 19E is a schematic perspective view of a first block translator of the saw module of FIG. 19A;

FIG. 19F is a schematic top view of the first block translator of FIG. 19E;

FIG. 19G is a schematic perspective view of a block flipping mechanism of the saw module of FIG. 19A;

FIG. 19H is a further schematic perspective view of the block flipping mechanism of FIG. 19G;

FIG. 19I is a schematic perspective view of a second block translator in use pushing a block against a fence of the saw module whilst a block is being cut;

FIG. 20 is a schematic diagram of an example of a control system for use in controlling a fleet of shuttles used in the robotic block laying machine; and,

FIG. 21 is a schematic diagram of an example of a control system for use in controlling the robotic block laying machine.

### DETAILED DESCRIPTION OF THE PREFERRED EMBODIMENTS

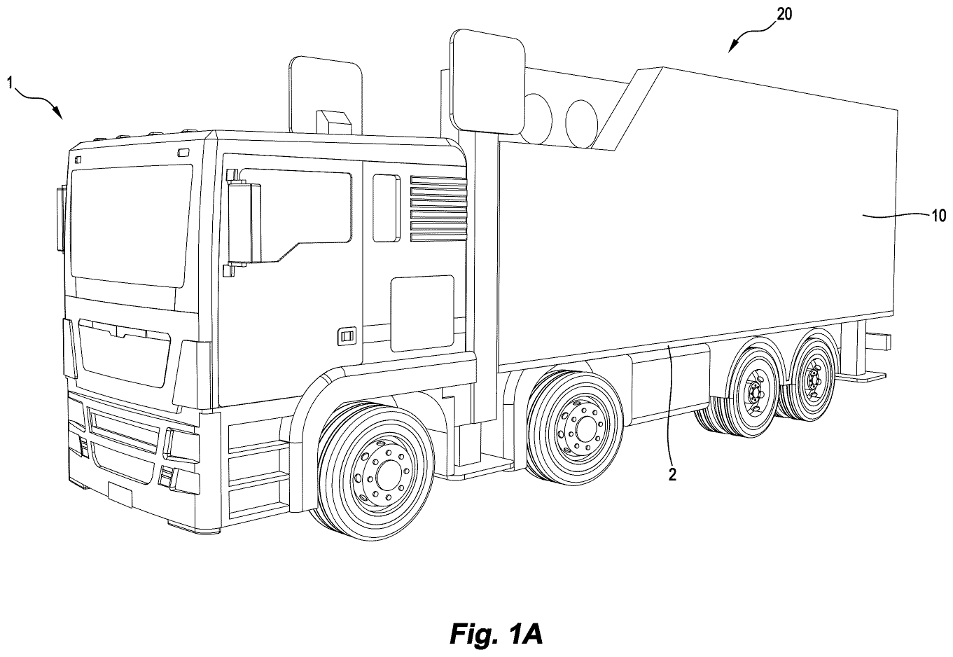

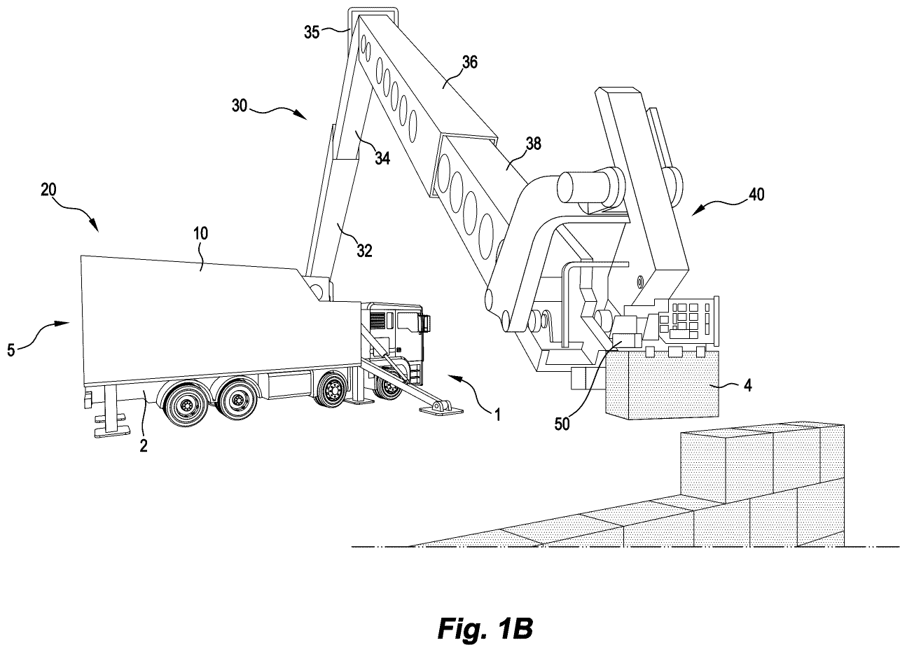

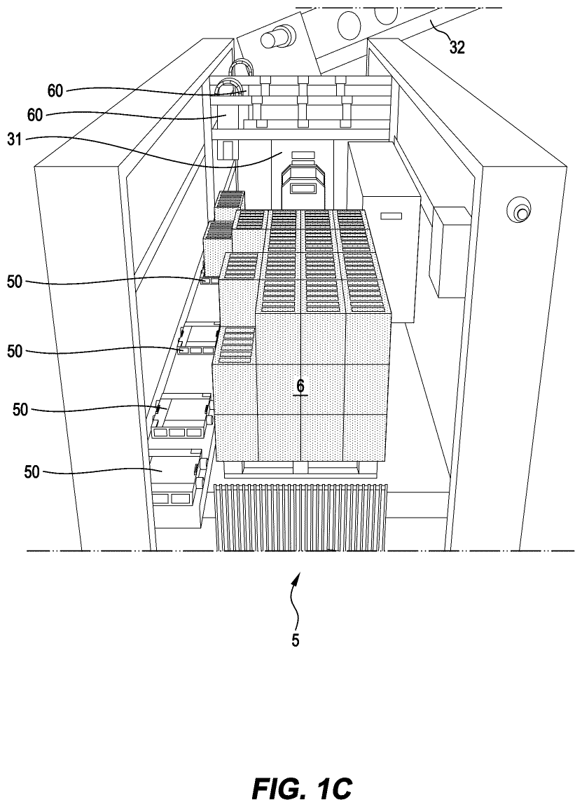

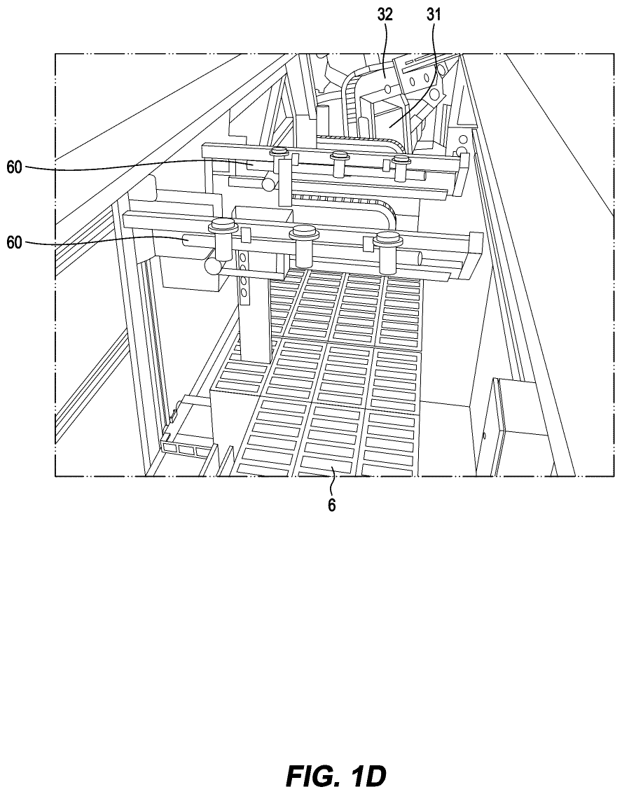

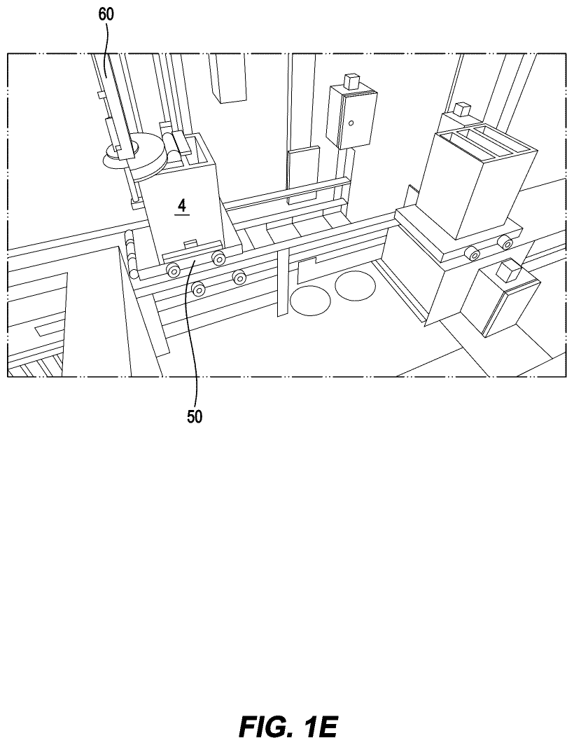

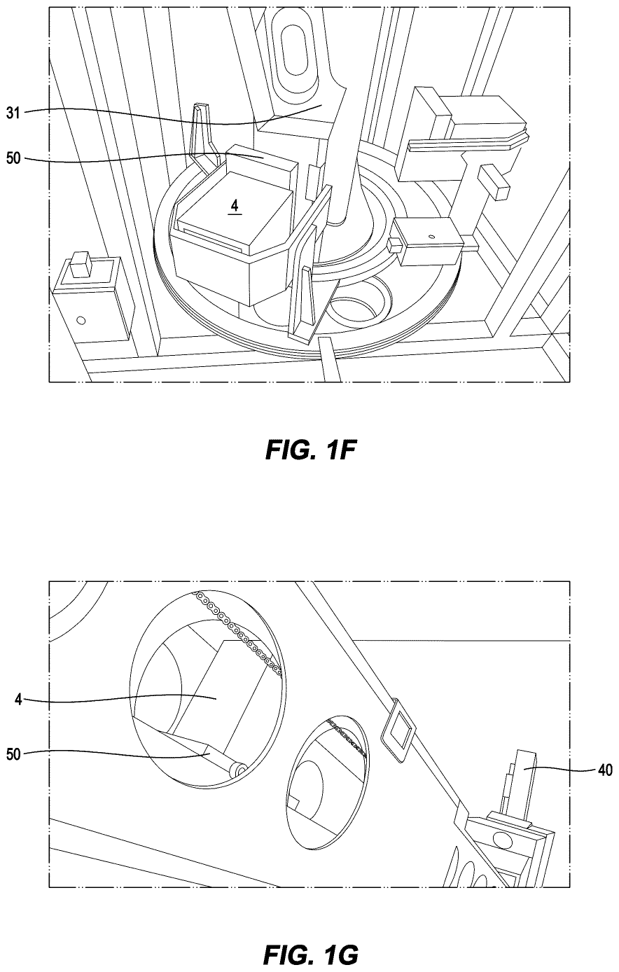

An example of a vehicle 1 which incorporates a robotic block laying machine 20 for use in constructing a block structure shall now be described with reference to FIGS. 1A to 1G.

The term “block” used herein is a piece of material, typically in the form of a polyhedron, such as a cuboid having six quadrilateral and more typically substantially rectangular faces. The block is typically made of a hard material and may include openings or recesses, such as cavities or the like. The block is configured to be used in constructing a structure, such as a building or the like and specific example blocks include bricks, besser blocks, concrete masonry units or similar. The term “block” should also be taken to include other unitary solid building elements such as roof tiles for use in constructing a roof and pavers for use in constructing an exterior flooring. Although the description below describes constructing a wall from blocks, it should be appreciated that other building elements such as roof tiles and pavers may also be transported through the machine.

In this example, the vehicle 1 includes a vehicle chassis 2, a support frame 10 mounted to the chassis 2 and a robotic block laying machine 20 mounted from the support frame 10. The support frame 10 is typically a framework capable of structurally supporting the machine 20 and may include a base frame and side frame components that support parts of the machine 20. The support frame 10 may further include skin panels that substantially cover the machine and assist in protecting internal components of the machine from rain, wind, dust, sunlight and other environmental elements. The skin panels also provide a guard to protect people from hazards. In one example, the support frame 10 is a large weldment. It is built in three major parts (base frame and opposing side frames) which are machined and then welded to form one part. In a complete kit knockdown (CKD) form for global shipping, it could be built in smaller parts that bolt together to fit in shipping containers. However, in driveaway form, it is more efficient to build it as a single welded structure.

The vehicle 1 is typically in the form of a rigid body truck which enables the robotic block laying machine 20 to be mobile and driven to and from building sites on roads. In examples, the vehicle 10 is an 8×8, 8×6 or 8×4 rigid body truck manufactured for example by Mack, Volvo, Mercedes, Iveco, MAN, Isuzu or Hino. The truck has a typical driver's cabin. In an alternative arrangement, a semi-trailer intended for connection to a prime mover using a fifth wheel, may be used instead of a rigid body truck. Alternatively, the vehicle may include a trailer. In one example, the vehicle is an 8×4 Isuzu FYJ-350 XLWB which provides a wheelbase long enough to provide spacious packaging for the machine components and ease of access thereto. In another example, the vehicle is a Mack TerraPro.

The above described vehicle can be used to support and transport a robotic block laying machine, which may therefore be integrated with the vehicle. However, it will be appreciated from the following that this is not essential, and the robotic blocking laying machine described in more detail below may not be incorporated in a vehicle. For example, the robotic block laying machine could be provided in a shipping container or other similar form factor, and transported to site using a separate vehicle, with the robotic block laying machine then being positioned on a site and used as needed. Accordingly, throughout the following description, reference to a vehicle should be interpreted as one embodiment in which the robotic block laying machine is incorporated into a vehicle, but this should not be seen as an essential or the only possible implementation, and reference to a vehicle should not be construed as limiting.

The robotic block laying machine 20 includes a base 5, which can receive blocks, for example packs 6 of blocks. The base 5 further includes at least one transfer robot 60 configured to pick an individual block, for example retrieving this directly from a pack 6 of blocks. The base of the machine is typically an area of the machine that sits above the chassis of the truck. Transfer robot 60 is defined as a robot in the base of the machine that interfaces with the blocks for example to pick up blocks from packs and transfer them to and from other modules in the base.

The machine 20 further includes a boom system including a boom 30, which may comprise a plurality of telescopic boom 32, 34 and stick 36, 38 elements having at least one pivot joint 35 therebetween, although other suitable arrangements could be used. A tower 31 is rotatably mounted about a boom slew axis in the base 5 for supporting the boom 30 and wherein the boom 30 is pivotally connected to the tower 31. A block laying robot 40, optionally forming part of a laying head, can be mounted at a distal end of the boom for laying a block delivered via the boom 30. In the example shown, the boom 30 has four elements comprising two boom and two stick elements and the reach of the boom is 32 m allowing it to operate up to a build height of three stories, although it will be appreciated that other configurations could be used. In other examples, the boom may have a reach at full extension of one of: 24-25 m, 25-26 m, 26-27 m, 27-28 m, 28-29 m, 29-30 m, 30-31 and 31-32 m.

A plurality of shuttles 50 are provided, which are optionally storable in the base 5, wherein each shuttle 50 is configured to receive a block from the at least one transfer robot 60 and transport the block from the base 5 to the block laying robot 40 along the boom system. In one example, the shuttles move through the boom, although this is not essential and alternatively the shuttles could move along an outside of the boom.

Accordingly, the shuttles function as delivery vehicles which transport a block through the system in a continuous manner. A single shuttle is able to take a block from the base of the robotic block laying machine to the block laying robot without handing the block to any other mechanism. To achieve this the shuttles can be configured to clamp a block during transport and then unclamp the block and release it on to a wall being built. Block handovers in the machine are therefore greatly reduced which improves overall reliability of the machine. In an alternative arrangement, the block laying robot may have a gripper which clamps a block received from a shuttle at the laying head.

In one example, the shuttles travel along a semi-continuous path through the machine, with loaded delivery shuttles travelling from the base to the block laying robot and empty return shuttles travelling back from the block laying robot to the base. The shuttles typically drive on tracks that are distributed through the machine. Tracks are either static (i.e. fixed) track sections or movable track sections (e.g. in the form of elevators, translators or rotators). The shuttles may have a self-contained power source such as batteries or alternatively the tracks may be electrified and provide power to the shuttles.

In one example, the shuttles are semi-autonomous with their own on-board logic, sensors, actuators, battery power, battery management and charging, wireless communication and drive system. A central machine controller or dedicated shuttle fleet controller typically coordinates shuttle movements and individual shuttles control their own functions. In some examples, the machine may include between twenty (20) and thirty (30) shuttles in order to achieve a target laying rate in excess of 350 blocks per hour.

A number of further features will now be described.

As mentioned above, the base can be configured to receive one or more packs of blocks and wherein the at least one transfer robot is configured to pick one of the blocks from a pack of blocks. In this example, typically, packs of blocks are arranged in single file in the base of the machine at designated pack stations which allows packs up to 1200 mm wide to be used to accommodate large format blocks up to 600 mm long and 300 mm wide. By contrast, Applicant's earlier machine was able to accommodate packs up to 1000 mm wide. Blocks are loaded into the machine from the rear of the truck. In some examples, a pack of blocks is provided on a wooden (or other material) pallet on which blocks are stacked. Packs of blocks are fed into the machine on pack conveyer modules which operate to move packs forwards to an empty pack station. In the example shown, there are at least three pack conveyers although other configurations of the machine may provide up to five pack conveyers. Accordingly, the machine is designed to accommodate at least three and up to five packs of blocks in use. Typically, if the machine additionally includes a saw module, then only three pack conveyers will be implemented.

In one example, each pack conveyer module is a chain conveyer including a base frame and a drive assembly including a plurality of chains extending the length of the base frame between a pair of shafts and spaced apart across the width of the base frame, wherein the chains are driven by a motor coupled to one of the shafts. Each pack conveyer module uses a number of chains. However, this eliminates the need to provide a conveyer with custom rollers and provides smoother motion to a pack not on a pallet.

Different types of blocks may be loaded into the machine simultaneously and consumed at different rates. This means that a pack at the front may be used up, then requiring the pallet to be removed so that the other packs can be moved forward. For this reason, the pack conveyer is implemented as sections that are just longer than one pack. Each module has its own electronic control which allows each module to be tested individually and changed out as a Line Replaceable Unit (LRU).

Where blocks come stacked on pallets, empty pallets are typically removed from a pack conveyer module by a pallet ejector robot that picks up an empty pallet and moves it to a pallet storage location for removal from the base and/or vehicle. In one example, the pallet ejector robot is operable to lift an empty pallet above an adjacent pack of blocks and transport the empty pallet to the rear of the base and/or vehicle where it is placed onto a pallet tray disposed between opposing side frames of the base and/or vehicle.

In one example, the pallet ejector robot includes a carriage support slidably mounted to a frame, such as a side frame of the vehicle or base for longitudinal travel therealong; and, a carriage slidably mounted to the carriage support for travel up and down the carriage support, for example in a vertical or substantially vertical direction. The carriage includes a body arranged for travel along the carriage support; and, an engagement means slidably mounted to the carriage for lateral travel towards and away from the carriage support, wherein in operation an empty pallet is secured by the engagement means and is picked up and moved to the pallet storage location.

Different pallet configurations may require different engagement means to pick up the pallet. In one example, the engagement means is a wedge clamp having a mouth which engages a portion of the pallet whilst in another example the engagement means is a vacuum gripper which engages the pallet through suction. Alternatively, a clamp gripper may be provided with jaws that clamp around the pallet.

The pallet ejector robot is typically a cartesian robot providing linear motion in the X, Y, and/or Z directions that picks an empty pallet and moves it to an empty pallet storage station. It needs to be able to move an empty pallet around full packs of blocks. The high-speed laying and the large blocks used result in a rapid cycle time for the pallets. The packs are delivered and empty pallets are removed by a telehandler. To reduce the number of telehandler cycles it is desirable for the empty pallets to be stacked so that the telehandler can remove a stack of empty pallets rather than single pallets.

As previously discussed, the machine includes at least one transfer robot configured to pick an individual block directly from a pack of blocks.

The transfer robot picks a block from a pack of blocks and loads the block onto a shuttle, or it places the block into the saw (if a saw module is included). The transfer robot also picks a block from the saw and loads it onto a shuttle. The transfer robot has a vision system to detect the location of blocks in the pack. In one example, the transfer robot has the highest cycle time of all modules and can be a key driver of production process speed as it has to move a lot to complete its tasks. Accordingly, to increase productivity and avoid bottlenecks preferably there are two transfer robots. The independent continuous shuttle arrangement facilitates parallel operation of the transfer robots by allowing each transfer robot to load a shuttle simultaneously. To avoid collisions, the transfer robots are fitted with physical stops between each other and proximity sensors to detect each other and prevent motion toward each other that would otherwise cause a collision. They may also have software interlocks and/or logic to prevent collisions.

The transfer robot uses linear orthogonal (cartesian) axes for its primary motion. The linear axes provide consistent dynamics and allow for fast motion. No kinematic transformation is required. To obtain the required Z axis motion (i.e. vertical direction), in one example the Z axis is telescopic.

In one example, the transfer robot includes a column support slidably mounted to a frame, such as a side frame of the vehicle and/or base, for longitudinal travel therealong; a beam slidably mounted at one end to the column support for travel up and down the column support, for example in a vertical or substantially vertical direction. A carriage is slidably mounted to the beam for lateral movement thereacross; and an arm is slidably mounted to the carriage for vertical movement up and down, wherein the arm includes a gripping mechanism at a distal end thereof for picking up a block from a pack.

Typically, the gripping mechanism includes a pair of gripper fingers configured to grip an internal core of a block wherein the gripper fingers are opened and closed via a linear actuator, such as a rack and pinion drive. The gripping mechanism includes a body rotatable about an axis of rotation aligned with a longitudinal axis of the arm to provide the arm with ability to rotate a block held by the gripper fingers. In other arrangements, the gripper may be a vacuum gripper configured to pick up a block (e.g., without cores) by applying a suction force to a surface of the block.

As mentioned, in one example the arm is telescopic. Typically, the telescopic arm includes a first arm element and a second arm element slidable relative thereto along tracks mounted to the first arm element. The first and second arm elements are slidably coupled by a pulley driven belt, wherein pulleys are coupled to the first arm element and the belt is clamped to the second arm element. In this example, the first arm element is driven up and down relative to the carriage by a rack and pinion drive and movement of the first arm element results in concurrent telescopic movement of the second arm element relative thereto. However, it will be appreciated that other arrangements, such as linear actuators could be used.

In order to locate blocks on a pack for picking, the transfer robot typically includes a vision system mounted to the beam for imaging blocks on a pack and one or more light sources to provide a uniform illumination of the blocks. Preferably, the one or more light sources include a flash able to overpower sunlight and any other ambient light. The flash provides at least one and preferably two orders of magnitude higher illumination than sunlight in order to ensure sufficient contrast is achieved so that vision system can detect edges of blocks. In other words, the flash units are approximately 10 to 100 times brighter than sunlight. In one example, the flash is an ultrabright Xenon flash.

In one example, the illumination surface area is approximately 450×700 mm with an irradiance of 2000 W/m2 at a surface distance of 600 mm. Typically, the spectral band of the flash unit is within 400-800 mm in accordance with a quantum efficiency of a camera used in the vision system (e.g. JAI GOX-12401M-PGE machine vision camera).

Typically, each flash provides 120 joules of light and the flash duration is adjustable from 0.01 ms to 1 ms, with a flash-to-flash intensity variation of less than 5%.

Each flash unit typically has a driver configured to trigger the flash to occur when a respective camera takes an image.

In one arrangement, the vision system includes three cameras spaced apart along a lengthwise extent of the beam to provide sufficient field of view of the pack in all operating configurations. Typically, each camera has an associated flash unit. However, other locating mechanisms could be used, such as a single vision system coupled with fiducial markings, a lidar or other suitable arrangement.

Typically, the vision system for imaging a pack of blocks exposed to variable ambient light including sunlight uses edge detection algorithms to identify a block in a captured image, the vision system including: a plurality of cameras positioned above the pack of blocks, each camera configured to acquire an image; a plurality of flash lighting units each associated with a respective one of the cameras and controlled to trigger a flash as the camera takes an image, the flash configured to be one and preferably two orders of magnitude brighter than sunlight; and, image processing software used to stitch together each acquired image into a composite image of the pack of blocks and identify one or more blocks in the composite image.

As mentioned, in one example two transfer robots for picking an individual block directly from a pack are located in the base and work concurrently to continuously feed blocks into shuttles for delivery to the block laying robot at the end of the boom. In operation, each transfer robot places a block picked from a pack into either an empty shuttle waiting in the base or the saw module (if used). The transfer robot is able to place a block into the saw and retrieve a cut block from the saw and place it into an empty shuttle.

In the base of the machine there can be provided a shuttle sequencing system that provides a location to store and load shuttles. This provides the ability to sort the order of shuttles and optionally may provide power to charge the shuttle batteries. It also sequences the shuttles to and from a carousel which rotates around the tower. The shuttle sequencing system can also provide positions for a shuttle to be loaded with a block by the transfer robot.

In one example, the shuttle sequencing system includes a shuttle storage bay including multiple levels of tracks on which shuttles are driven and stored when not in use. In the example shown, the shuttle storage bay has three levels of tracks and the capacity to hold up to thirty (30) shuttles in total. The shuttles can be charged at any position within the shuttle storage bay. The charging rails are separate to the motion tracks.

The shuttle sequencing system can also include an arrangement to move shuttles to a different level track of the storage bay, such as an elevator, looped section of track, or the like, depending on the preferred implementation. A shuttle translator can also be provided, which is configured to move shuttles into and out of the shuttle storage bay.

In one example, the shuttle storage bay has a rear section, a middle section that opens like a gate and a front section. The middle section that opens allows shuttles to be removed or added, or to be maintained outside of the machine.

Typically, the transfer robot loads shuttles on a top track of the storage bay and shuttles on the top track are therefore departing shuttles that travel in a direction from the rear to the front of the machine. The middle and bottom tracks are used by empty returning shuttles and travel in the opposite direction from the front to the rear of the machine. The provision of three levels of tracks also provides redundancy to the system in that malfunctioning shuttles can be stored on one level whilst the remaining two levels of tracks supply and return functioning shuttles.

The shuttle sequencing system further includes a shuttle elevator configured to move a shuttle disposed thereon to a different level track of the storage bay. In one example, the sequencing system includes first and second shuttle elevators located at the front and rear of the shuttle storage bay respectively (between opposing ends of the tracks) and configured to elevate a shuttle disposed thereon to a different level track of the storage bay. The shuttle translator is located proximate an elevator, and in one example is provided adjacent to the front elevator, with the shuttle translator being operable to move shuttles into and out of the shuttle storage bay.

The first shuttle elevator travels between a bottom track and a middle track of the shuttle storage bay and the second shuttle elevator travels between the top, middle and bottom tracks. The difference in travel is accommodated by assembling a stop in the appropriate location and setting the software configuration for the module. It is to be noted also that alternative specialised shuttles (e.g. a gable cut shuttle or a mortar carrying shuttle) can be stored and sorted by the elevators.

In one example, each shuttle elevator includes an elevator mount attached to a frame, such as a side frame of the vehicle and/or base and an elevator tray slidably coupled to the elevator mount for vertical travel up and down the mount, the elevator tray including a body having elevator track sections engageable with wheels of a shuttle. The elevator tray accommodates a single shuttle and operates to align the elevator track sections with tracks on one of the levels of the shuttle storage bay to allow the shuttle to drive onto that level of the storage bay.

The shuttle translator operates to move shuttles in a direction of travel orthogonal to a direction in which shuttles move in the shuttle storage bay. The shuttle translator therefore moves in a direction across the width of the vehicle and/or base (i.e. sideways) to align with either tracks of the storage bay or the carousel.

In one example, the shuttle translator includes a translator base mounted to a frame, such as a base frame of the vehicle or base, and a translator assembly slidable coupled to the translator base for slidable movement therealong, wherein the translator assembly includes a body having first and second translator track sections each engageable with wheels of a shuttle. The track sections of the translator are orthogonal to the direction of travel of the translator.

In a first position of the shuttle translator, the first translator track section (an upper track section) is aligned with the top track of the shuttle storage bay for receiving a departing shuttle thereon. The second translator track section (a lower section) accommodates a return shuttle and in use, the front elevator will raise so that its track section is aligned with the second translator track section so the return shuttle can drive from the translator onto the front elevator for return to the storage bay.

As the shuttle holds a block all the way until it is laid on the wall, it is important that each shuttle clamps a block in an accurate and repeatable position to minimise block laying inaccuracies at the wall. As the transfer robot loads a shuttle in the storage bay, there will be some positional variation in block clamping position for each shuttle. To account for this, a shuttle datum assembly is provided for use in datuming the position of a block relative to a shuttle.

The shuttle datum assembly includes a track for receiving a shuttle and a datum plate that extends laterally across the track and is movably mounted longitudinally relative to the track so that the datum plate can be provided in a datum plate position so that when the shuttle travels along the track to a reference position the block engages the datum plate and is urged into a datum position on the shuttle. This can therefore be used to re-position and/or align a block on the shuttle, to ensure the blocks are at a known fixed position on the shuttle, which in turn helps ensure accurate positioning of the blocks when these are laid.

In one example, the reference position is an end of the track, so that the shuttle can drive to the end of the track and thereby align/position the block on the shuttle.

In one example, the track of the shuttle datum assembly is part of the shuttle translator. In this example, the shuttle datum assembly is located next to the shuttle translator and mounted to the translator base, the datum assembly including a slidable arm having a datum plate mounted at an end thereof that is vertically disposed above a top track of the shuttle translator, the datum plate movable in a lengthwise direction of the translator track sections.

In use, a block is datumed by the datum plate moving to a defined datum position for a particular block type as a loaded shuttle drives onto the top track of the shuttle translator. The shuttle then unclamps the block as it approaches the datum plate. The shuttle drives the block into the datum plate and continues to drive until it reaches a shuttle hard stop mounted to a frame of the shuttle datum assembly. The shuttle then re-clamps the block in the datumed position.

The shuttle sequencing system further includes inductive proximity sensors that are located in each of the shuttle storage bay, first and second shuttle elevators and shuttle translator to confirm the presence of a shuttle at a certain location. The proximity sensors detect a striker plate on each shuttle. A number of striker plates are also provided along the shuttle sequencing system which are detectable by an inductive proximity switch on the shuttle and used to reference the shuttle's position in the system as will be described in further detail below. Alternatively, an optical sensor of each shuttle detects reflective targets located along the track in each of the shuttle storage bay, first and second shuttle elevators and shuttle translator.

Typically, the second shuttle elevator includes a hard stop that a shuttle is driven to which provides a reference for a starting position of the shuttle.

As previously mentioned, the base of the machine further includes a carousel located concentrically with the boom slew ring at the base of the tower, the carousel rotatable about the tower and including a plurality of radially spaced apart carousel rotators each configured with two pairs of tracks to either receive a loaded shuttle from the shuttle translator and enable the loaded shuttle to drive onto a tower track section or receive an empty shuttle from a tower track section and enable the empty shuttle to drive onto the shuttle translator.

The carousel rotators each include spaced apart first and second carousel rotator track sections and wherein each carousel rotator is configured to rotate from a first position in which the rotator tracks are aligned with the shuttle translator track sections and a second position in which the rotator tracks are aligned with the tower track sections.

In the example shown, the carousel has three carousel rotators that can store shuttles with for example cut blocks required in a block laying sequence. It will be appreciated that a different number of carousel rotators may be provided depending on the configuration of the machine and amount of buffer/storage required to execute the block sequence. The carousel is powered via a slip ring that allows continuous rotation. Continuous rotation allows the carousel to move in the shortest direction to its next destination.

In use, the shuttle translator moves sideways from the shuttle storage bay to the carousel whilst the carousel rotates so that one of the carousel rotators is aligned with the translator to receive a shuttle thereon, the carousel then rotates to position the loaded carousel rotator proximate the tower track sections, and the loaded carousel rotator then rotates to align the carousel rotator track sections with the tower track sections to allow the shuttle to travel between the carousel and tower.

The boom has to slew intermittently and almost continuously to move the block laying robot around the building site so during the transfer of a shuttle between the carousel rotator and the tower, rotation of the carousel is slaved to track the boom slew motion.

The boom slew supports the tower and boom and rotates them to the required building angle. The boom slew uses a ball or roller bearing slew ring with an integral ring gear. The slew drive is by two servo motors acting through bearing reducers (Spinea Twinspin) to pinions. Two motors are used to achieve adequate torque to resist the slew moment generated by wind blowing on the side of the boom. The two motors may also work to eliminate backlash.

As previously described, the tower is supported by the boom slew ring and in turn supports the boom. The tower includes a boom pivot about which a proximal end of the boom pivots, the tower further including a tower rotator pivotally mounted to the tower so as to pivot coaxially with the boom pivot. The main body of the tower supports tower track sections that allow a shuttle to drive or otherwise travel up the tower. The tower rotator is for transferring a shuttle between the tower and the boom.

In one example, the tower rotator includes a body having tower rotator track sections configured to receive one of a loaded shuttle travelling to the block laying robot or an empty shuttle returning to the shuttle storage bay and wherein the tower rotator is configured to pivot between a first position in which the tower rotator tracks are aligned with the tower track sections in order to transfer a shuttle onto the body of the tower and a second position in which tower rotator track sections are aligned with boom track sections in order to transfer a shuttle to the boom.

There is provided a hydraulic lift ram for the boom which is mounted to the tower. The lift ram alters a lift angle of the boom. During transfer of a shuttle between the tower rotator and the boom, pivoting motion of the tower rotator is slaved to a lift angle of the boom.

The tower rotator is moved by an electric servo motor that drives through a planetary gearbox that drives a pinion that drives a gear to pivot the tower rotator. The servo motor has an integral absolute encoder and a brake. Proximity switches are used to confirm the alignment of the tower rotator with the tower or the first boom element. Proximity sensors detect the presence of a shuttle in the correct position to allow rotation.

The boom system shall now be described.

The boom system includes a boom having at least two pairs of telescopic boom and stick elements having at least one pivot joint therebetween and wherein each element includes track sections extending substantially along the length of each element, the track sections being configured to allow a shuttle to travel along the boom.

Typically, the boom includes hollow boom and stick elements, which permit the shuttles to travel internally through the boom. In one specific example, each boom or stick track section includes two levels of internal track including a top track on which loaded shuttles drive out to the block laying robot and a lower track on which empty shuttles return to the base.

The boom includes a boom rotator located at the pivot or luff joint between the respective boom and stick elements, the boom rotator having boom rotator track sections and configured to rotate so as to alternately align the boom rotator track sections with one of an adjacent boom or stick element so to transfer a shuttle across the pivot joint.

In one example, each of the boom and stick elements are box sections comprising carbon fibre foam sandwich panels bonded at the corners with one of aluminium extrusions, or carbon fibre angle sections. The carbon fibre construction allows the weight of the boom to be within an acceptable limit for a reach of up to 32 m. The boom system is very light for its length and load capacity. Alternatively, the boom may be manufactured from a lightweight aluminium alloy.

Telescoping motion between the respective boom and stick elements is chain driven by electric servo motors. The pivot or luff joint between the boom and stick elements uses hydraulic rams pushing on a linkage to provide 180 degrees of articulation. The boom has two hydraulic luff rams. The luff rams have integral load holding valves. The luff rams are connected by hoses to a proportional valve in the base of the machine. A single proportional valve spool controls the oil to both rams. Accordingly, the boom is articulated and telescoping.

As mentioned previously, the boom has internal telescoping tracks for the continuous shuttles to travel along. A reciprocating boom rotator at the luff joint moves a pair of tracks that alternately align with the boom or the stick to transfer a shuttle over the pivot or luff joint. The lift and luff motions are by hydraulic rams with position encoder feedback. The telescoping motion is chain driven by redundant double chains and electric servo motors. Typically, the internal tracks of the respective telescoping boom and stick elements are telescoping tracks and wherein tracks of the inner boom and stick elements telescope outside of tracks of outer boom and stick elements. In one embodiment, tracks of the outer boom and stick elements include spigots configured for sliding interconnection with corresponding channels forming part of the tracks of the telescoping inner boom and stick elements.

The boom and stick elements are tubes constructed from carbon fibre foam sandwich panels bonded at the corners with either aluminium extrusions or carbon fibre angle sections. The end fittings that attach to rams and pivot joints are steel or aluminium weldments bonded to the carbon fibre tube.

The first boom element mounts to the tower with a welded steel bulkhead pivot fitting. The bulkhead fitting is bonded to a composite carbon fibre tube. At its tip it is bonded to machined aluminium fittings. The composite tube is constructed from four flat sandwich panels bonded to either aluminium extrusions at the corners or carbon fibre angle sections. Ultra-high modulus prepreg carbon fibre is used to obtain high stiffness at low weight. The first boom element supports linear roller bearing blocks for the telescopic motion of the second boom element that telescopes inside of the first boom element. The linear bearing blocks have recirculating rollers. The blocks pivot to align with the bearing steel strip.

The second boom element comprises a composite carbon fibre tube and at its tip it is bonded to a welded aluminium luff joint pivot fitting. The 6061-0 aluminium luff joint fitting is heat treated to 6061-T6 or T4 after welding. The composite tube is constructed from four flat sandwich panels bonded to either aluminium extrusions at the corners or carbon fibre angle sections. Ultra-high modulus prepreg carbon fibre is used to obtain high stiffness at low weight.

In one example, the aluminium corner extrusions have dovetail grooves that hard steel bearing strips are captured in. The corner extrusions are shaped to simplify the bonding process. Alternatively, if carbon fibre angle sections are used in the corners then steel bearing strips may be mechanically fastened to the carbon fibre.

The second boom element is moved telescopically by a chain driven by a sprocket driven by a geared electric servo motor mounted on the first boom element.

The first stick element is connected to the luff joint. There is a welded and post weld heat treated aluminium 6061-T6 fitting bonded to a composite tube. The composite tube is constructed from four flat sandwich panels bonded to either aluminium extrusions at the corners or carbon fibre angle sections. Ultra-high modulus prepreg carbon fibre is used to obtain high stiffness at low weight. A fitting bonded to the tube provides a mount for the luff rams and supports the luff ram pins in double shear. A link above the luff ram supports the fitting.

The second stick element telescopes inside the first stick element and is also a composite tube constructed from four flat sandwich panels bonded to either aluminium extrusions at the corners or carbon fibre angle sections. Ultra-high modulus prepreg carbon fibre is used to obtain high stiffness at low weight. The bearing strips are mounted in the same manner as described for the second boom element.

The second stick element is moved telescopically by a chain driven by a sprocket driven by a geared electric servo motor mounted on the first stick element.

The block laying robot shall now be described.

Typically, the block laying robot is provided at a distal end of the boom and includes a laying arm; and, an end effector depending from the laying arm for handling shuttles, wherein the end effector receives a loaded shuttle carrying a block and the laying arm moves the end effector so as to position the shuttle proximate a block laying location so that the shuttle can release the block and thereby lay the block.

The end effector includes upper and lower tracks configured to transfer a shuttle from the lower track onto the upper track after the block has been laid. In use, a loaded shuttle drives onto the lower tracks of the end effector and an empty shuttle drives off of the upper tracks of the end effector in opposing directions so as to exchange shuttles between the boom and end effector. Typically, shuttles are exchanged concurrently.

Shuttles are exchanged between the boom and end effector via a shuttle rotator disposed between the boom and laying arm which rotates shuttles 180 degrees so as to orientate a block to face downward for laying.

The end effector typically includes a frame, first and second spaced apart end effector tracks mounted to the frame, the lower and upper end effector tracks being configured to align with corresponding first and second tracks in the boom and an elevator slidably mounted to the frame that is configured to transfer the empty shuttle from the lower track onto the upper track to allow a loaded shuttle to be received onto the lower track and the empty shuttle returned to the boom from the upper track.

In one example, when the laying arm positions the end effector and shuttle thereon in a block laying location, a block is laid by a shuttle unclamping the block. Specifically, in this case, the block laying robot is configured to receive the shuttle from the boom and then position the shuttle proximate a block laying location so that the shuttle can release the block and thereby lay the block.

Accordingly, in this case the block laying robot is typically configured to position the end effector adjacent the distal end of the boom to receive a loaded shuttle, position the shuttle proximate a block laying location so that the shuttle can release the block and thereby lay the block and position the end effector adjacent the distal end of the boom to return the empty shuttle to the boom. When the end effector includes the elevator, this process involves receiving the loaded shuttle from the boom on the lower end effector track, and then transferring the empty shuttle from the lower end effector track to the upper end effector track after the block has been laid, so that the shuttle can be returned to the boom.

The block laying robot is typically part of a laying head that includes a support tower pivotally connected to a distal end of the boom and wherein the block laying robot depends from the support tower.

In one example, the block laying robot is a spherical geometry robot wherein the laying arm is linearly extendable (in radius) and controllable in roll and pitch via a support tower mount whilst the end effector is controllable in roll, pitch and yaw via a wrist mount. The joints of the spherical geometry robot are arranged to avoid poles and singularities within the movement envelope. This means that the end effector can move along any arbitrary path within the envelope without any joint having to do excessive or rapid rotation, as it would if there were singularities or poles within the envelope. The main pitch, roll and linear actuators are located near the centre of the sphere so that the inertia of moving parts is minimised.

The rotary axes of the block laying robot are driven by Spinea Twinspin bearing reducers driven by electric servo motors. Linear movement along the Z axis is driven by a rack and pinion via a toothed belt and electric servo motor. The servo motor has an integral brake.

In one example, the support tower and laying arm are carbon fibre structures and electrical equipment is housed within those structures.

Typically, the support tower comprises a clevis shaped body having a pair of arms via which the clevis is pivotally mounted for controlled rotation relative to the distal end of the boom and wherein the support tower includes a shuttle rotator including upper and lower tracks and wherein a loaded shuttle travelling along an upper track of the boom drives onto an upper track of the shuttle rotator which rotates 180 degrees to invert the loaded shuttle so that it can drive onto a lower track of the end effector with the block in a laying orientation facing downward.

The inverted shuttle then drives onto a lower track of the end effector of the block laying robot optionally via a fixed section of track mounted to the support tower or ancillary structure connected thereto.

In this arrangement, the end effector is an attachment on the end of the laying arm that handles shuttles in order to lay blocks. In one example, the end effector includes a frame depending from a wrist of the robotic arm, the frame having a top plate coupled to the wrist, the top plate connected to opposing side plates and an end plate. The lower and upper are mounted at least in part to the opposing side plates and the elevator is slidably mounted to the frame that is configured to raise an empty shuttle from the lower track onto the upper track.

The elevator typically includes a cross-beam spanning across the end plate and slidably mounted thereto for travel up and down the end plate. One or more lower track sections are connected to the cross-beam so as to be raised or lowered therewith and an actuation assembly is configured to move the elevator relative to the frame.

In one example, the actuation assembly includes a pneumatic cylinder and a bell crank coupled between a piston of the cylinder and the cross-beam, wherein the bell crank pivots in response to piston extension and retraction so as to raise or lower the elevator. Pneumatic actuation is preferable due to the speed and responsiveness with which the elevator needs to manipulate shuttles.

Furthermore, during a laying action, the pneumatic cylinder provides vertical compliance to the end effector by venting its ram ports (through the control valve) thereby allowing the end effector to continue to descent slightly as the block makes contact with the surface.

It is to be appreciated that in this example, the lower track includes fixed lower track sections mounted to the frame and movable lower track sections that form part of the elevator. The upper track includes at least one pivotable upper track section operable to pivot out of the way when a shuttle is elevated from the lower track to the level of the upper track. In an elevated position, the movable lower track sections are aligned with and form part of the upper track to enable an empty shuttle to drive off of the end effector.

In this way, shuttles can be exchanged concurrently on the end effector so that as a loaded shuttle drives on, an empty shuttle drives off.

As a block travels from the shuttle rotator to the end effector, adhesive is applied onto a bottom surface of the block. In one example, this is achieved using an adhesive application system that is configured to be supported proximate the block laying robot provided at the distal end of a boom. The adhesive application system typically includes at least one adhesive canister, a nozzle outlet configured to dispense adhesive onto a lower surface of a block, a supply line extending from the at least one adhesive canister to the nozzle outlet and a motor driven gear pump that pumps adhesive through the supply line. The use of the motor driven gear pump allows the viscous adhesive to be reliably supplied to the nozzle and allows an amount of adhesive applied to each block to be measured for quality control purposes.

In one example, an adhesive application system is mounted to the laying head (specifically the support tower thereof), with an angled nozzle outlet being used to dispense adhesive onto a lower surface of a block as it passes over the application system. Typically, an adhesive application system is installed on each side of the support tower.

Typically, the adhesive canister is coupled to the hose that feeds to the gear pump via a dry break coupler which assists in preventing the adhesive from curing prematurely and allows the cartridge to be removed whilst leaving liquid adhesive in the hose and/or cartridge.

The nozzle outlet is positionable in horizontal and vertical axes to adjust the nozzle height and lateral position relative to a block. The nozzle is positioned in two axes, across the brick and vertically to the correct application width and height by servo motors. The vertical servo motor drives a trapezoidal threaded rod whilst the horizontal servo motor drives a pinion engaging in a rack. The nozzle lateral location should be aligned with the correct rib or face shell of the block. It is anticipated that the lateral position of the nozzle will be constant for each block type. Optionally, the lateral position may be varied as the block advances over the nozzle, thereby applying a “wavy” pattern of adhesive.

The pump motor is controlled so that the nozzle outlet dispenses adhesive in synchronisation with a shuttle carrying a block passing over the nozzle outlet.

A sensor may be used to detect the start and end of the block as the shuttle passes over the nozzle outlet which triggers the pump to dispense adhesive. Alternatively, a position of the shuttle in the machine is used to trigger the pump to dispense adhesive based on timing and travel distance for the shuttle to arrive at and move across the nozzle outlet.

The gear pump is typically controlled to suck back an amount of adhesive at the end of an application cycle in order to reduce or minimise the amount of overflow and drip that occurs after application.

In typical embodiments, the canister stores an approximate volume of adhesive comprising one: 5-6L, 6-7L, 7-8L, 8-9L, 9-10L, 10-11L, 11-12L, 12-13L, 13-14L and 14-15L.

In order to achieve a repeatable adhesive signature, a precise dose of adhesive can be dispensed onto a block using the fixed displacement gear pump. A dispensed quantity of adhesive can be measured and/or verified for every block via a camera and lighting system that images an adhesive signature for each block and an image processor that determines the quantity of adhesive dispensed.

The shuttle will now be described in further detail.

In one example, each shuttle includes a frame, a clamp assembly configured to receive and hold a block and a wheeled assembly coupled to the frame for engaging the shuttle onto a track, the wheeled assembly including at least one driven wheel assembly coupled to at least one drive motor enabling the shuttle to travel along the track and thereby transport a block via the boom to the block laying robot. This allows the shuttle to receive a block in the base of the robotic block laying machine and drive along the boom to the block laying robot, without requiring the block to be handed off to different handling mechanisms. This reduces the complexity of the machine, and hence potential points of failure, as well as helping ensure accurate alignment of the block when the shuttle reaches the block laying robot.

Further, as previously described, the block laying robot can be configured to lay a block by positioning the shuttle proximate a block laying location so that the shuttle can release the block and thereby lay the block. This in effect means the shuttle not only transports the block through the block laying machine, but also acts as part of the end effector to lay the block, thereby ensuring accurate positioning of the block right through to laying of the block. This helps improve the accuracy of block positioning.

The wheeled assembly includes upper wheels configured to run on top of a track section and lower wheels configured to run below the track section. Typically, the wheeled assembly includes front and rear upper wheel assemblies; and, front and rear lower wheel assemblies. In this regard, it will be noted that the terms “front” and “rear” are relative terms based on the forward direction of travel of a loaded shuttle through the machine. As the shuttle returns in the opposite direction without turning around, the “rear” of the shuttle will be forward facing during return travel.

Typically, one or more of the upper wheel assemblies are driven wheel assemblies coupled to the at least one drive motor and the lower wheel assemblies are non-driven idler wheel assemblies. The drive motor may be coupled to the at least one driven wheel assembly by one of a belt and pulley mechanism; and, a chain and sprocket mechanism. Accordingly, the one or more driven wheel assemblies are responsible for generating wheel traction. Either one of or both of the rear and front upper wheel assemblies may be driven. In other words the shuttles can be provided with two wheel drive or four wheel drive depending on the desired configuration.

To assist in keeping the wheels on the track, the wheels of both the front and rear lower wheel assemblies have a spring pre-load to generate normal force to the track.

In embodiments, the drive wheels could be made from polyurethane, polyester-polyurethane or rubber over a metal rim. The non-driven wheels are typically made of acetal, plastic or rubber.

Some of the wheels may also have flanges to laterally locate the shuttle between the tracks.

In some embodiments, the shuttle further includes a plurality of horizontal guide rollers on either side of the shuttle frame to assist in guiding the shuttle along the track.

The clamp assembly typically includes first and second movable jaw assemblies that open and close to respectively release and clamp the block, although other suitable clamping arrangements could be used.

In one example, the clamp assembly includes a dual rack and pinion drive comprising a first rack mounted to the first jaw assembly and a second rack mounted to the second jaw assembly and a clamp motor positioned beneath the jaw assemblies that drives a pinion engaged with both racks such that rotation of the clamp motor in one direction causes the jaw assemblies to move apart and open, and rotation of the clamp motor in an opposite direction causes the jaw assemblies to move together and close. The rack and pinion drive also provides a strong correlation between motor torque and clamp force.

Additionally, the entire clamp assembly is able to be shifted laterally by a side-shift motor to thereby offset the clamp assembly (and block) relative to the frame of the shuttle. This enables the shuttle to lay blocks up against existing party walls.

The clamp offset is enabled by providing the jaw assemblies that are slidably mounted to rails disposed on top of a support that spans across the shuttle, and wherein the shuttle further includes a movable carriage to which the clamp motor and side-shift motor are mounted, the movable carriage slidable along rails disposed beneath the support and the side-shift motor operable to drive a pinion engaged with a rack mounted to the support such that the movable carriage shifts sideways and thereby offsets the clamp assembly.

In one example, the jaw assemblies include opposing primary grippers for clamping opposing sides of a block and wherein optionally at least one of the jaw assemblies further includes a pair of spaced apart retractable secondary grippers disposed about opposing sides of a primary gripper. The shuttle includes RC servos which actuate the secondary grippers wherein the RC servos are operable to rotate the secondary grippers from a retracted position to an extended position in which the gripper is used to clamp at least one side of the block in addition to the primary gripper. The secondary grippers may be used to clamp longer blocks to ensure they are clamped securely and accurately. The secondary grippers retract when handling shorter blocks so they do not interfere with laid blocks.

In one example, each shuttle is self-contained and is equipped with its own power source. Typically, each shuttle has a battery pack containing one or more batteries, such as a plurality of lithium-ion rechargeable batteries. Alternative battery chemistry such as a Lithium-Iron-Phospate may also be used. The shuttles include a charging mechanism, such as an electrical pick-up assembly including carbon brushes for engaging with a charging rail in the shuttle storage bay to at least partially re-charge the batteries each cycle through the machine. Alternatively, wireless charging via tuned inductive coils may be used.

The shuttle may include front and rear collision avoidance sensors to determine the distance between nearby shuttles and assist in avoiding collisions.

Additionally, each shuttle includes one or more sensors for use in referencing a shuttle position along the track, the sensors detecting striker targets distributed along the track wherein the detection causes a shuttle controller to capture an encoder position of a shuttle drive motor.

The sensors may include inductive proximity sensors or optical sensors. For example, one or more inductive proximity sensors for use in referencing the shuttle's position on the track may be located for example on a side of the shuttle or beneath the shuttle. Alternatively, an optical sensor on each shuttle detects reflective targets installed along a track of the base and boom at various locations.

The inductive proximity sensors are used to detect striker plates installed along the track at various locations throughout the delivery and return loop. For a system using optical sensors, reflective striker targets may be installed along the track. When a striker is detected, using either the inductive or optical sensors, the shuttle controller captures an encoder position of the shuttle drive motor and reports this to the central controller as a position reference. Typically, the shuttle reports its position to a shuttle fleet controller as distance travelled relative to the last position reference it captured. The shuttles typically reference their starting position by touching a hard stop on the second (rear) shuttle elevator.

The shuttle also includes a striker plate that is detected by proximity sensors distributed along the track throughout the delivery and return loop. These sensors are used to confirm the presence of a shuttle at a particular location so that the central controller knows where each shuttle is in the system and is able to coordinate the traffic.

It is to be appreciated that each position reference has a unique identifier and when the shuttle fleet controller requests a shuttle to move from its current position to a final position, the shuttle fleet controller provides to the shuttle controller a list of position reference identifiers including a starting position reference identifier, a requested final position reference identifier and any intermediate position reference identifiers that the shuttle will detect during travel between its current position and its requested final position. When executing a movement request, the shuttle controller tracks which position reference identifier was most recently detected and the list of position reference identifiers it is expected to detect whilst completing a current movement request.

In the system, the shuttle communicates with the shuttle fleet controller over a wireless communication network such as Wi-Fi. In this regard, each shuttle includes both a wireless receiver for receiving instructions from the shuttle fleet controller; and a wireless transmitter for sending status information to the shuttle fleet controller. Typically, instructions received from the shuttle fleet controller are indicative of a movement request that has been sent to the shuttle fleet controller from a central controller responsible for coordinating movement of modules and sequencing tasks required to complete a build.

The shuttle controller is configured to control a drive system on-board the shuttle to execute the movement request; manage charging of batteries on-board the shuttle and report charge status information to the shuttle fleet controller; and, monitor signals from sensors on-board the shuttle and one or more of: modify movement of the shuttle in accordance with the received signals; and, provide status information to the shuttle central controller based at least in part on information derived from the received signals.

Each shuttle has persistent memory that records data such as active command, last known state, alarm history, last known position, currently held block type, distance travelled from last reference along with life data such as total on time, total distance travelled, number of blocks clamped, model, serial number, last maintenance date and maintenance history.

The vehicle further includes an outrigger system for stabilising the vehicle during operation when the boom is deployed, the outrigger system depending from the support frame mounted to the chassis and including front fold down legs disposed on opposing sides of the vehicle, the front fold down legs pivotally coupled to a foot pad, and, wherein in use, the legs are deployed at an angle to the ground. Additionally, the front fold down legs may be angled forward which provides improved stability for the boom in its forward arc. The front fold down legs are low at their outer end which allows the laying head (on the end of the boom) to lay close to the foot.

During operation, a front fold down leg is deployed on a building side of the vehicle only to minimise the intrusion of the vehicle footprint onto the road.

Typically, outrigger system further includes front jacks each having a vertical ram, the front jacks mounted proximate the fold down legs on opposing sides of the vehicle and for use primarily on a roadside of the vehicle as they have a limited footprint which doesn't extend onto the road.

At the rear of the truck, the outrigger system further includes rear pull-out legs on opposing sides of the vehicle, each having a vertical ram that can be deployed in any pull-out or stowed position of the leg.

This combination of outriggers provides the machine with a lot of versatility enabling it to have a wide stance on the building side and a narrow stance on the roadside. The main stability is provided by the front fold down legs, however narrow footprint stability may be provided at the front by the jack legs and vertical rams.

The option of using the pull-out legs, fold down legs or vertical rams provides the ability to provide adequate stability to the vehicle whilst minimising footprint and accommodating tight building sites and it also allows the vehicle to park on a roadside and build from the roadside without having to extend legs further onto the road.

As previously described, the machine may optionally have a saw module to enable cutting of blocks on-board the machine. Alternatively, blocks may be provided on pallets pre-cut and optionally sequenced in accordance with a build data file.

An example of a saw module will now be described. In this example, the saw is provided with a wet diamond blade (water cooled to remove dust and lubricate the blade to maximise blade life) and is able to cut bricks square, with mitres, with gable mitres and it can cut bricks to a reduced height. These cuts can be completed on blocks up to 600×300×400 mm (L×W×H) which are the largest format blocks the machine is designed to handle. In one example, the saw blade has a diameter of 1100 mm.

In one example, the saw module (which is located in the base of the machine) includes a base frame and a gantry saw including a gantry rail mounted to the base frame and a gantry frame coupled to a saw blade and motor, the gantry frame slidably mounted to the gantry rail for translation therealong. The saw module further includes a loading area having a cutting plate disposed proximate a floor of the base frame onto which blocks for cutting are placed and from which cut blocks are subsequently retrieved. A first block translator is provided adjacent the cutting plate and operable to move the block in a direction orthogonal to the cutting direction of the saw blade. A fence is mounted alongside the cutting plate, wherein in use, a block is at least partially restrained up against the fence for support whilst cutting; and, a second block translator is provided adjacent the cutting plate movable in the cutting direction of the saw blade for one of pushing blocks up against the fence; and, clamping a block against the fence whilst cutting.

Additionally, the saw module may include a block rotating assembly operable to change the orientation of a block placed on the cutting plate by 90 degrees, the block rotating mechanism including a finger assembly comprising a plurality of spaced apart L-shaped fingers rigidly coupled to a rotator bar that is rotated by an actuator; and, a rotator bar coupled at opposing ends to bushings slidable along guide rods, to thereby enable the finger assembly to translate in the same direction as the first block translator, wherein, in use, the finger assembly is translated to position the fingers beneath a block and then the finger assembly is rotated to rotate the block into a different orientation.

The block rotating assembly is located proximate one side of the cutting plate, the cutting plate having slots aligned with the finger assembly to allow the fingers to freely translate and rotate through the cutting plate in order to manipulate a block.

In one example, the first block translator includes first and second spaced apart arms independently slidable along a mount, the first and second arms extending over the cutting plate and having a paddle attached at a distal end of each for pushing a block along the cutting plate. Typically, each paddle is rotatable allowing an angle of a paddle relative to the cutting plate to be varied so that a block can be angled for gable and mitre cuts.

Blocks are loaded into and retrieved from the loading area of the saw module by the transfer robot.

The saw may additionally have a reject chute to eject waste offcuts.

The robotic block laying machine includes an on-board diesel truck engine driven generator operable in either a generator mode or an electric motor mode. The electrical system of the machine is powered by one of the generator or shore power.

The machine additionally includes a hydraulic system used for the outriggers and boom lift and luff having a hydraulic pump that can be driven by either a diesel engine of the truck or by the generator in electric motor mode. In diesel engine driven mode, the diesel engine drives a gearbox mounted Power Take Off (PTO) connected to a long driveshaft which in turn drives the pump and also an electric motor/generator to generate electric power.

In electric motor driven mode, shore power (e.g. site power at a building site) turns the electric motor/generator and via a belt, drives the hydraulic pump. In this mode, the PTO is isolated from the turning drive shaft by a clutch because the PTO bearings and PTO internal clutch plates are not designed to function with a stationary motor and turning drive shaft because they require pressurised oil for lubrication, which is supplied by the gearbox which must be turned by the engine to provide oil pressure.

It is to be understood from the above description that the machine has been designed to have a modular architecture. Each of the modules is able to function independently of the others as a stand-alone module. The machine has a highly distributed control architecture with each module having its own Industrial Personal Computer (IPC) and drives.

The robotic block laying machine also typically includes a control system. The control system typically includes one or more processing devices configured to control a control a shuttle to cause the shuttle to move from the base to the block laying robot via the boom to thereby transport a block to the block laying robot; control the boom to cause the boom to move the block laying robot to a position required to lay a block; control the block laying robot to cause the block laying robot to: position an end effector adjacent a distal end of the boom to receive the shuttle; position the shuttle proximate a block laying location so that the shuttle can release the block and thereby lay the block; position the end effector adjacent the distal end of the boom to allow the shuttle to return to the boom; and, control the shuttle to cause the empty shuttle to return along the boom to the base.

The control system also controls a transfer robot to cause the transfer robot to pick individual blocks, for example from a pack of blocks, and transfer each block to a respective one of a plurality of shuttles. The control system then independently controls each of the shuttles to cause the shuttles to move along the boom to the block laying robot provided at a distal end of the boom and thereby transport the block from the base to the block laying robot.

For each block, the control system controls the boom to thereby position a distal end of the boom relative a block laying location and controls the block laying robot to cause the block laying robot to lay the block.

Laying of the block is typically achieved by having control system cause the block laying robot to position an end effector adjacent the distal end of the boom to receive the shuttle, position the shuttle proximate a block laying location so that the shuttle can release the block and thereby lay the block and then position the end effector adjacent the distal end of the boom, so that the control system can control the shuttle to cause the empty shuttle to move back along the boom to the base.

The control system typically includes sensors that detect a position of the shuttle along the boom, with the one or more processing devices being configured to control the shuttles in accordance with signals from the sensors.

The one or more processing devices typically include a distributed architecture and include a central controller configured to manage a schedule of jobs that the robotic block laying machine is required to perform for a given build; and, a shuttle fleet controller that: communicates with the central controller including: receiving instructions indicative of job requests for shuttles; providing shuttle status information to the central controller; communicates wirelessly with each shuttle in the fleet including: sending instructions to a shuttle to perform the job requested by the central controller; and, receiving status information from the shuttle.

The one or more processing devices further include at least one shuttle controller provided in each shuttle, the at least one shuttle controller being configured to control the shuttle in accordance with commands from the shuttle fleet controller.

The at least one shuttle controller is configured to control a drive system on-board the shuttle to execute a movement request, manage charging of batteries on-board the shuttle and report charge status information to the shuttle fleet controller, and cause clamps to open or close in accordance with instructions received from the shuttle fleet controller. Each shuttle controller also causes status information to be provided to the shuttle fleet controller.

Typically, each shuttle further includes one or more sensors for use in referencing a shuttle position along the track, the sensors detecting striker targets distributed along the track wherein the detection causes the shuttle controller to capture an encoder position of a shuttle drive motor. The one or more sensors are one of: an inductive proximity sensor on each shuttle that detects metallic striker targets installed along the track, and, an optical sensor on each shuttle that detects reflective striker targets installed along the track.

The shuttle typically reports its position to the shuttle fleet controller as distance travelled relative to the last position reference it captured. Each position reference has a unique identifier and wherein when the central controller issues a job request for a shuttle to move from its current position to a final position, the central controller provides to the shuttle fleet controller a list of position reference identifiers including a starting position reference identifier, a requested final position reference identifier and any intermediate position reference identifiers that the shuttle will detect between its current position and its requested final position. During movement, the shuttle controller tracks which position reference identifier was most recently detected and the list of position reference identifiers it is expected to detect whilst completing a current movement request.

When laying a block, the control system typically controls the block laying robot to position the end effector and shuttle thereon in the block laying location and then controls the shuttle to unclamp the block. Specifically, the control system controls the block laying robot to position the end effector adjacent the distal end of the boom to receive a loaded shuttle, position the shuttle proximate the block laying location so that the shuttle can release the block and thereby lay the block and then position the end effector adjacent the distal end of the boom to return the empty shuttle to the boom. The control system can also control the block laying robot to move an elevator to transfer the empty shuttle from a lower end effector track to an upper end effector track after a block has been laid, to enable an empty shuttle to return to the boom.

Where the elevator includes a pneumatic actuation system, the control system can be configured to detect laying of a block by detecting venting of ram ports of the pneumatic actuation system.

Typically, status information including shuttle position is sent from each shuttle to the shuttle fleet controller which provides this information to the central controller to enable it to coordinate movement of track sections and other modules of the machine.

In a preferred embodiment, each shuttle includes: a wireless transmitter used to send the status signal to the shuttle fleet controller over a wireless communication network such as Wi-Fi; and, a wireless receiver used to receive commands from the shuttle fleet controller over a wireless communications network such as Wi-Fi.

The one or more processing devices further include: a boom controller configured to control the boom in accordance with commands from the central controller; and, a block laying robot controller configured to control the block laying robot in accordance with commands from the central controller.

Further, the one or more processing devices are configured to control at least one transfer robot to: pick individual blocks from a pack of blocks; and transfer each block to a respective one of the plurality of shuttles located at a loading position in a base of the machine. Preferably, a pair of transfer robots are provided to concurrently pick blocks from packs and transfer them to shuttles. The one or more processing devices include a transfer robot controller configured to control the transfer robot in accordance with commands from the central controller.

The one or more processing devices are configured to control a plurality of pack conveyers that move packs of blocks forward in the base of the machine to an empty pack station. In this regard, the one or more processing devices include a pack conveyer controller configured to control the pack conveyers in accordance with commands from the central controller.

The one or more processing devices are configured to control a shuttle sequencing system provided in the base of the machine, the shuttle sequencing system including a shuttle storage bay including multiple levels of tracks on which shuttles are driven and stored when not in use; one or more shuttle elevators controlled to move shuttles to a different level track of the storage bay; and, a shuttle translator controlled to move shuttles into and out of the shuttle storage bay. In some embodiments, the one or more processing devices include: at least one shuttle elevator controller configured to move a shuttle between levels of the storage bay in accordance with commands from the central controller; and, a shuttle translator controller configured to move shuttles into and out of the storage bay.

The control system is further configured to control the carousel rotators to: receive a loaded shuttle from the shuttle translator and enable the loaded shuttle to drive onto a tower track section; and, receive an empty shuttle from a tower track section and enable the empty shuttle to drive onto the shuttle translator.

In some embodiments, the one or more processing devices include: a carousel slew controller configured to control rotation of the carousel about the tower; and; one or more carousel rotator controllers configured to control rotation of the carousel rotators to enable transfer of shuttles between the carousel and tower and shuttle translator respectively.

### General Machine Process Flow

The machine has a fundamentally serial process flow. Blocks are loaded into the machine and then processed sequentially and transported through the machine to be positioned in a wall structure by the block laying robot. Some parallel processes exist such as the two transfer robots operating which enables multiple blocks to be handled concurrently. The saw module is able to cut blocks whilst the transfer robots handle other blocks and the three storage bays on the carousel (i.e. carousel rotators) are able to store cut blocks ahead of requirements.

The process flow shall now be briefly described. The machine drives to site. If the truck leaves the road, bog mats stored under the machine can be manually placed on soft ground. The outriggers are then extended to stabilise the machine and the boom is unpacked. Tracking equipment (e.g. laser trackers and targets) are removed from its storage bays (not shown) on the machine and manually set up. In one example, a Leica laser tracker AT960 is used to track a T-Mac target mounted to the laying head to track the 6DOF position and orientation of the laying head.

Block packs or block pallets are then loaded onto the pack conveyer by a telehandler. A transfer robot then takes images of the blocks and then picks a block with either a clamp gripper or a vacuum gripper, depending on the type of blocks to be handled.

The transfer robot moves the block to either the saw module for cutting, or loads the block into a waiting shuttle. The transfer robot can pick a cut block from the saw. The saw ejects offcut waste.

The loaded shuttle drives along tracks on the shuttle storage bay and then onto a translator. The shuttle briefly unclamps the block whilst a datum plate is moved to accurately locate the block on the shuttle and the shuttle then re-clamps the block. The translator then moves sideways to align with the carousel, then the shuttle drives onto one of three carousel rotators on the carousel. The carousel rotates to align the carousel rotator with the tower and the carousel rotator rotates to align with the tower tracks.

The shuttle then drives up the tower, onto the tower rotator. The tower rotator rotates to align with the first boom element then the shuttle drives along tracks through the first boom element and the second boom element. Meanwhile the tower rotator rotates back to align with the tower. The shuttle then drives onto the luff rotator. The luff rotator rotates to align with the first stick element then the shuttle drives along tracks through the first stick element and the second stick element. Meanwhile the luff rotator rotates back to align with the boom elements.

The shuttle then drives onto the shuttle rotator. The shuttle rotator then rotates the shuttle and block and then as the shuttle drives across onto the end effector of the block laying robot, adhesive is applied to the bottom of the block by the adhesive application system.

The laying arm then moves to position the end effector in the desired position to lay the block onto the wall. Final movement is optionally horizontal to close the perp gap which is the gap between adjacent block ends. The shuttle then unclamps the block and as the laying arm moves up, the shuttle also moves up to the upper track of the end effector via the elevator.

When the laying arm is fully retracted, the empty shuttle drives onto the waiting shuttle rotator, while simultaneously, another loaded shuttle drives onto a lower track of the end effector below the empty shuttle.

The shuttle rotator then rotates to align with the sticks and then the empty shuttle drives onto the lower track of the second stick element. The shuttle then returns via tracks on the second stick element, first stick element, luff rotator, second boom element, first boom element, tower rotator, tower track, carousel rotator, translator.

The translator translates sideways to deliver the empty shuttle to the front shuttle elevator. The front shuttle elevator may move up or down to align with the middle or bottom tracks of the shuttle storage bay. The empty shuttle then drives into the shuttle storage bay.

Shuttles are sequenced and selected for use by the control system. The next empty shuttle to be used drives into the rear shuttle elevator. The rear shuttle elevator then moves up to align with the upper tracks of the shuttle storage bay. The empty shuttle then drives forward to the position where it will be loaded by the transfer robot and another cycle commences.

Further detail of the process will be described below by reference to individual modules.

### Truck

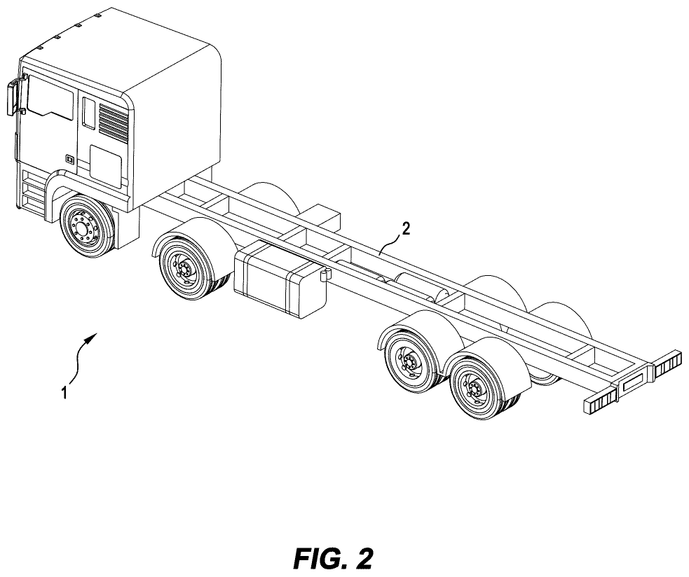

An example vehicle 1 which forms the platform on which the robotic block laying machine 20 is mounted is shown in FIG. 2.

The vehicle 1 is in the form of a rigid body truck which enables the robotic block laying machine 20 to be drivable to and from building sites on roads. In this example, the truck 1 is an 8×4 rigid body truck manufactured by Isuzu (e.g. Model No. FYJ-350 XLWB). The truck 1 has a typical driver's cabin. In an alternative arrangement, a semi-trailer intended for connection to a prime mover using a fifth wheel, may be used instead of a rigid body truck. Another alternative is to mount the block laying machine 20 on a trailer.

The truck 1 is used to mount the robotic block laying machine 20 and deliver the system to site. The truck 1 carries all of the required equipment and the adhesive and the operating crew, but it does not carry the required blocks which are typically delivered to site separately. The truck 1 can optionally tow a trailer to transport a telehandler to site.

The robotic block laying machine 20 is mounted above the chassis rails of the chassis 2. Some equipment including the generator, hydraulic pump, tools, spare parts, cooling system and bog mats are mounted to the robotic block laying machine 20 but are substantially below the top of the chassis rails. Some equipment is mounted to the chassis rails (e.g. rear underrun protection device (RUPD)).

Whilst an Isuzu truck is shown in this example, it is to be appreciated that other suitable trucks such as Mack, Volvo, Mercedes, DAF, Scania, Freightliner or Navistar could be used. A suitable model can be chosen that is fairly similar in terms of size, layout, chassis rail height, empty weight and engine power to the Isuzu FYJ-350 XLWB. Modification to the truck and/or machine may be required to accommodate a different truck base. It is anticipated that electric trucks could also be used, in which case the generator would be removed and an electric motor used to drive the hydraulic pump. The truck batteries could be used to power the electrical equipment.

### Support Frame

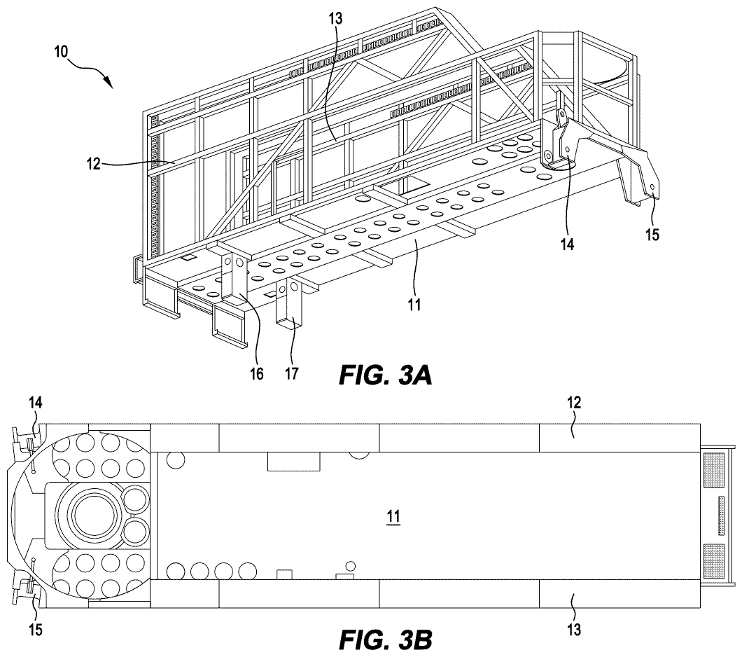

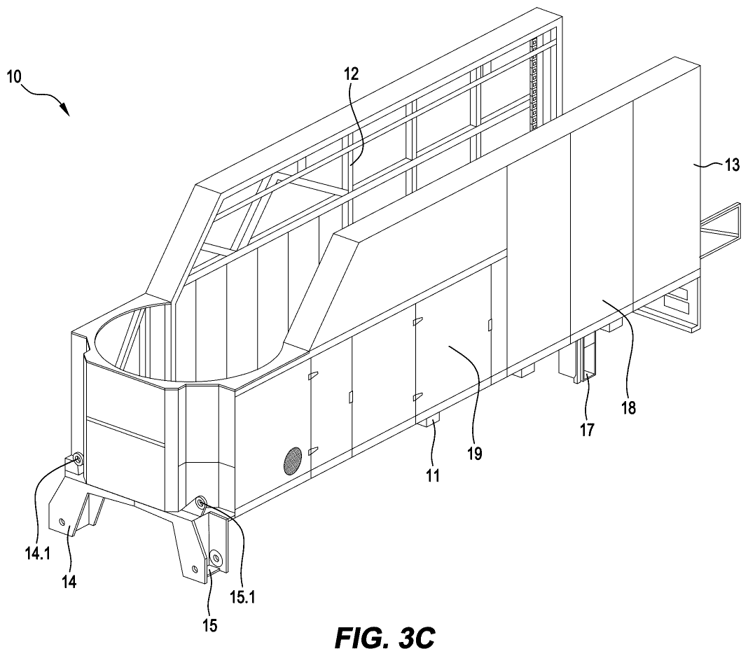

Referring now to FIGS. 3A to 3C, there is shown an example of a support frame 10 that is mounted onto the chassis 2 of the truck 1 for supporting the robotic block laying machine 20.

The support frame 10 is typically a framework capable of structurally supporting the machine 20. In the example shown, the support frame 10 includes a base frame 11 which sits over the chassis rails and two upstanding side frames 12, 13. The base frame 11 provides a mounting for the boom slew ring as well as mounting fixtures for the front and rear outriggers. For example, there is shown front outrigger mounts 14, 15 which include cylinder mounts 14.1, 15.1 as well as rear outrigger mounts 16, 17. The side frames 12, 13 include mounting fixtures such as rails and racks (not shown) that support various modules in the base of the machine including the transfer robots and pallet ejector.

The support frame 10 may further include skin panels 18 that substantially cover the machine 20 and assist in protecting internal components of the machine from rain, wind, dust, sunlight and other environmental elements as well as safety guarding of internal hazards. The support frame 10 is a large weldment. It is built in three major parts (base frame and opposing side frames) which are machined and then welded to form one part. In a complete kit knockdown (CKD) form for global shipping, it could be built in smaller parts that bolt together to fit in shipping containers. However, in driveaway form, it is more efficient to build it as a single welded structure.

The skin panels 18 may also include access doors 19 which can be opened from outside the vehicle to provide access to equipment such as the shuttle storage bay.

### Outrigger System

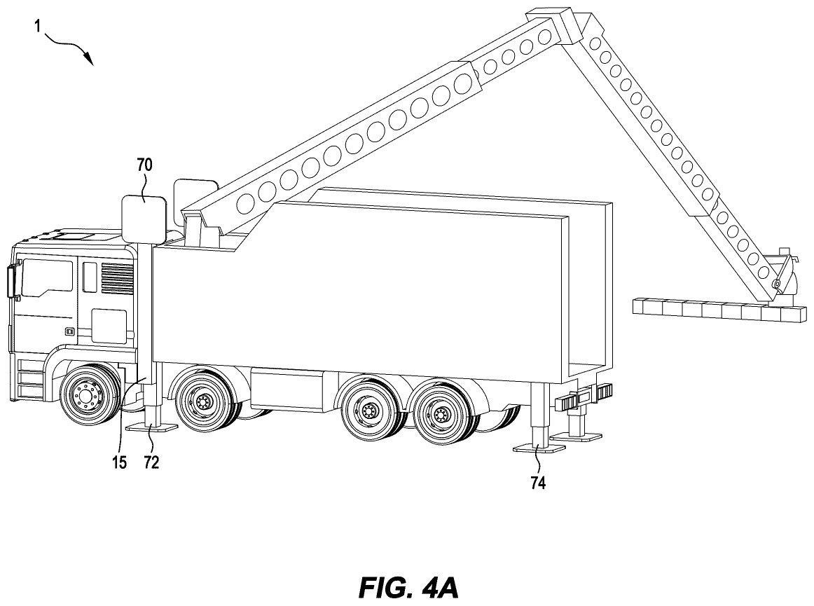

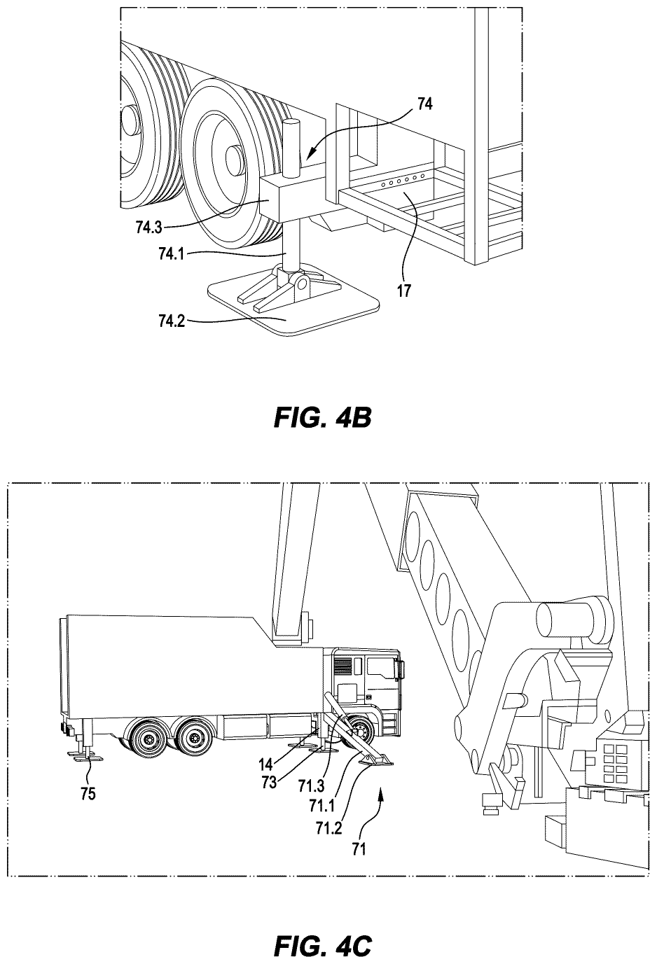

The vehicle 1 includes an outrigger system for stabilising the truck during operation and boom deployment. The vehicle 1 includes three different types of outriggers as shown in FIGS. 4A to 4C which allow the vehicle 1 to have a wide stance on the building side of the machine and a narrow stance on the road side of the machine during operation.

Front outriggers 70, 71 are the primary stabilisers and are in the form of fold down legs that are provided at the front of the vehicle to the rear of the cabin. The legs are pivotally attached to front outrigger mounts that have a degree of forward orientation so that when deployed, the legs are slightly angled forward (as well as to the ground) to provide adequate stability for the boom in its forward arc of travel.

In FIG. 4C, front outrigger 71 is shown in a deployed state. The outrigger 71 comprises leg 71.1 that is pivotally attached to the front outrigger mount 14. A foot (i.e. foot pad or plate) 71.2 is pivotally coupled to the leg 71.1 which allows the leg 71.1 to be low at its outer end when folded down so that the laying head at the end of the boom can build close in to the foot. The front outrigger 71 includes a hydraulic cylinder 71.3 that is coupled between the cylinder mount 14.1 on the front outrigger mount 14 and the leg 71.1. During operation, typically only one of the front outriggers 70, 71 is deployed to minimise the footprint of the vehicle and incursion onto the road. The front outrigger 70, 71 on the building side of the vehicle is deployed in use.

Additionally, the outrigger system further includes front jack legs 72, 73 (i.e. vertical rams) that are also mounted to front outrigger mounts 14, 15. These vertical rams can be deployed on the road side of the vehicle and optionally on the building side with the front outrigger 70, 71 to provide additional stability. The front vertical rams provide narrow footprint stability to the vehicle.

At the rear of the vehicle 1, there is provided rear outriggers 74, 75 in the form of pull-out legs having vertical rams that can be deployed in any pull-out position of the leg. In FIG. 4B, rear outrigger 74 is shown in a deployed state. The rear outrigger 74 includes a hydraulic ram 74.1 attached to a foot 74.2 and mounted to a slide 74.3 which is slidably coupled to the rear outrigger mount 17 to thereby allow the outrigger 74 to pulled out to the desired position.

The option of using the pull-out legs, fold down legs or vertical rams provides the ability to provide adequate stability to the vehicle whilst minimising footprint and accommodating tight building sites and it also allows the vehicle to park on a roadside and build from the roadside without having to extend legs further onto the road.

### Pack Conveyer

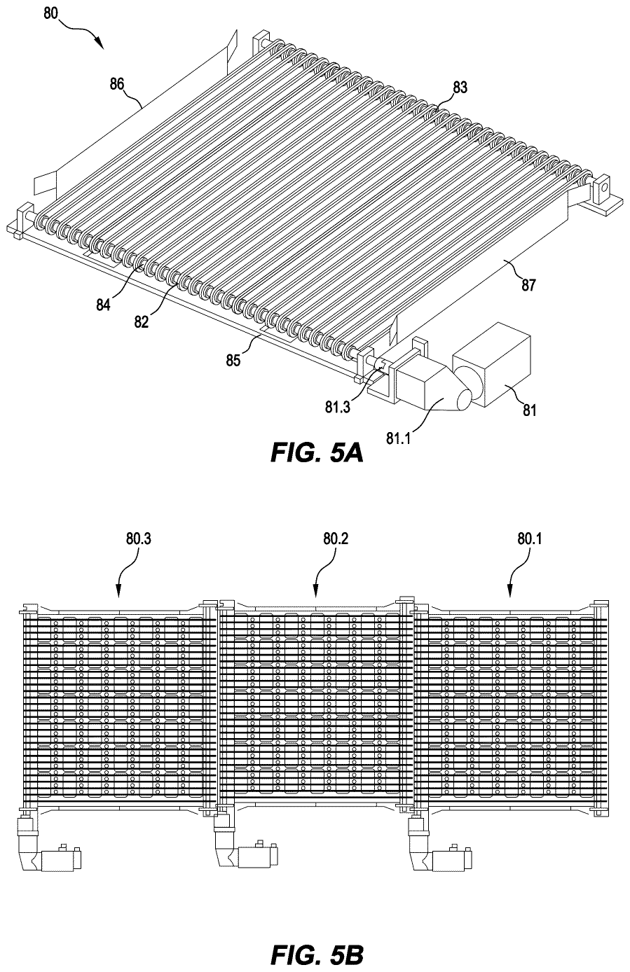

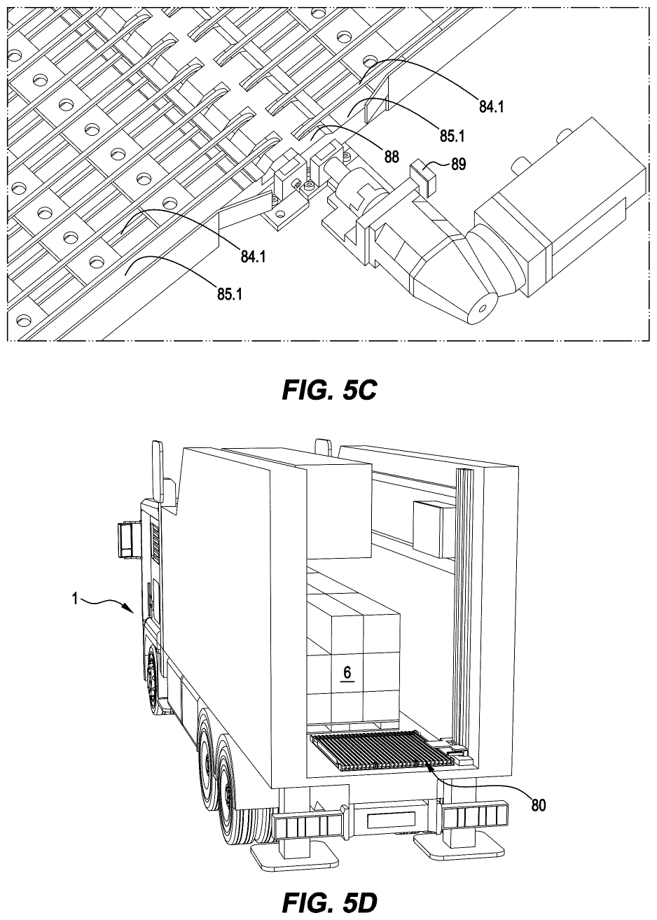

An example of a pack conveyer 80 for conveying packs of blocks 6 through the machine shall now be described with reference to FIGS. 5A to 5D.

In this example, the pack conveyer 80 is a chain conveyer that includes a base frame 85 and a drive assembly including a plurality of chains 84 extending the length of the base frame between a pair of shafts 82, 83. The chains 84 are spaced apart across the width of the base frame 85 and driven by a motor 81 coupled to one of the shafts. In the example shown, motor 81 is connected to the shaft 82 via a gearbox 81.1 and shaft coupling 81.3. The shafts 82, 83 have a plurality of sprockets mounted thereto which engage with the chains 84.

The pack conveyers 80 are configured as modules which can be mounted adjacent each other and arranged in single file in the base of the machine to provide a plurality of pack stations. Accordingly, packs of blocks in the machine are arranged in single file as shown in FIG. 5D. In use, packs of blocks are fed into the rear of the machine on pack conveyer modules which operate to move packs forwards to an empty pack station. Typically, each pack conveyer 80 further includes guide plates 86, 87 mounted to opposing sides of the conveyer to assist in loading the packs and guiding them along when the conveyer is moving.

In one configuration as shown in FIG. 5B, there are three pack conveyers 80.1, 80.2, 80.3 that are used in the machine which can accommodate up to three packs of blocks. A bridging plate 88 is used to couple adjacent pack conveyers and is mounted to between adjacent frames 85.1, 85.2 of pack conveyers 80.1, 80.2. In this example, adjacent pack conveyers are slightly offset to one another laterally so that the respective chains of each conveyer are laterally offset. This arrangement enables the terminal ends of chains of adjacent conveyers to be as close to each other as possible so that packs can easily transition from one conveyer to the next which is important if packs of blocks do not come on pallets.

Each pack chain conveyer 80 further includes a pack detection sensor such as a diffuse reflection sensor 89 which transmits a light beam across the conveyer. When a pack of blocks is on a conveyer at a particular pack station, the light beam is reflected back off the pack of blocks. In this way, the system is able to determine whether there are blocks remaining on a pack, or whether the pack is empty and its pallet requires removal so that the packs behind can be moved forward on the conveyers.

In another configuration, when no saw module is installed, there may be provided five in-line pack conveyers which can accommodate the loading of up to five packs of blocks in the machine.

### Pallet Ejector

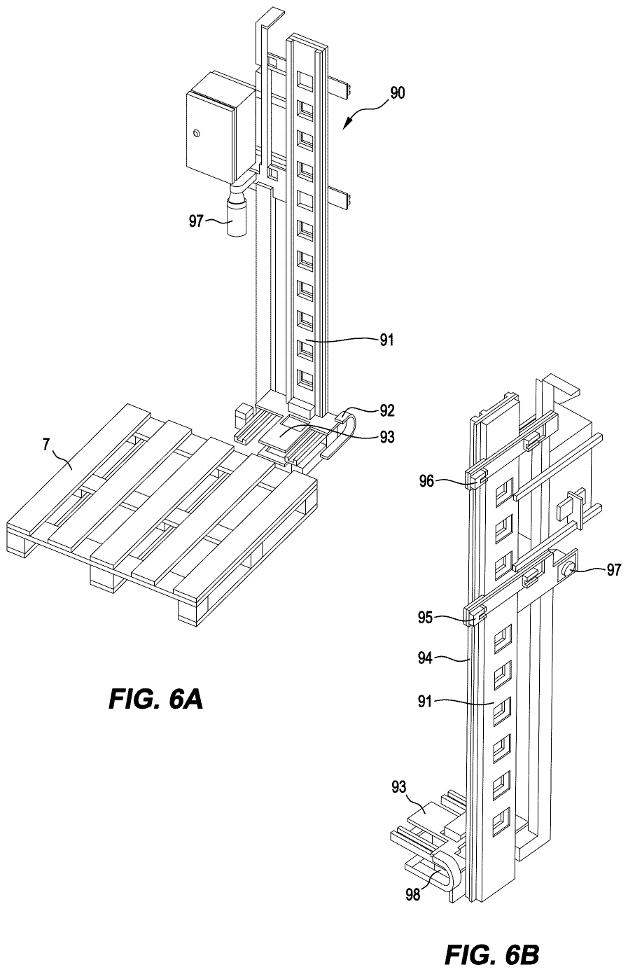

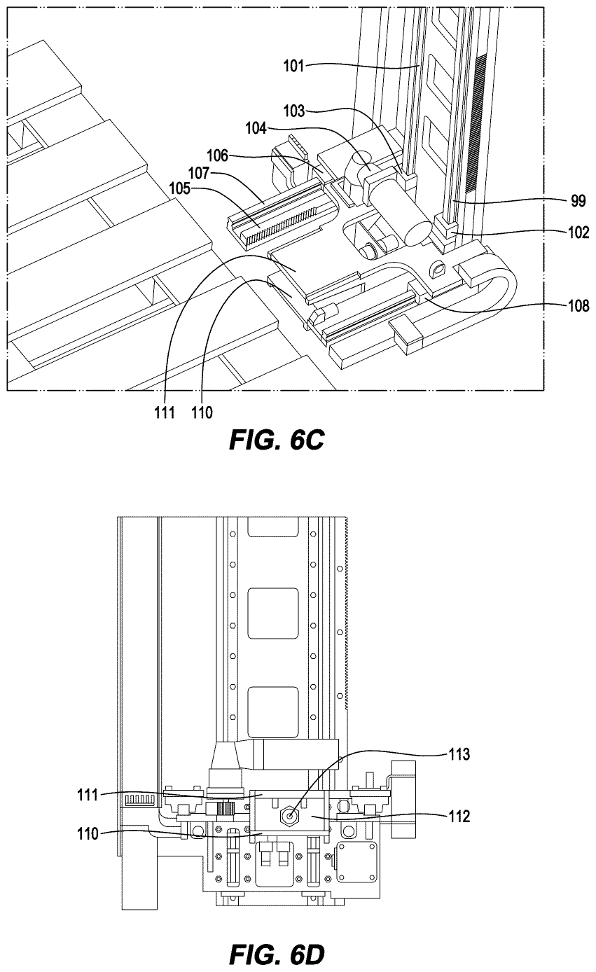

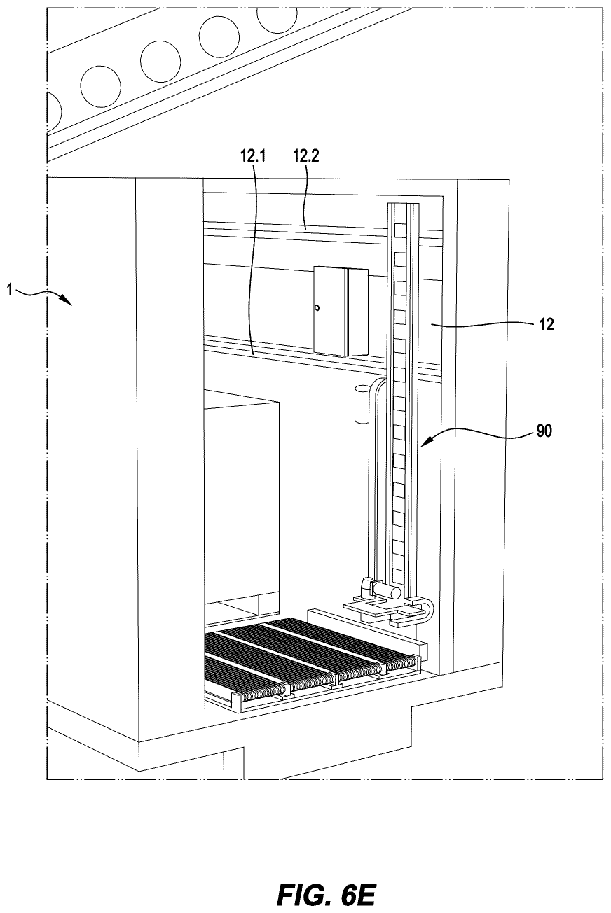

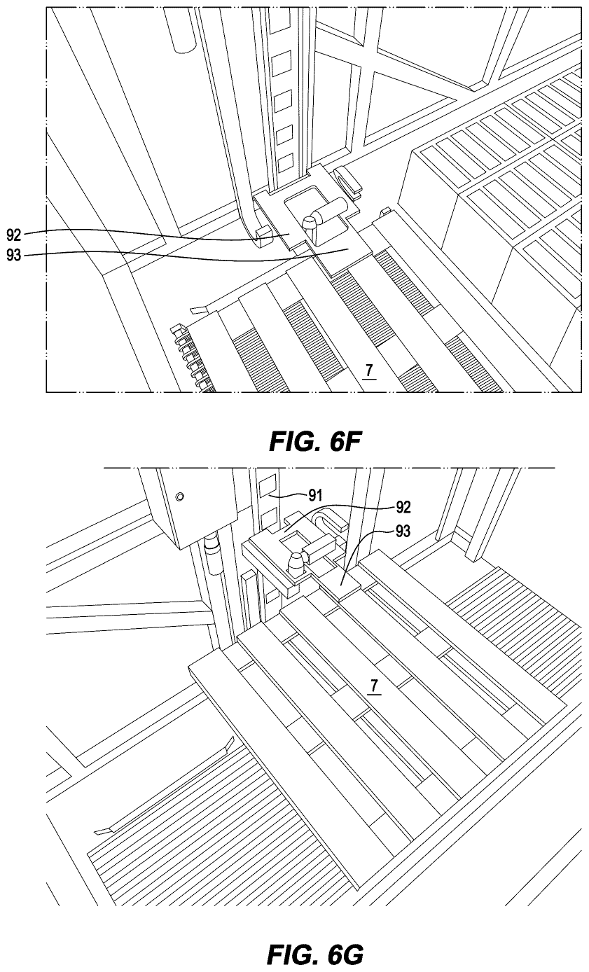

An example of a pallet ejector robot 90 for handling empty pallets shall now be described with reference to FIGS. 6A to 6G.

The pallet ejector robot 90 is a cartesian robot providing linear motion in the X, Y, and Z directions that picks an empty pallet from a pack conveyer and moves it to a pallet storage location. Although not shown in the figures, in one example a shelf is provided at the rear of the vehicle where empty pallets are stacked prior to removal by a telehandler or similar device.

The pallet ejector robot 90 is mounted to a side frame 12 of the vehicle 1 to side rails 12.1, 12.2 mounted longitudinally thereon. The pallet ejector robot 90 includes a carriage support 91 slidably mounted to the side frame 12 for longitudinal travel therealong on the rails 12.1, 12.2.

A carriage 92 is slidably mounted to the carriage support 91 for vertical travel up and down the carriage support 91. The carriage 92 includes a body provided for travel along the carriage support 91 and an engagement means 93 slidably mounted to the carriage 92 for lateral travel towards and away from the carriage support 91. In operation, an empty pallet 7 is secured by the engagement means 93 and is picked up and moved to the pallet storage location.

In the example shown, the engagement means is in the form of a wedge clamp 93 having an opening or mouth 112 and comprising lower and top jaws 110, 111 respectively that are configured to engage with a pallet. The jaws may include tapered portions which assist in securing the pallet by increasing the frictional engagement between the jaws and pallet as the wedge clamp is driven to its fully engaged position.

As shown in FIG. 6D, the wedge clamp includes an ultrasonic proximity sensor 113 used to detect how far the pallet has entered into the jaws during travel of the carriage 92 towards the pallet.

In an alternative example, instead of a clamp arrangement, the engagement means may comprise a vacuum gripper which engages the pallet through suction. For example, one or more pneumatic suction elements may engage the top of the pallet to lift the pallet up.

The carriage support 91 has linear bearing blocks 95, 96 mounted to the rear thereof that are slidably engaged with the rails 12.1, 12.2 of the side frame 12. A motor 97 mounted to the carriage support 91 drives a pinion that is engaged with a rack that runs along one of the rails 12.1, 12.2 to facilitate travel of the robot in the longitudinal X direction of the vehicle. The carriage 92 has linear bearing blocks 102, 103 slidably engaged with rails 99, 101 mounted to the carriage support 91. A motor 98 mounted to the carriage 92 drives a pinion engaged with a toothed rack 94 mounted to the carriage support 91 to enable the carriage 92 to travel vertically in the Z direction up and down the carriage support 91. The wedge clamp 93 has linear bearing blocks 106, 108 mounted thereto that are slidably engaged with rails 107, 109 mounted to the carriage 92. A motor 104 mounted to the wedge clamp 93 drives a pinion engaged with a toothed rack 105 mounted to the carriage 92 to enable the wedge clamp 93 to travel laterally in the Y direction towards and away from the carriage support 91 in order to clamp a pallet 7.

In FIG. 6F there is shown the wedge clamp 93 fully extended relative to the carriage 92 in a pick-up position where the jaws are engaged with an empty pallet. The carriage 92 and wedge clamp 93 is then raised vertically on the carriage support 91 to lift the pallet 7 up from the pallet conveyer. The pallet ejector robot 90 then travels with the pallet 7 along the side frame 12 towards the rear of the vehicle where the pallet is placed onto a shelf or pallet tray disposed between opposing side frames of the vehicle. During transport, the pallet 7 is able to be lifted over adjacent pallets of blocks to the storage location.

### Transfer Robot

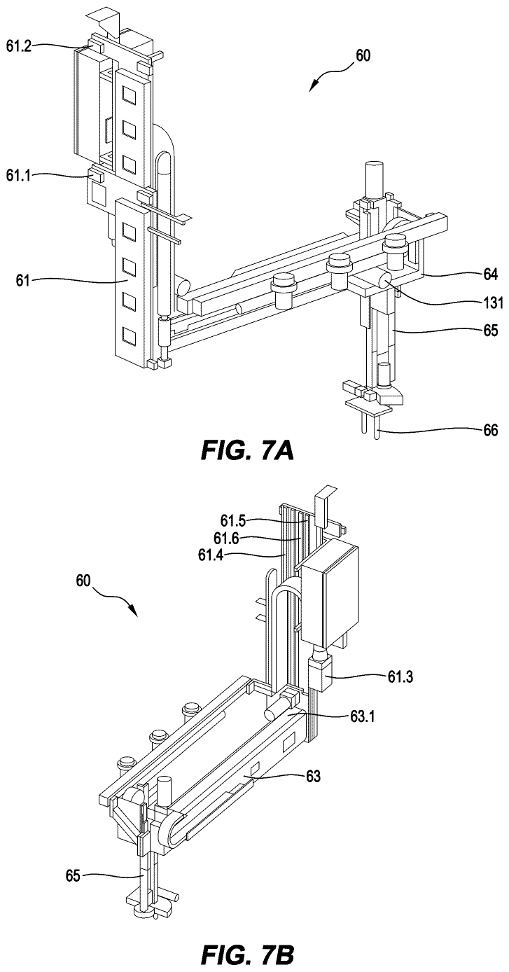

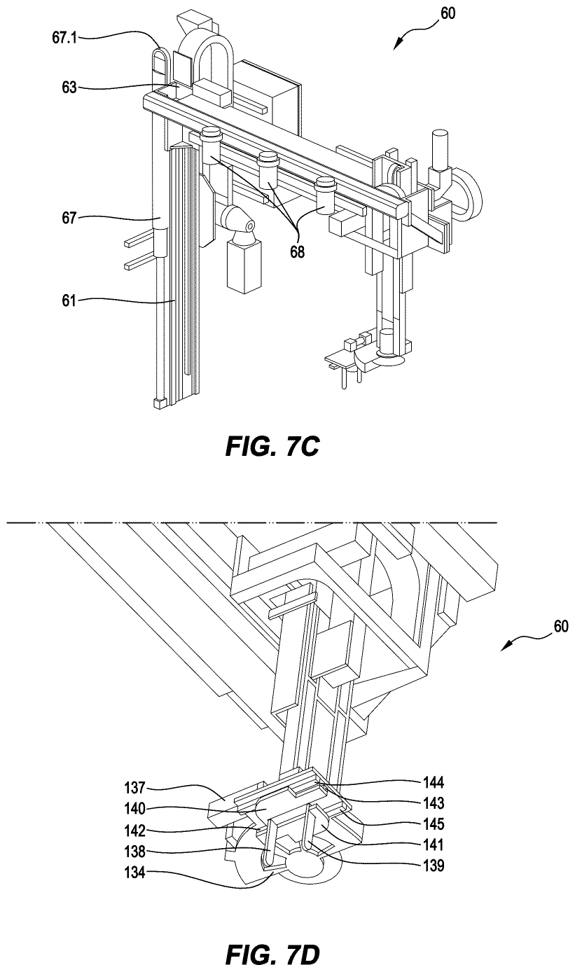

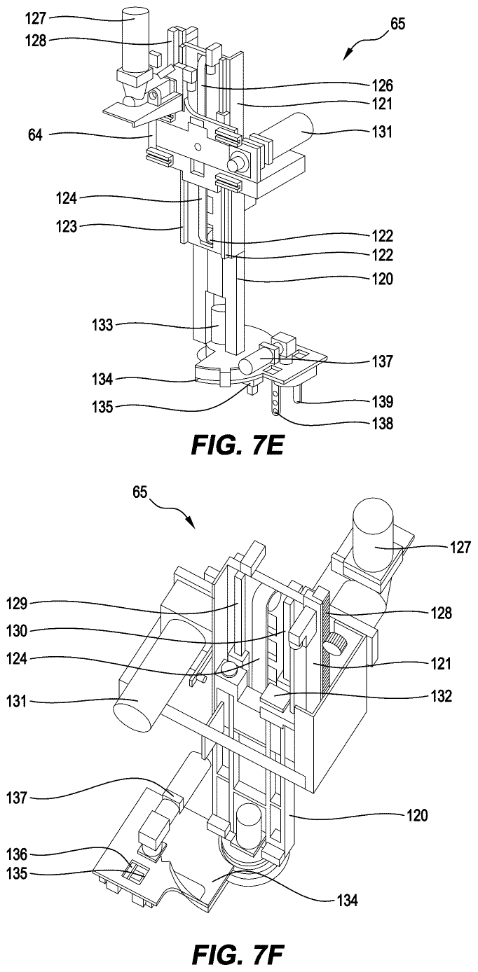

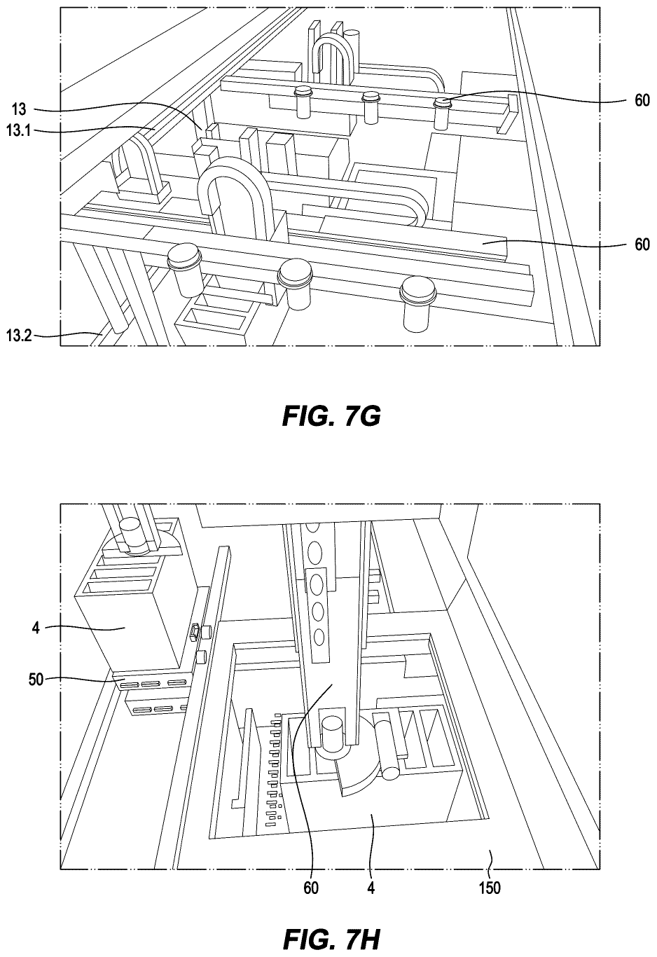

An example of a transfer robot 60 shall now be described with reference to FIGS. 7A to 7H.

As previously described, the function of the transfer robot 60 is to pick an individual block directly from a pallet of blocks and transfer it to another module in the base of the machine. The transfer robot 60 is configured to load empty shuttles with blocks and if the machine is configured with a saw module, also transfer blocks into and out of the saw. In the illustrated example, two transfer robots 60 are used side by side to concurrently load shuttles and execute tasks to increase efficiency.

In the example shown, the transfer robot 60 includes a column support 61 slidably mounted to a side frame 13 of the vehicle for slidable travel therealong. As shown in FIG. 7G, the transfer robots are mounted on spaced apart longitudinal rails 13.1, 13.2 via linear bearing blocks 61.1, 61.2 that are mounted to the column support 61. A motor 61.3 is also mounted to the column support 61 which drives a pinion engaged with a rack mounted to the side frame 13.

A beam 63 is slidably mounted at one end to the column support 61 for vertical travel up and down the column support 61. The column support 61 has rails 61.4, 61.5 mounted thereto about which the beam 63 travels. A motor 63.1 mounted to the end of the beam 63 drives a pinion engaged to a rack 61.6 mounted on the column support 61 to facilitate motion. A pressurized gas strut 67 is also mounted to the column support 61 with a chain 67.1 coupled between the strut and the beam 63. The gas strut 67 acts as a spring counterweight to support the weight of the beam 63 and blocks and reduce the motor power and motor size required. It also reduces the difference in vertical force required to move up or down and simplifies motor tuning and increases dynamic motion response. The gas strut 67 also assists in providing controlled motion and in the event a brake gearbox or pinion associated with the motor fails, the strut will cause the gantry to return to a neutrally buoyant position to avoid crashing into the floor and damaging the equipment mounted to the beam.

A carriage 64 is slidably mounted to the beam 63 for travel therealong and an arm 65 is slidably mounted to the carriage 64 for vertical movement up and down, wherein the arm 65 includes a gripping mechanism 66 at a distal end thereof for picking up a block from a pack of blocks.

A motor 131 is mounted to the carriage 64 driving a pinion engaged with a rack mounted to the beam 63. The beam further includes rails coupled to linear bearing blocks mounted on the carriage to permit slidable travel therealong.

Typically, the gripping mechanism 66 includes a pair of gripper fingers 138, 139 configured to grip an internal core of a block. The gripper fingers 138, 139 are opened and closed via a rack and pinion drive. Each finger 138, 139 is associated with a slidable jaw mounted to a base of the gripping mechanism 66. A motor 137 drives a pinion engaged between racks mounted to respective jaws so that rotation of the pinion in one direction opens the jaw and rotation of the pinion in the opposite direction closes the jaws.

The arm 65 includes a motor 133 at the bottom thereof coupled to the base 134 of the gripping mechanism 66 operable to rotate the gripping mechanism about a substantially vertical axis.

The gripping mechanism is rotatable about an axis of rotation aligned with a longitudinal axis of the arm to provide the arm with the ability to rotate a block held by the gripper fingers. In other arrangements, the gripper may be a vacuum gripper configured to pick up a block (e.g., without cores) by applying a suction force to a face of the block. This is required specifically to handle Autoclaved Aerated Concrete (AAC) blocks.

The arm 65 is shown in further detail in FIGS. 7E and 7F. The arm includes an upper arm element 121 and a telescopic lower arm element 120. The upper arm element 121 includes a pair of rails 129, 130 mounted thereto that permits the lower arm element 120 to slide along linear bearing blocks. The lower arm element 120 is coupled to the upper arm element by a pulley driven belt 124. Belt 124 is coupled around upper and lower pulleys 125, 126 mounted to the upper arm element 121. The belt 124 is clamped to the lower arm element 120 by belt clamp 132.

The upper arm element 121 is driven up and down relative to the carriage 64 by a rack and pinion drive and movement of the upper arm element 121 results in concurrent telescopic movement of the lower arm element 120 relative thereto. Motor 127 is mounted to carriage 64 and via a right-angle gearbox drives a pinion engaged with a rack 128 mounted to the upper arm element 121. Upper arm element includes further rails 122, 123 which permit the arm 65 to move up and down relative to the carriage 64. As the arm 65 moves up, the lower arm element 120 retracts inside the upper arm element 121 and as the arm 54 moves down, the lower arm element 120 extends out of the upper arm element 121.

In order to locate blocks on a pack for picking, the transfer robot typically includes a vision system mounted to the beam for imaging blocks on a pack and one or more light sources to provide a uniform illumination of the blocks. Preferably, the one or more light sources include a flash able to overpower sunlight and any other ambient light. The flash provides at least one and preferably two orders of magnitude higher illumination than sunlight in order to ensure sufficient contrast is achieved so that vision system can detect edges of blocks. In other words, the flash units are approximately 10 to 100 times brighter than sunlight. In one example, the flash is an ultrabright Xenon flash.

In one example, the illumination surface area is approximately 450×700 mm with an irradiance of 2000 W/m2 at a surface distance of 600 mm. Typically, the spectral band of the flash unit is within 400-800mm in accordance with a quantum efficiency of a camera used in the vision system (e.g. JAI GOX-12401M-PGE machine vision camera).

Typically, each flash provides 120 joules of light and the flash duration is adjustable from 0.01 ms to 1 ms, with a flash-to-flash intensity variation of less than 5%.

Each flash unit typically has a driver configured to trigger the flash to occur when a respective camera takes an image.

In the example shown, the vision system includes three cameras 68 spaced apart along a lengthwise extent of the gantry 63 to provide sufficient field of view of the pallet in all operating configurations. Typically, each camera has an associated flash unit. In one example, the cameras are industrial area scan cameras such as the GOX-12401C-PGE compact 12.3-megapixel camera.

As mentioned, in the example shown, two transfer robots 60 are provided for picking an individual block directly from a pack. The transfer robots 60 are located in the base 5 as shown in FIG. 7G and work concurrently to continuously feed blocks into shuttles for delivery to the block laying robot at the end of the boom. In operation, as shown in FIG. 7H, each transfer robot 60 places a block 4 picked from a pack into either an empty shuttle 50 waiting in the base 5 or the saw module 150 (if used). The transfer robot 60 is able to place a block 4 into a loading area of the saw 150 and retrieve a cut block from the saw and place it into an empty shuttle.

### Shuttles

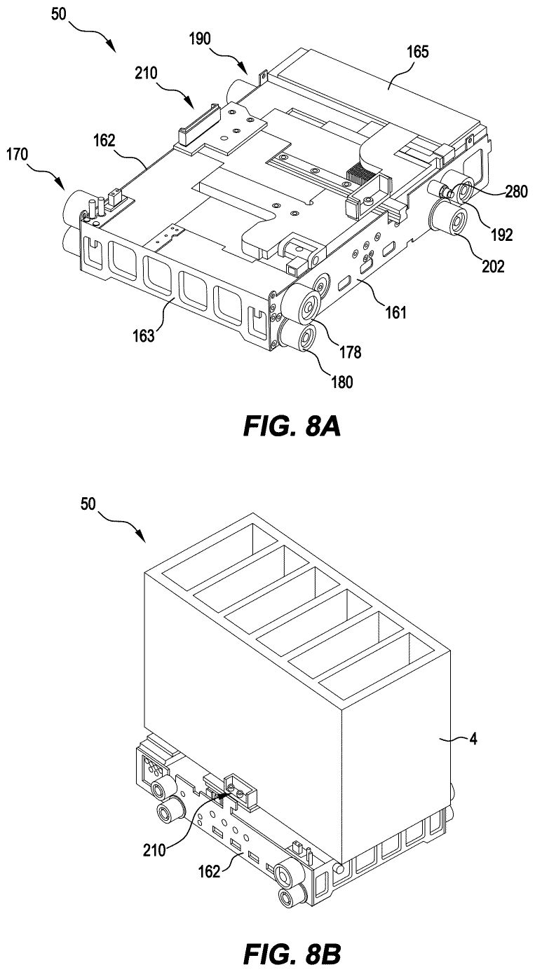

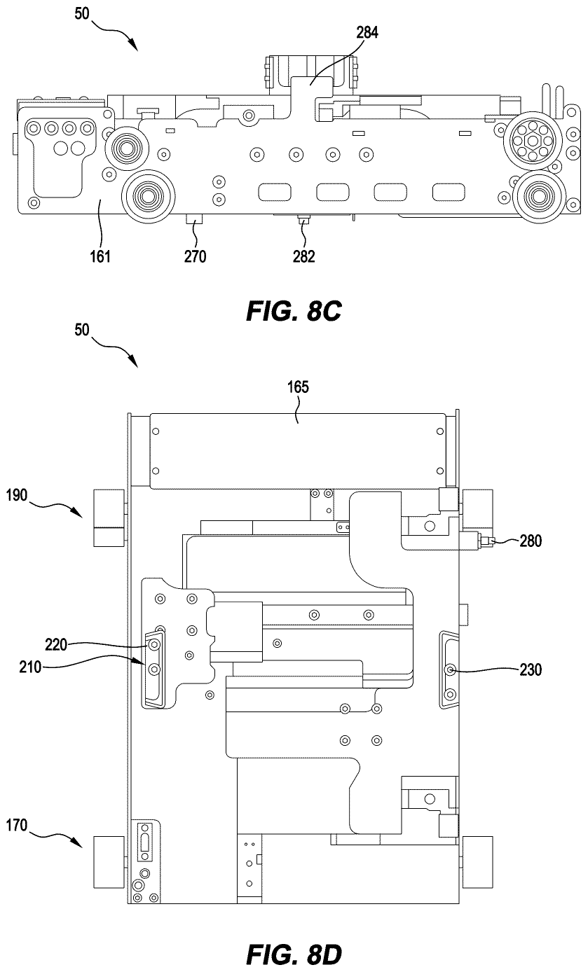

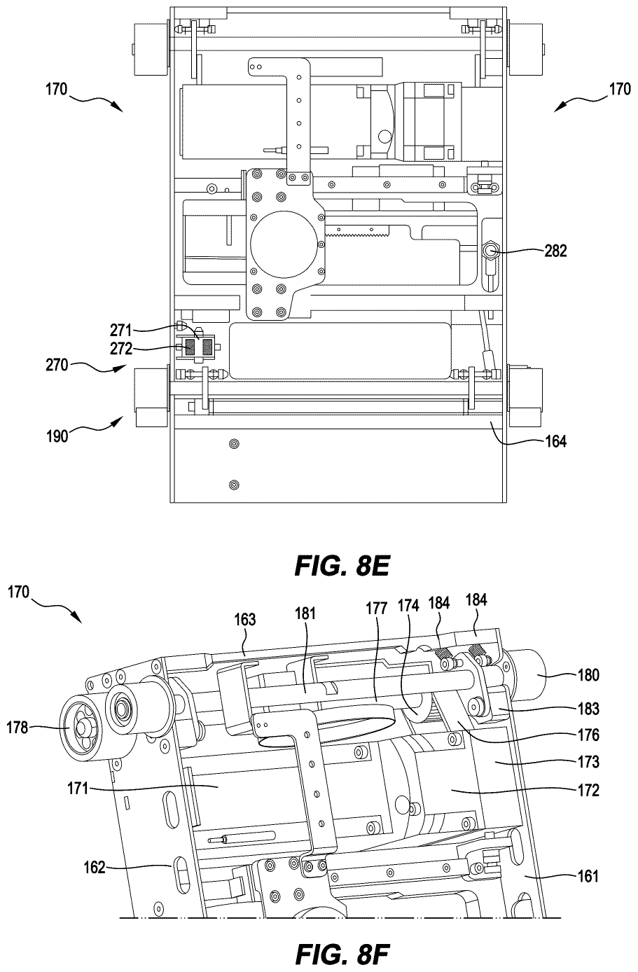

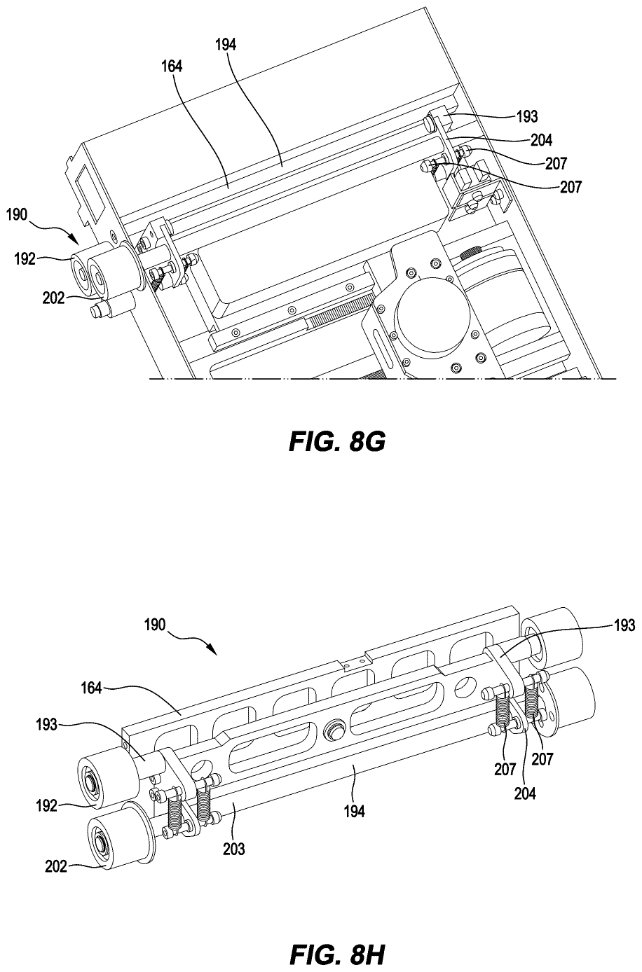

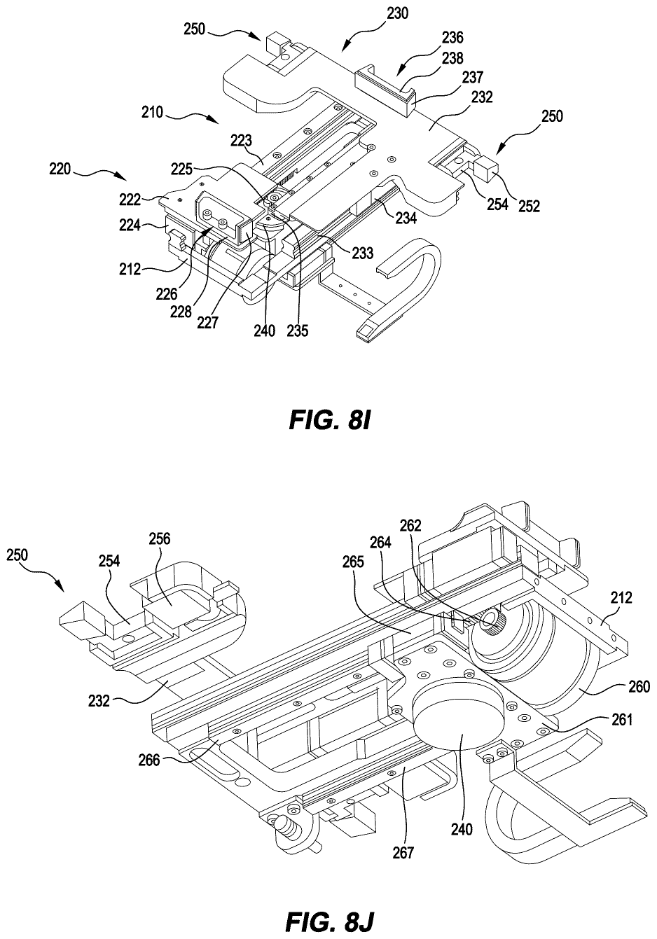

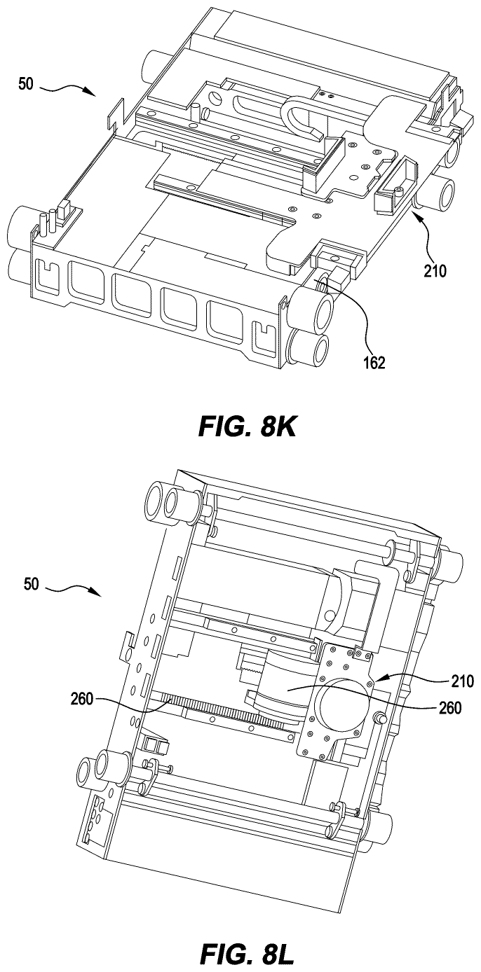

An example of a shuttle 50 shall now be described in further detail with reference to FIGS. 8A to 8L.

Shuttle 50 is a delivery mechanism for transporting an object such as a block, tile, paver or other building component from the base 5 of the machine 20 to the block laying robot 40 at the end of the boom 30. As previously described, the machine includes a plurality of shuttles which travel in a return loop between the base 5 and block laying robot 40 along send and return tracks. Empty shuttles are loaded in the base and travel on tracks to the block laying robot where the object is placed. Empty shuttles return to the base along a return track.

In one example, a shuttle 50 clamps a block 4 and transports it through the machine 20 to the block laying robot 40 and then unclamps the block in order to effect laying of the block on the wall. The machine has “continuous shuttles” meaning each shuttle is loaded and then proceeds through the system to lay a block and then returns. In this manner, the shuttles continuously loop around the machine.

Each shuttle 50 includes a base frame 160. In the example shown, the base frame 160 includes a pair of opposing side plates 161, 162, a rear plate 163 at the rear of the shuttle mounted between the side plates 161, 162 and a front plate 164 (see FIG. 8E) disposed toward the front of the shuttle mounted between the side plates 161, 162. At the front of shuttle, there is provided a battery housing 165 that sits forward of the front plate 164 and which is mounted between the side plates 161, 162. The battery housing 165 houses a plurality of batteries which power the shuttle. In one example, the batteries are 3.7V 21700 rechargeable lithium-ion cells. In this example, each shuttle 50 contains 36 batteries, although the exact number required will vary based on power requirements of the shuttle, depending on the desired lay speed, mass of the blocks and desired battery life.

In other arrangements, the shuttle may not have an on-board power source and instead may rely on power provided over the tracks or rails on which it travels. In other arrangements, the battery packs may be replaced with, or augmented with, super capacitors.

The shuttle 50 includes a rear drive assembly 170 comprising a drive motor 171 coupled to a gearbox 172 mounted to a motor support 173 that is coupled to side plate 161. The drive motor 171 is operable to drive a pair of rear drive wheels 178 via a belt 176 and pulley 174 mechanism coupled between the motor 171 and drive axle 177 connecting the rear drive wheels 178. The rear drive wheels 178 are disposed about opposing sides of the shuttle 50 exterior of the side plates 161, 162. The rear drive wheels 178 are configured to run on top of a track section and transmit torque to propel the shuttle 50. In other arrangements, both the rear and front upper wheels are both driven and may be coupled to the drive motor by a sprocket and chain mechanism. In this way the drive can be two wheel drive or four wheel drive depending on traction requirements.

The rear drive assembly 170 further includes a pair of rear idler wheels 180 connected via an idler axle 181 that are disposed beneath the drive wheels 178 and configured to run on a lower surface of a track section. The idler axle 181 is coupled to the base frame 160 via one or more tension springs 184 mounted between the rear plate 163 and lever arms 182 engaged proximate opposing ends of the idler axle 181. The lever arms 182 are pivotally connected to lever mounts 183 that are fixed to respective side plates 161, 162. In operation, as the spring tension is varied, the lever arms 182 pivot about the lever mounts 183 which adjusts the force acting on the idler axle 181 and thereby increases or decreases the amount of friction between the rear idler wheels 180 and lower surface of the track. The rear idler wheels 180 are also disposed about opposing sides of the shuttle 50 exterior of the side plates 161, 162 and have flanges to keep the shuttle on the track and stop the shuttle from slipping, in particular when travelling along a vertical or steeply inclined section of track.

In one configuration, the drive wheels 178 comprise a metallic rim with a rubber tyre. Alternatively, the drive wheels may be polyurethane or polyester-polyurethane. The idler wheels 180 are made of acetal with screw fastened metal flanges.

The shuttle 50 further includes a front wheel assembly 190 comprising a pair of front upper wheels 192 configured to run on top of a track section and a pair of front lower wheels 202 configured to run on a lower surface of the track. The front wheel assembly 190 is supported by the front plate 164. The front upper wheels 192 are coupled to wheel mounts 193 that are rigidly connected via a connection plate 194 that is pivotably pinned to the front plate 164. This permits the front wheel assembly 190 to roll about the longitudinal shuttle axis and if the track is twisted, maintain contact of all eight wheels to the tracks.

The front lower wheels 202 are mounted to opposing ends of a front axle 203. A pair of lever arms 204 are keyed to the front axle 203 proximate opposing ends thereof. The lever arms 204 are pivotally connected at one end to a lower portion of the respective wheel mounts 193 whilst one or more tension springs 207 are coupled between spring supports (e.g. screws or bolts) passing through an opposing end of the lever arms 204 and an upper portion of the wheel mounts 193. In operation, as the spring tension is varied, the lever arms 204 pivot about the lower portion of the wheel mounts 193 which adjusts the clamp force acting on the front axle 20, clamping the wheels to the tracks. It is to be understood that in this example, the front upper and lower wheels 192, 202 are idler wheels and that only the rear upper wheels are driven. In other embodiments, the front upper wheels may also be driven wheels and a further drive motor may be present.

The shuttle clamping mechanism shall now be described with reference to FIGS. 8I to 8L.

Each shuttle 50 includes a clamping assembly 210 for securely clamping or gripping an object such as a brick or block. The clamping assembly 210 includes opposing first and second shuttle jaw assemblies 220, 230 each including one or more grippers contactable with a side of the block during clamping. The clamping assembly 210 is controllable to respectively open or close the shuttle jaw assemblies 220, 230 in order to grip or release the block. Each shuttle jaw assembly 220, 230 is mounted onto a linear bearing block 224, 234 which is configured for slidable travel along spaced apart rails 223, 233. The rails 223, 233 are mounted to a rail support block or plate 212 which is mounted between opposing side plates 161, 162 of the shuttle 50.

Shuttle jaw assembly 220 includes a jaw 222 mounted to the linear bearing block 224 and including a rack 225 mounted sideways to the jaw 222 with its teeth facing toward the rear of the shuttle 50. Shuttle jaw assembly 230 includes a jaw 232 mounted to the linear bearing block 234 and including a rack 235 mounted sideways to the jaw 232 with its teeth facing toward the front of the shuttle 50. A motor 240 driving a spur gear (i.e. pinion) is mounted beneath the shuttle jaw assemblies 220, 230 in a vertical orientation. The spur gear is mechanically coupled to the two racks 225, 235 such that rotation of the motor 240 in a first direction causes the shuttle jaw assemblies 220, 230 to open and rotation of the motor 240 in a second direction causes the shuttle jaw assemblies 220, 230 to close. In this way, a single actuator can open or close the shuttle jaws via the dual rack and pinion drive.

The shuttle jaw assemblies 220, 230 both include opposing primary grippers 226, 236 comprising gripper pads 227, 237 that are fastened or bonded to pad mounting brackets 228, 238 which are upstanding from the respective jaws 222, 232. In the example shown, these primary grippers 226, 236 have a wide form to increase the surface area of the pads contactable with the block.

To accommodate longer blocks, shuttle jaw assembly 230 further includes a pair of spaced apart retractable secondary grippers 250 disposed about opposing sides of the primary gripper 236. The secondary grippers 250 include a pad 252 fastened or bonded to a pad mount 254 that is rotationally coupled to a Remote Control (RC) servo 256. The RC servo includes a motor and geartrain reduction. The RC servo 256 is operable to rotate the secondary grippers 250 from a retracted position in which the gripper is horizontally disposed to an extended position in which the gripper is vertically disposed above the jaw 232. In this way, the secondary grippers 250 pivot up and down so that when a long block is being clamped, the block will be gripped by both the primary and secondary grippers so as to be held securely and accurately. When not required, the secondary grippers 250 retract to avoid interference with adjacent blocks in a wall being built.

When a shuttle is loaded in the shuttle storage bay, a block is placed on top of the shuttle and rests on surfaces of the respective jaws 222, 232 and is then clamped by the primary and optionally secondary grippers of each jaw assembly.

In some situations, it is desirable to be able to offset blocks clamped in a shuttle 50 such as when building close to an existing party wall. The shuttle 50 enables this functionality via a motor 260 disposed beneath the jaw assemblies 220, 230 in a horizontal disposition that is mounted to a motor support 261 that also locates the motor 240 driving the jaw assemblies 220, 230. The motor 260 drives a spur gear 262 that is engaged with a rack 264 mounted beneath the rail support block or plate 212. The motor support 261 is coupled to linear bearing blocks 265 that slidably travel along rails 266, 267 mounted on a lower surface of the rail support block or plate 212. Accordingly, the motor 260 is configured to drive both shuttle jaw assemblies 220, 230 laterally in a concurrent manner along rails 266, 267 to thereby offset the clamped block relative to the shuttle 50. In a fully shifted position, shuttle jaw assembly 230 and the clamped block will overhang the side of the shuttle.

The shuttles 50 further includes an electrical pick-up assembly 270 (as shown in FIG. 8E) mounted to side plate 162 comprising one or more carbon brushes 272 disposed in a brush mounting enclosure 271 so that the brushes 272 hang below the shuttle 50 for pick-up on charging rails in the shuttle storage bay. In the example shown, the brushes 272 are spring loaded to ensure reliable contact is made with the charging rails to enable the shuttle 50 to at least partially re-charge its batteries when in the shuttle storage bay of the machine.

The position of each shuttle 50 in the system must be accurately known in order to control movement of the plurality of shuttles that are continuously moving throughout the machine. The shuttle drive motor 240 includes an absolute position encoder which is used to estimate distance travelled and this data is input to the shuttle's position algorithm. However, wheel slip, mechanical wear, slightly different physical dimensions in different shuttle units, and the existence of telescoping segments of track mean that absolute axle encoder readings can't provide precise location data over the long term. The encoder readings need to be regularly re-referenced to known physical locations. To provide a reliable and precise positioning system, proximity sensors (e.g. inductive proximity switches) are mounted on each shuttle which can detect metal strikers (e.g. plate, bolthead etc.) located at various locations along the track. Furthermore, proximity sensors are mounted on the track in various locations, which are actuated by striker plates on the shuttles, which can positively confirm the presence of a shuttle at that location. In alternative arrangements, optical proximity sensors may be used in conjunction with reflective striker targets.

In the example shown in FIGS. 8C and 8D, two inductive proximity sensors 280, 282 are mounted on the shuttle 50. A first inductive proximity sensor 280 is mounted to the side of the shuttle 50 whilst a second inductive proximity sensor 282 is mounted on the bottom of the shuttle 50. This enables the shuttle 50 to detect strikers located to the side of the shuttle along the track or optionally below the shuttle. As shown in FIG. 8C, side plate 161 further includes a striker plate 284 which protrudes upward for detection by inductive proximity sensors distributed around the track throughout the machine for use in confirming the presence of a shuttle at a particular section of track.

The shuttle 50 may further include collision avoidance proximity distance sensors (e.g. ultrasonic) located at the front and rear of the shuttle used to avoid collisions between nearby shuttles. Alternatively, laser-based range sensors may be used to monitor distance between shuttles moving along the tracks. A processing device of the shuttle monitors signals received from the collision avoidance sensors; and, controls the drive system to modify speed or brake the motor in accordance with the received signals to ensure that collisions with other shuttles or objects are avoided.

The shuttle 50 further includes at least one on-board shuttle controller. Typically, the shuttle includes a primary controller which in one example comprises a Raspberry Pi running an EtherCAT master. A secondary controller may also be provided which is configured to control power supply to the primary controller and brake the drive motor in case of primary controller unavailability.

The shuttle controller is broadly configured to wirelessly receive instructions from a shuttle fleet controller indicative of a movement request; control a drive system on-board the shuttle to execute the movement request; and, wirelessly send status information back to the shuttle fleet controller at least in part indicative of a status of the movement request.

Each shuttle communicates with the shuttle fleet controller over a wireless communications network such as Wi-Fi. Typically, messages are sent between each shuttle and the shuttle fleet controller over the Wi-Fi network via a MQTT broker.

Typically, status information including shuttle position is sent from each shuttle to the shuttle fleet controller which provides this information to a central controller of the machine responsible for coordinating movement between shuttles and tracks.

### Shuttle Sequencing System

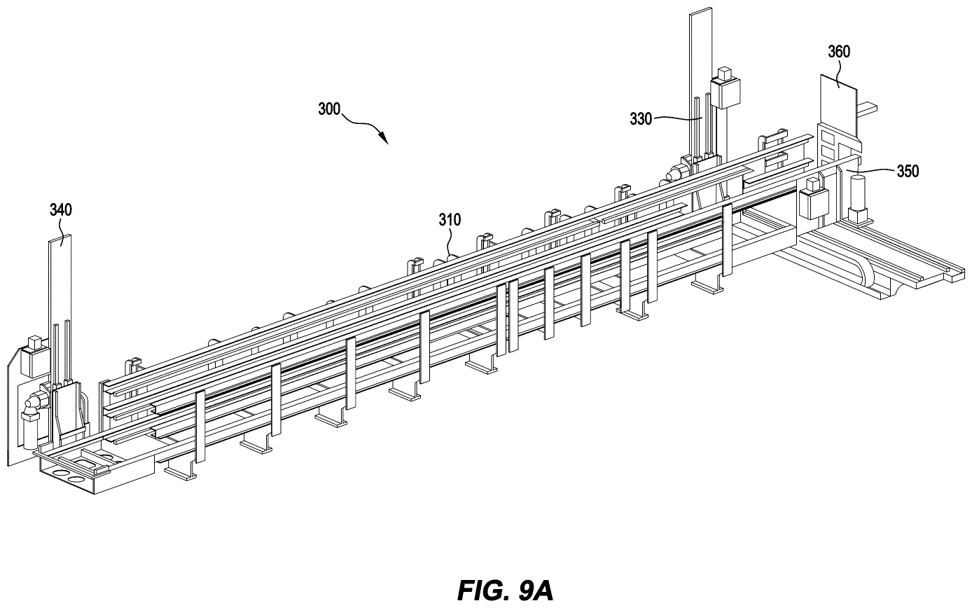

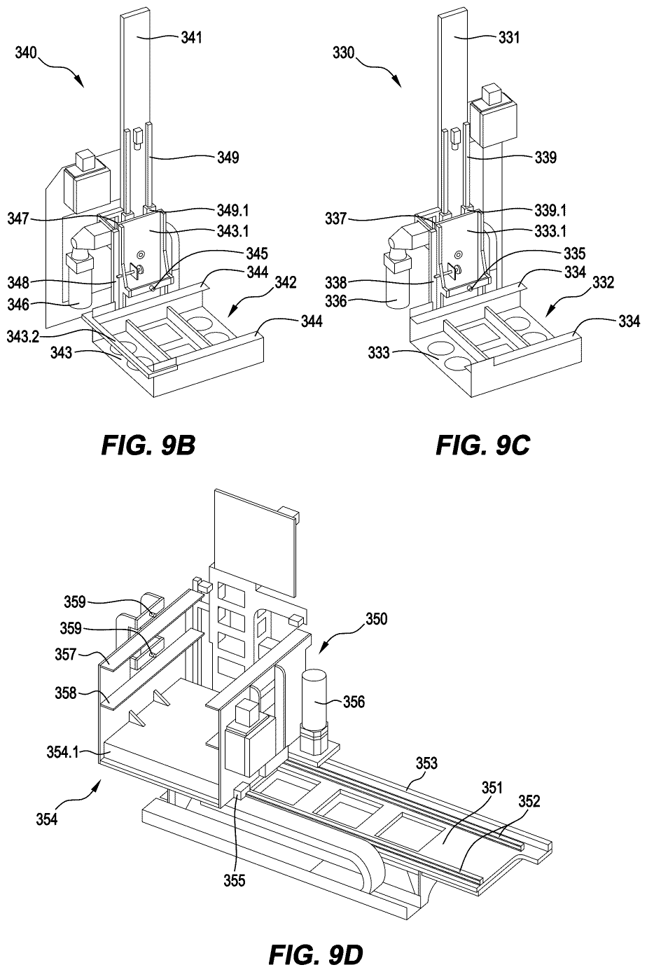

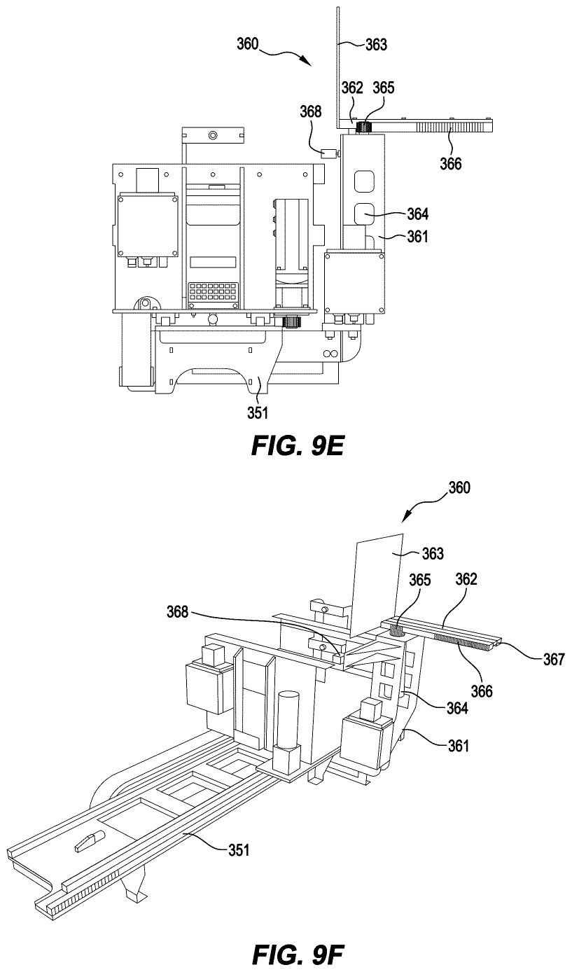

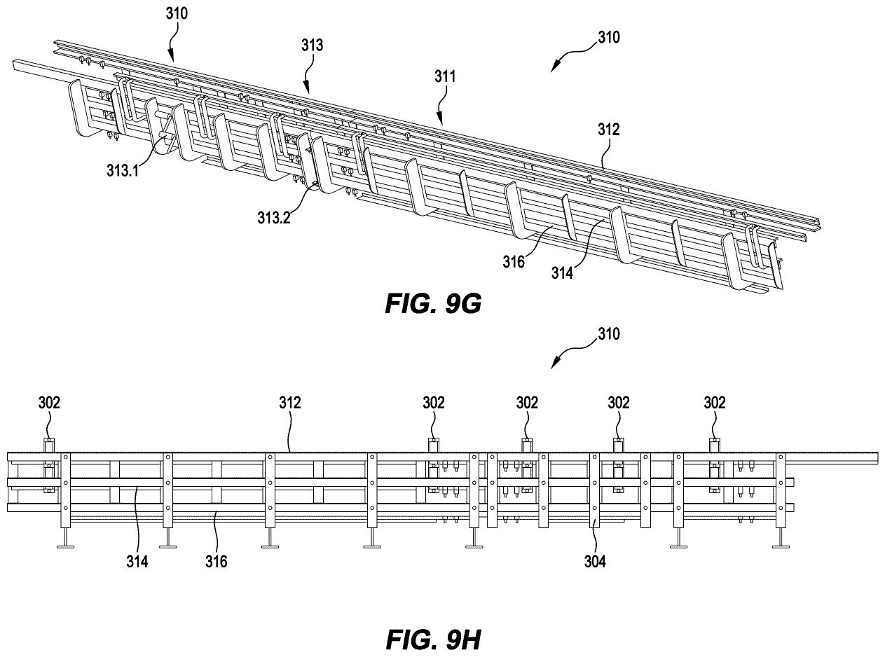

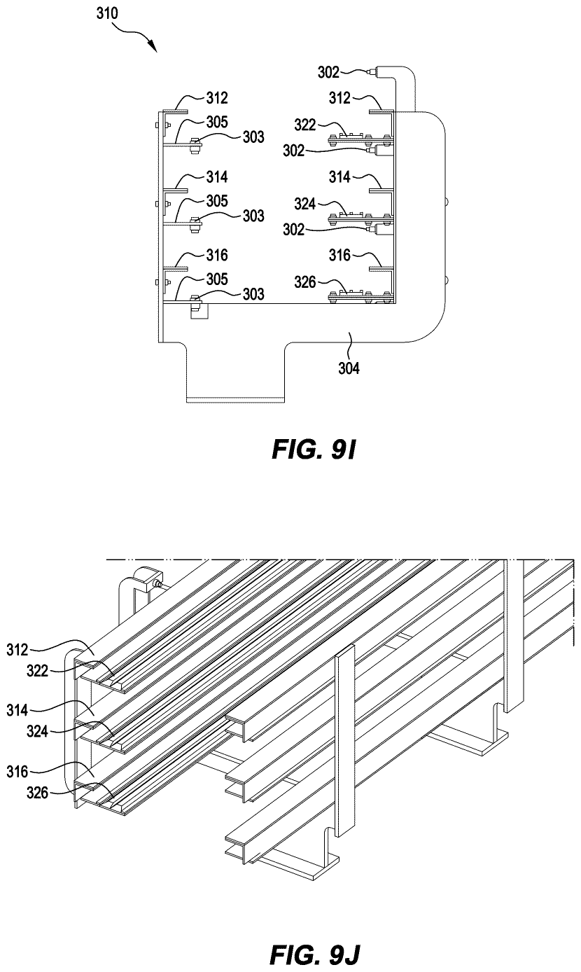

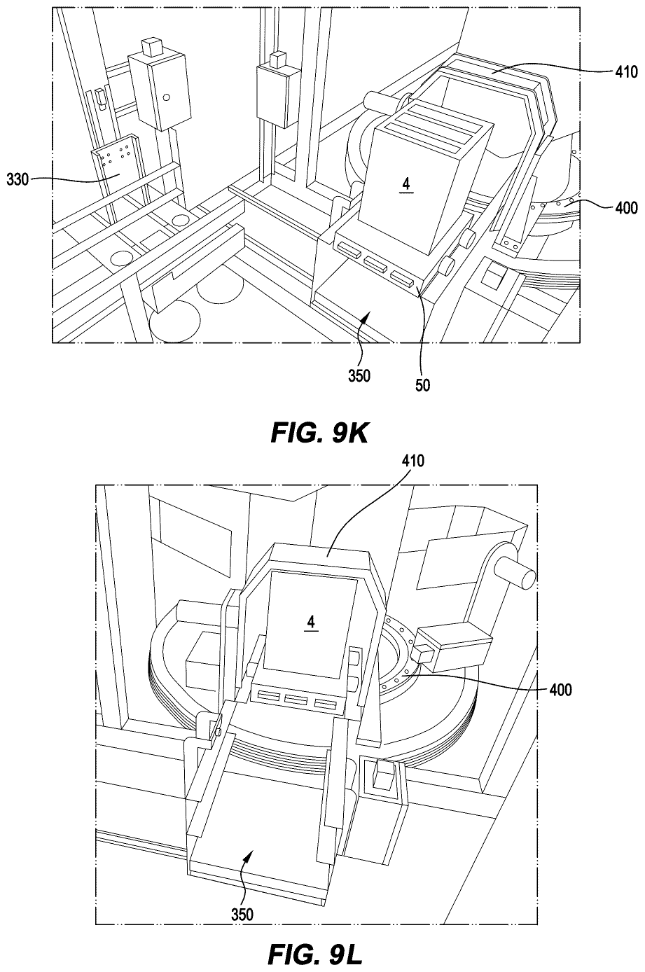

The shuttle sequencing or management system 300 shall now be described in further detail with reference to FIGS. 9A to 9L.

The shuttle sequencing system 300 is located in the base 5 of the machine 20 and provides a location to store shuttles, ability to sort the order of shuttles and power to charge the shuttle batteries. The shuttle sequencing system 300 is responsible for sequencing the shuttles to and from the carousel and additionally provides positions for a shuttle to be loaded with a block, by the transfer robot 60.

The shuttle sequencing system 300 includes a shuttle storage bay 310 including multiple levels of tracks on which shuttles are driven and stored when not in use. The shuttle sequencing system 300 further includes first and second shuttle elevators 330, 340 located at the front and rear of the shuttle storage bay 310 respectively configured to elevate a shuttle disposed thereon to a different level track of the storage bay 310, and a shuttle translator 350 located adjacent to the front elevator 330, the shuttle translator 350 operable to move shuttles into and out of the shuttle storage bay 310. The shuttle translator 350 moves shuttles between the shuttle storage bay 310 and the carousel.

In the example shown in FIG. 9G, the shuttle storage bay 310 includes three levels of tracks, namely a top track 312, a middle track 314 and a bottom track 316. Each track 312, 314, 316 includes a pair of spaced apart rails in the form of angle extrusions. The rails are spaced apart in accordance with a width between wheels of the shuttle 50. The upper surface of each track may have a rubber strip bonded to it to improve traction with the shuttle wheels. Each level of track also includes an associated charging rail 322, 324, 326 (see FIG. 9I) contactable with the electrical pick-ups 272 of each shuttle 50. The charging rails 322, 324, 326 securely retain copper conductors along the length of the rails which are powered and provide charge to the batteries of each shuttle in the storage bay 310. As shown in FIGS. 9I and 9J, the charging rails 322, 324, 326 are mounted beneath the respectively tracks 312, 314, 316.

In operation, the top track 312 is used for loading empty shuttles and loaded shuttles then drive along the top track 312 in a forward direction towards the shuttle translator 350. Empty shuttles on the top track 312 receive a block from one of the transfer robots 60. The middle and bottom tracks 314, 316 are used by returning empty shuttles and as such, shuttles travel on these tracks towards the back of the machine and the rear shuttle elevator 340.

The tracks 312, 314, 316 are mounted to a frame structure 304 which is mounted to the floor of the base 5 of the machine 20 proximate side frame 13. The shuttle storage bay 310 further includes a plurality of proximity switches 302 associated with each level of track and spaced apart along the length of the storage bay 310 which detect strikers 284 on each shuttle 50 to confirm the presence of a shuttle at that location in the storage bay 310. The storage bay 310 further includes plates 305 mounted beneath each track 312, 314, 316 (opposite the charging rails) to which are mounted spaced apart strikers 303 that are detected by the inductive proximity sensor 282 on each shuttle to reference position. The strikers 303 are located at defined reference positions in the storage bay. In the example shown in FIG. 9I, the strikers 303 in the shuttle storage bay 310 are boltheads or screwheads.

In the example shown, the storage bay 310 is an elongate structure comprising three sections, namely a rear section 311, a middle section 313 and a front section 315. The middle section 313 opens like a gate and allows shuttles to be removed or added, or to be maintained outside of the machine. In this regard, an access panel is provided on the outside of the machine to enable a user to open the pivotable middle section 313 of the storage bay 310. The middle section 313 opens about a pivot 313.2 in response to handles 313.1 being actuated to unlock the middle section 313.

The shuttle elevators 330, 340 shall now be described with reference to FIGS. 9B and 9C. The front shuttle elevator 330 travels between a bottom track 316 and a middle track 314 of the shuttle storage bay 310 and the rear shuttle elevator 340 travels between the top track 312, middle track 314 and bottom track 316. The elevators 330, 340 enable shuttles 50 to be raised or lowered to different levels of track as required.

Each shuttle elevator 330, 340 includes an elevator mount 331, 341 attached to the side frame 13 of the vehicle 1 and an elevator tray 332, 342 slidably coupled to the elevator mount 331, 341 for vertical travel up and down the mount, the elevator tray 332, 342 including a body 333, 343 having elevator track sections 334, 344 engageable with wheels of a shuttle. The elevator tray 332, 342 accommodates a single shuttle and operates to align the elevator track sections 334, 344 with tracks on one of the levels of the shuttle storage bay 310.

Each elevator tray 332, 342 includes a U-shaped base with an upstanding plate element 333.1, 343.1 that is slidably coupled to the elevator mount 331, 341 via linear bearing blocks 339.1, 349.1 that slide along rails 339, 349 mounted to the elevator mount 331, 341. A motor 336, 346 is mounted to the elevator mount 331, 341 and via a right-angle gearbox drives a pinion 337, 347 engaged with a rack 338, 348 to move the shuttle elevator tray 33, 342 up and down.

The rear shuttle elevator 340 includes a hard stop 343.2 that a shuttle 50 is driven to which provides a reference for a starting position of the shuttle 50. Each shuttle elevator 330, 340 additionally includes an inductive proximity sensor 335, 345 mounted to the plate element 333.1, 343.1 for detecting a striker 284 on the shuttle 50 and a striker (not shown) mounted to the base of the elevator tray 332, 342 which is detected by the proximity sensor 280 of the shuttle 50. Alternatively, optical proximity sensors and reflective strikers may be used.

The shuttle translator 350 moves shuttles 50 in a direction of travel orthogonal to a direction in which shuttles move in the shuttle storage bay 310. In use, shuttles 50 are translated individually between the shuttle storage bay and the carousel by the shuttle translator 350.

As shown in FIGS. 9D to 9F, the shuttle translator 350 includes translator base 351 mounted to a base frame 11 of the vehicle 1. The translator base 351 includes rails 352 that extend along it in the direction of travel of the shuttle translator 350. A translator assembly 354 is slidable coupled to the translator base 351 for slidable movement therealong. The translator assembly 354 includes a body 354.1 that slides along the rails 352 via linear bearing blocks 355. The translator assembly 354 is driven via a motor 356 that drives a pinion engaged with a rack 353 mounted to the translator base 351. The body 354.1 is of U-shaped construction with side walls to which are mounted first and second translator track sections 357, 358 that are each engageable with wheels of the shuttle 50. In this way, the shuttle translator 350 includes upper and lower track sections 357, 358. The track sections of the shuttle translator are orthogonal to the direction of travel of the translator.

In a first position of the shuttle translator 350, the first translator track section 357 (an upper track section) is aligned with the top track 312 of the shuttle storage bay 310 for receiving a departing shuttle thereon. That is, a loaded shuttle drives along the top track 312 of the shuttle storage bay 310 and onto the top track of the shuttle translator 350. The second translator track section 358 (a lower section) accommodates a return shuttle and in use, the front elevator 330 will raise so that its track section 334 is aligned with the second translator track section 358 so the return shuttle can drive from the shuttle translator 350 onto the front elevator 330 for return to the storage bay 310.

The shuttle translator 350 further includes an inductive proximity sensor 359 at each level of track 357, 358 to detect the striker plate 284 on the shuttle 50 and a striker (not shown) that is detected by the proximity sensor 280 of the shuttle 50. Alternatively, optical proximity sensors and reflective strikers may be used.

The shuttle sequencing system 300 further includes a shuttle datum assembly 360 for use in datuming the position of a block in the clamp assembly 210 of each shuttle 50. The datum assembly 360 is located next to the shuttle translator 350 proximate a distal end of the translator track sections 357, 358. The datum assembly 360 is mounted to the translator base 351 via a frame 361. The datum assembly 360 includes a slidable arm 362 having a datum plate 363 mounted at an end thereof that is vertically disposed above the top track 357 of the shuttle translator 350. A motor 364 is mounted to the frame 361 and drives a pinion 365 engaged with a rack 366 mounted to the arm 362 of the datum assembly 360. The arm 362 is mounted to a linear bearing block which slides along rail 367.

The datum plate 363 is therefore able to travel in the lengthwise direction of the translator track section 357 and its position may be varied in accordance with the block type that a particular shuttle is loaded with.

In use, as a loaded shuttle drives onto the top track 357 of the shuttle translator 350 from the shuttle storage bay 310, the datum plate 363 will translate across to a known datum location for a particular block type (the datum position will vary in accordance with block length). The shuttle 50 will unclamp the block it is carrying or loosen its clamps so that block is able to be moved by the datum plate 363. The shuttle 50 will drive the block into the datum plate causing the block to stop at that location. The shuttle 50 will continue driving forward until it contacts a shuttle hard stop 368 that is mounted to the frame 361 of the datum assembly 360. The block is then re-clamped by the shuttle in a datumed position and ready to be translated by the shuttle translator 350 across to the carousel 400.

FIGS. 9K and 9L show the shuttle translator 350 in a second position whereby it has translated across to the carousel 400 in alignment with tracks of a carousel rotator 410 so that the shuttle 50 can transition between the shuttle translator 350 and the carousel 400.

### Carousel

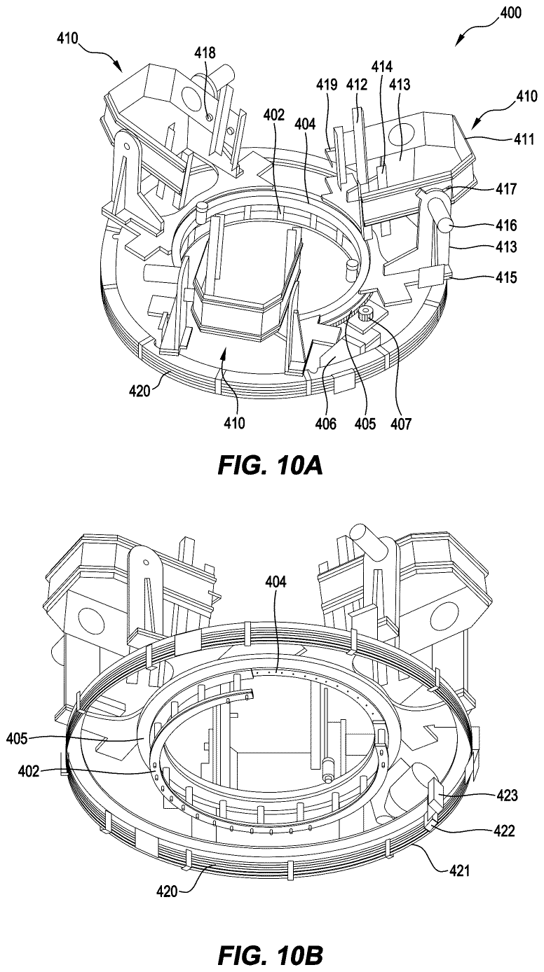

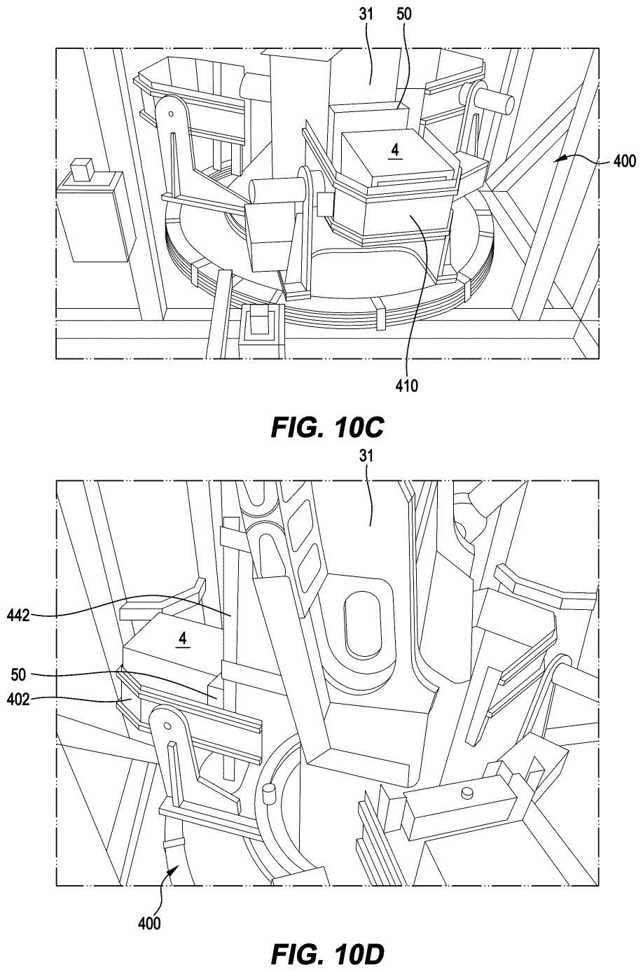

The carousel 400 will now be described with reference to FIGS. 10A and 10B.

The carousel 400 is located in the base 5 of the machine 20 and is mounted concentrically with the boom slew ring at the base of the tower 31. The carousel 400 is rotatable about the tower 31 and includes a plurality of radially spaced apart carousel rotators 410 each configured to either receive a loaded shuttle 50 from the shuttle translator 350 and rotate to align the loaded shuttle 50 with a tower track section or receive an empty shuttle from a tower track section and rotate to align the empty shuttle with the shuttle translator 350.

The carousel 400 includes a carousel support 402 that is mounted to the base frame 11 concentrically with the boom slew ring. A lubricated inner bearing ring 404 is mounted to the carousel support 402 and an outer slew ring 405 is rotationally coupled to the inner bearing ring 404. A motor 406 is mounted to the carousel support 402 and via right angle gearbox drives a gear 407 engaged with teeth of the outer slew ring 405 to cause the slew ring 405 to rotate around the fixed inner bearing ring 404.

The carousel rotators 410 are mounted to the top of the outer slew ring 405 and accordingly rotate with the outer slew ring 405. The carousel rotators 410 each include spaced apart first and second carousel rotator track sections 412, 414 mounted to opposing sides of a U-shaped body 411. The U-shaped body 411 is pivotally mounted between a pair of spaced apart support arms 413 coupled to a base plate 415 that is fixed to the outer slew ring 405. A motor 416 is mounted to one of the support arms 413 via a reduction gearbox (or Spinea Twinspin bearing reducer) 417 mounted directly to the pivot joint of the arm 413. This transmission mechanism allows the U-shaped body 411 of the carousel rotator 410 to rotate from a first position in which the rotator tracks 412, 414 are aligned with the track sections 357, 358 of the shuttle translator 350 and a second position in which the rotator tracks 412, 414 are aligned with the tower track sections.

In the example shown, the carousel 400 has three carousel rotators 410 that can store shuttles with for example cut blocks required in a block laying sequence. It will be appreciated that a different number of carousel rotators may be provided depending on the configuration of the machine and amount of buffer/storage required to execute the block sequence. The carousel 400 is powered via an electrical slip ring 420 that allows continuous rotation. Continuous rotation allows the carousel to move in the shortest direction to its next destination without limitations associated with electrical power cabling. The slip ring 420 is mounted beneath the base plates 415 of the carousel rotators 410 exterior to the inner and outer rings 404, 405. The slip ring 420 transmits power for the carousel 400 via current collector brushes 422 attached to collector arms 423 that contact copper rails 421 insulated inside the respective rings during rotation. The slip rings and brushes are made by Conductix Wampfler.

The carousel rotators 410 further include inductive proximity sensor 418 at each level of track 412, 414 to detect the striker plate 284 on the shuttle 50 and strikers 419 at each level of track 412, 414 that are detected by the proximity sensor 282 of the shuttle 50.

In use, the shuttle translator 350 moves sideways from the shuttle storage bay 310 to the carousel 400 and the carousel 400 rotates to align one of the carousel rotators 410 with the shuttle translator 350, so that a loaded shuttle can drive onto the carousel rotator 410. The carousel 400 then rotates to align the loaded carousel rotator track sections 412 with the tower track sections 442 to allow the shuttle to drive onto the tower 31 (for example as shown in FIGS. 10C and 10D).

It is to be appreciated that the boom 20 has to slew intermittently and almost continuously to move the block laying robot 40 around the building site so during the transition of a shuttle 50 between the carousel 400 and the tower 31, rotation of the carousel 400 is slaved to track the boom slew motion.

### Tower

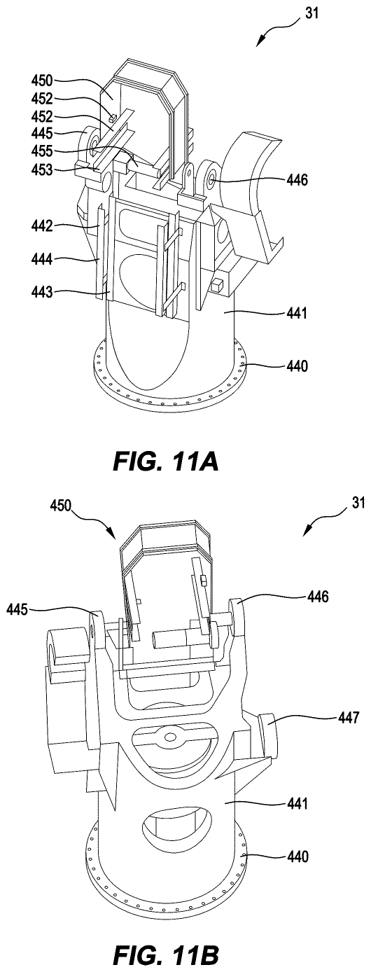

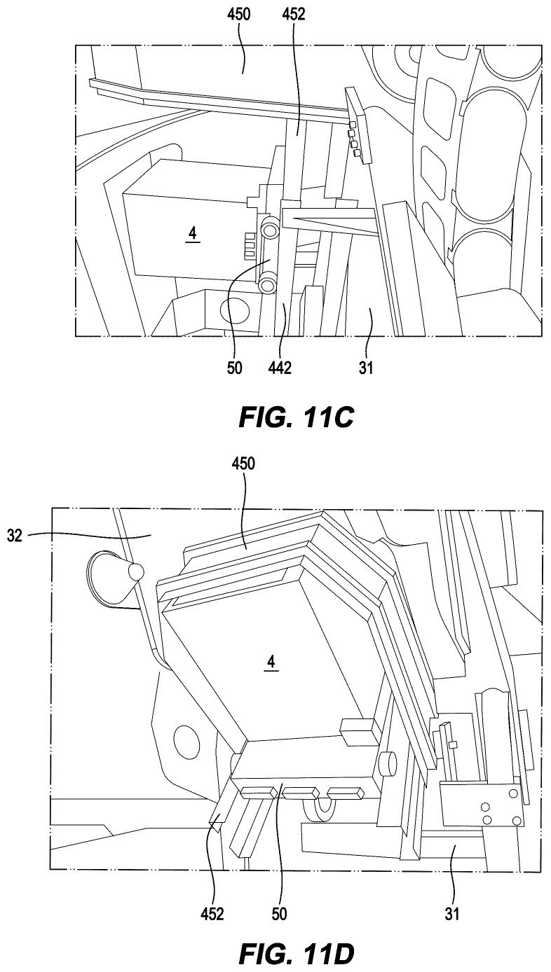

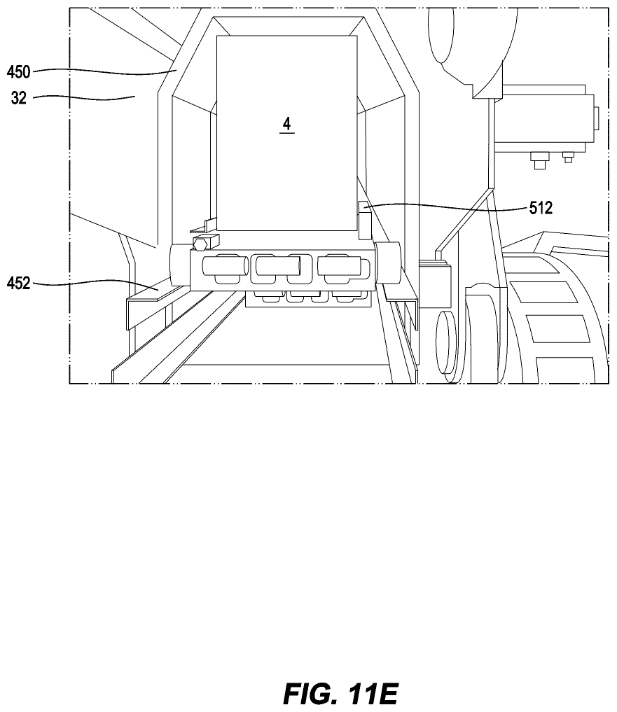

The tower 31 shall now be described with reference to FIGS. 11A to 11E.

The tower 31 is mounted via a base 440 to the boom slew ring which rotates to the required building angle. The boom slew uses a ball bearing slew ring with an integral ring gear. The slew drive is by two servo motors acting through bearing reducers (Spinea Twinspin) to pinions. Two motors are used to achieve adequate torque to resist the slew moment generated by wind blowing on the side of the boom. The two motors may also be used to eliminate backlash.

The tower 31 is supported by the boom slew ring and in turn supports the boom 30. The tower 31 includes a body 441 having a boom pivot about which a proximal end of the boom pivots. As shown in FIG. 11A, the tower 31 includes two mounting lugs 445, 446 at the boom pivot about which a bulkhead of the first boom element is pivotally mounted. A further lug 447 is provided on the tower 31 to which one end of a hydraulic lift ram for the boom is coupled.

The main body 441 of the tower 31 supports tower track sections that allow a shuttle to drive up the tower. A pair of fixed tower track sections 442, 443 are mounted to a side of the tower 31 for receiving a loaded shuttle from the carousel rotator 410 or an empty return shuttle from the tower rotator 450 as will be described in further detail below.

The tower rotator 450 is pivotally mounted to the tower 31 so as to pivot coaxially with the boom pivot. In the example shown, the tower rotator 450 includes a body having tower rotator track sections 452, 453 configured to receive one of a loaded shuttle travelling to the block laying robot 40 or an empty shuttle returning to the shuttle storage bay 310. In this regard, the tower rotator 450 is configured to pivot between a first position (see FIG. 11C) in which the tower rotator tracks 452, 453 are aligned with the tower track sections 442, 443 in order to transfer a shuttle to and from the tower 31 and a second position (see FIGS. 11D and 11E) in which tower rotator track sections 452, 453 are aligned with boom track sections in order to transfer a shuttle into and out of the boom.

During transition of a shuttle between the tower rotator 450 and the boom 30, pivoting motion of the tower rotator 450 is slaved to a lift angle of the boom. In this regard, there is provided a hydraulic lift ram for the boom which is mounted to the tower as will be described in more detail below.

The tower rotator 450 is actuated by an electric servo motor 455 that drives through a planetary gearbox that drives a pinion that drives a gear to pivot the tower rotator 450. The servo motor has an integral absolute encoder and a brake. Proximity switches 454 are used to confirm the alignment of the tower rotator with the tower 31 and first boom element. Proximity sensors detect the presence of a shuttle in the correct position to allow rotation. Proximity sensors 444 and strikers are also provided proximate the tower track sections 442, 443 to detect the shuttle and allow the shuttle to reference its position.

### Boom System

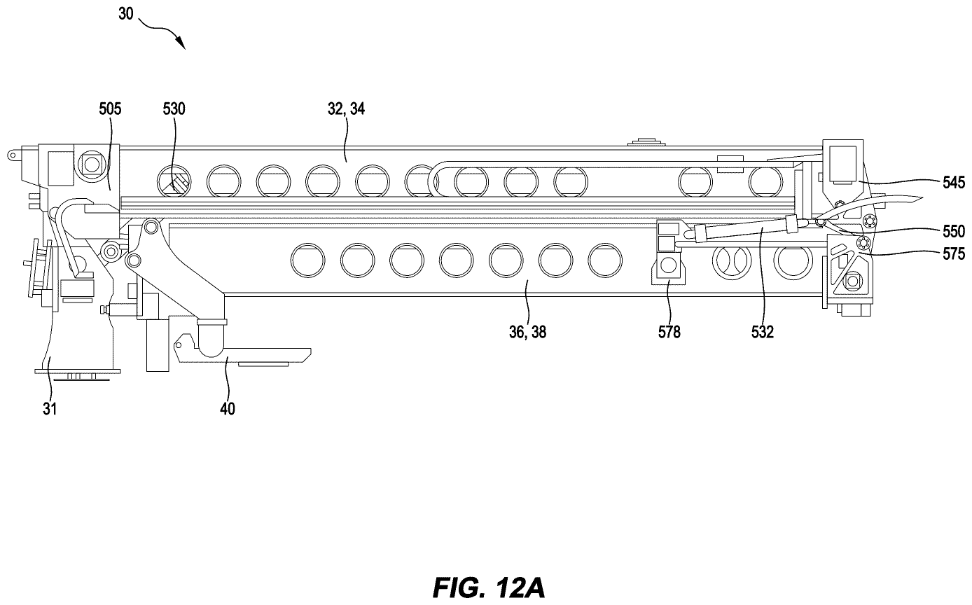

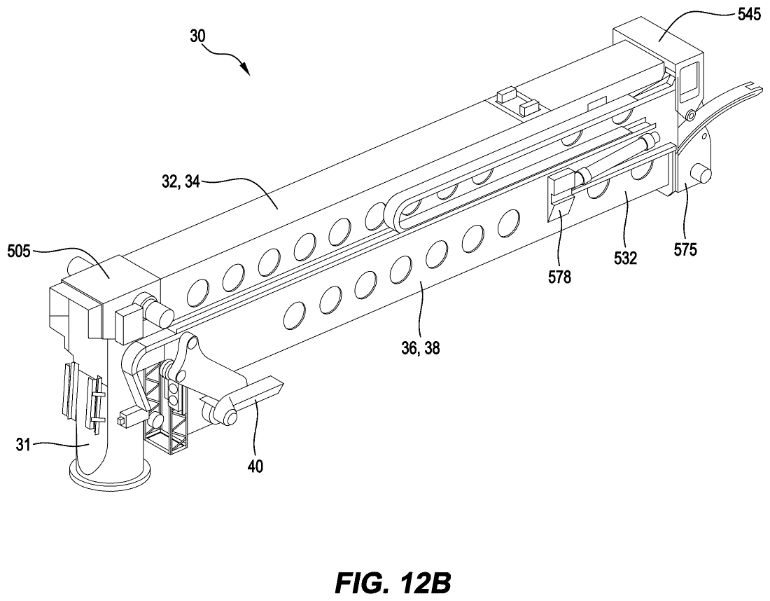

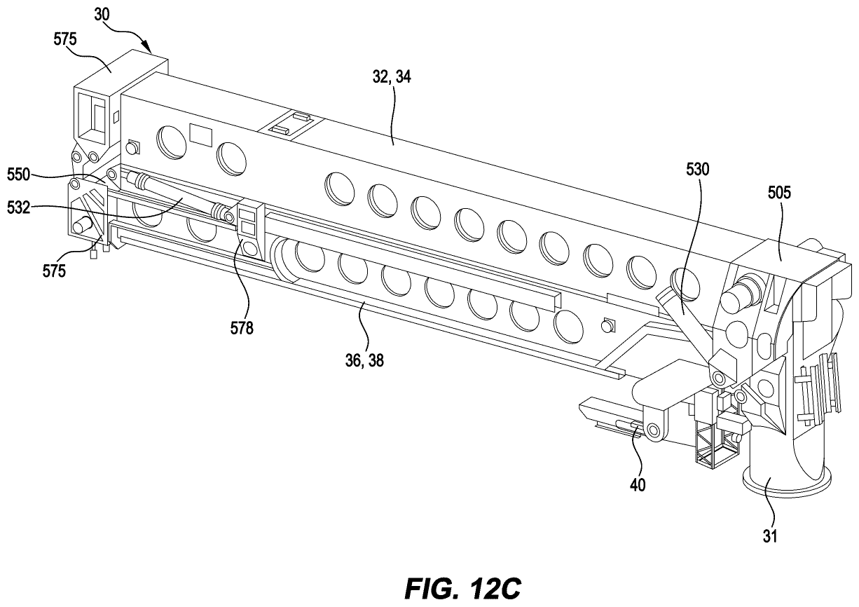

FIGS. 12A to 12C depict the boom system 30 in a folded transport position.

The first boom element 32 is pivotally connected to the tower 31 via its bulkhead 505 which is bonded to the first boom element 32 at a proximal end thereof. A hydraulic lift ram 530 provides the lift force to raise and lower the first boom element 32 and is coupled between the tower 31 and bulkhead 505 of the first boom element 32. A second boom element 34 is telescopically connected to the inside of the first boom element 32 and includes a bulkhead 545 at a distal end thereof. A first stick element 36 having a bulkhead 575 at a proximal end thereof is pivotally coupled to the second boom element at a pivot or luff joint. A pair of symmetrically disposed hydraulic rams 532 are coupled between the second boom element 34 and the first stick element 36 to provide the luff force to manipulate the angle of the sticks. The hydraulic rams 532 are connected between a fitting 578 on the first stick element 36 and a dog bone linkage 550 that is coupled between the bulkheads 545, 575 of the second boom element 34 and first stick element 36. A second stick element 38 is telescopically connected to the inside of the first stick element 36 and is pivotally connected at a distal end thereof to the block laying robot 40.

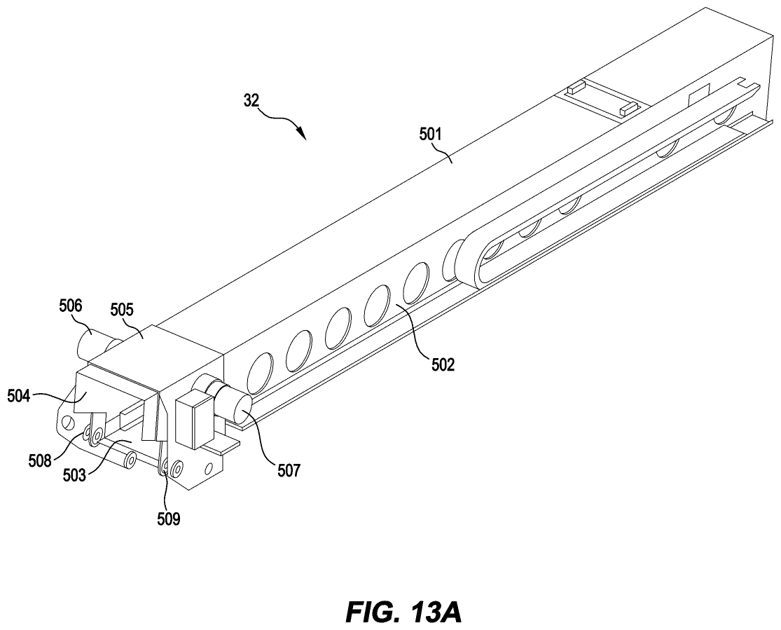

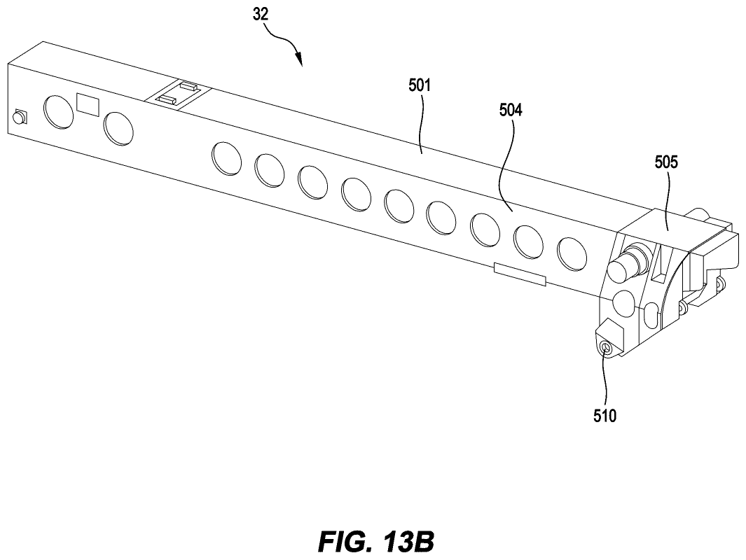

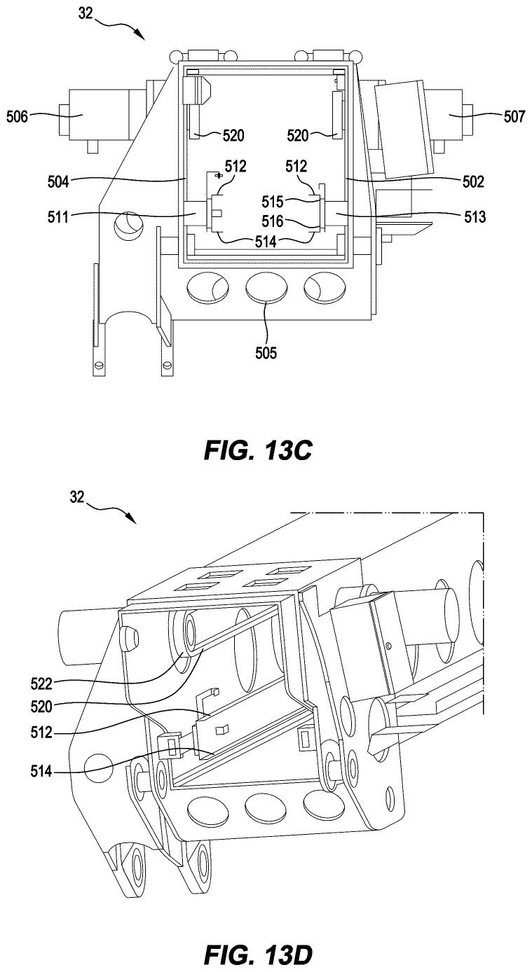

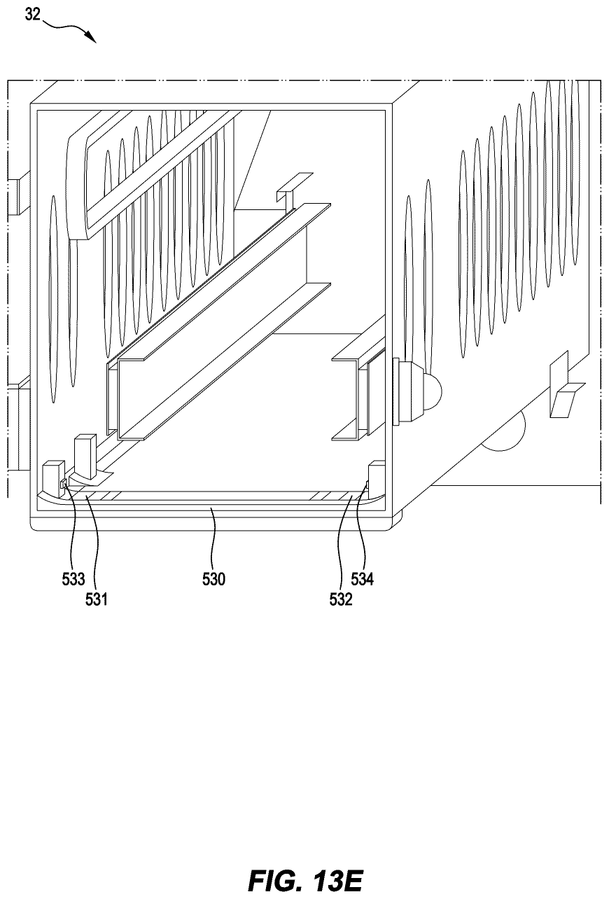

The first boom element 32 (see FIGS. 13A to 13E) mounts to the tower 31 with a welded steel bulkhead pivot fitting 505. The bulkhead fitting 505 is bonded to a composite carbon fibre tube constructed from four flat sandwich panels 501, 502, 503, 504 bonded to either aluminium extrusions at the corners or a build-up of carbon fibre angle sections. Ultra-high modulus prepreg carbon fibre is used to obtain high stiffness at low weight. The bulkhead 505 is pivotally mounted to the tower 31 at mounting lugs 508, 509 disposed about opposing sides thereof which are pinned through corresponding lugs 445, 446 of the tower 31. The bulkhead 505 includes a further lug 510 through which the hydraulic ram 530 is connected. One end of the ram 530 is connected to lug 447 of the tower 31 so that extension and retraction of the ram 530 causes the boom lift angle to change relative to the tower.

The first boom element 32 includes a pair of internal tracks having a top track 512 and a bottom track 514. The tracks are mounted via brackets 511, 513 attached to the bulkhead 505 of the first boom element 32 so as to be offset from the side panels thereof. The tracks of the first boom element 32 form the inner track of the telescoping connection with a respective outer track of the second boom element. To this end, the tracks include upper and lower spigots 515, 516 configured for sliding interconnection with corresponding channels forming part of the tracks of the second boom element as will be described in more detail below. In the example shown, the tracks of the first boom element 32 include a composite core that is inserted in a web section of the C-shaped carbon fibre tracks.

As shown in FIG. 13E, the first boom element 32 supports self-aligning linear roller bearing blocks 531, 532 (e.g. bearing skates) for the telescopic motion of the second boom element 34 that telescopes inside of the first boom element 32. The bearing blocks 531, 532 are mounted to a fitting 530 installed on the inside of the tube. The first boom element 32 typically includes linear roller bearing blocks on both lower and upper sections of the boom element along which the second boom element 34 slides. Wear pads 533 are also typically mounted inside the first boom element which the telescopic element slides past and which act as a sacrificial wear component and laterally locate the second boom element 34. The bearing blocks can pitch and roll slightly so that all contact rollers uniformly contact the steel bearing strips of the second boom element.

The second boom element 34 is moved telescopically by a chain 520 driven by a sprocket 522 driven by geared electric servo motor mounted on the first boom element 32. In the example shown, a pair of motors 506, 507 are mounted about opposing sides of the bulkhead 505 and each drive a sprocket 522 and chain 520 on opposing sides of the boom element. The chains 520 are coupled to the second boom element 34 via adjustable chain linkage elements mounted to fittings on the outside of the second boom element 34 which enable the chain tension to be varied. The chain drive forms an endless loop and acts as a winch to extend and retract the second boom element. Providing a double chain arrangement provides for redundancy.

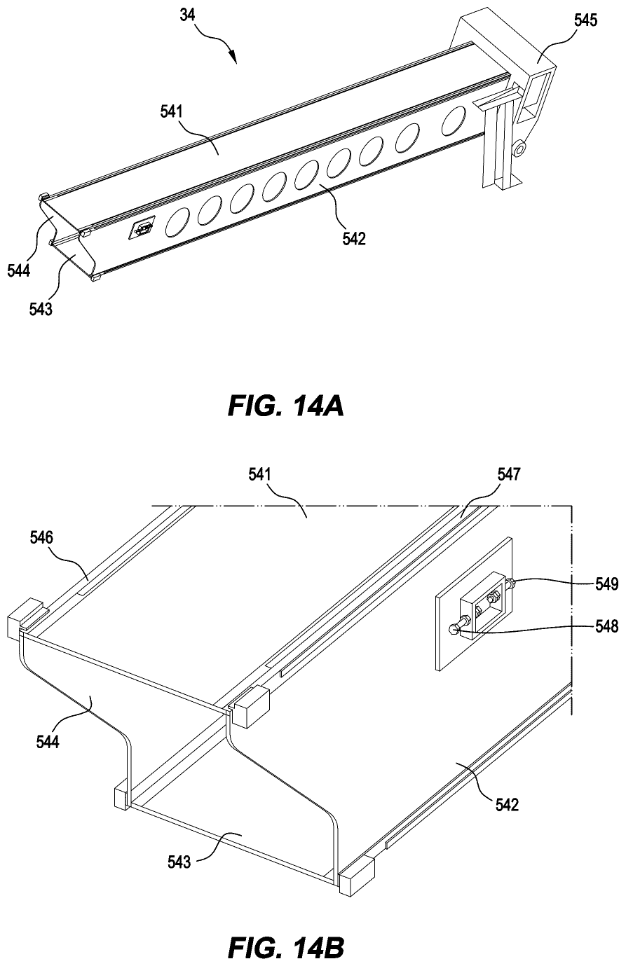

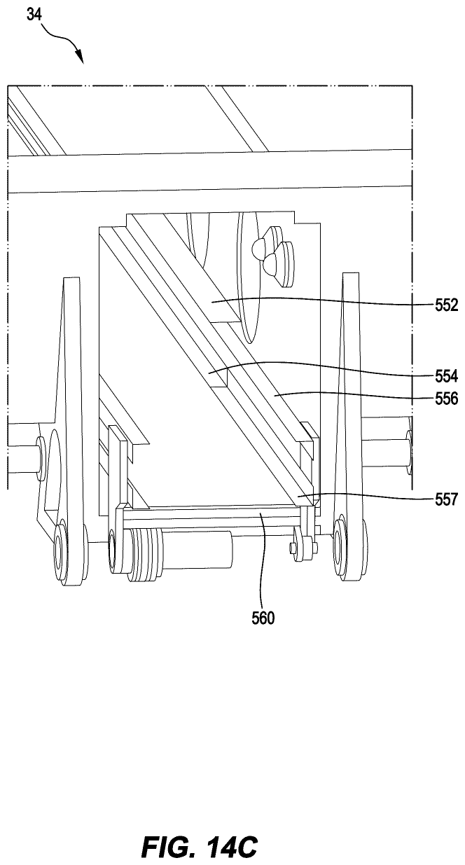

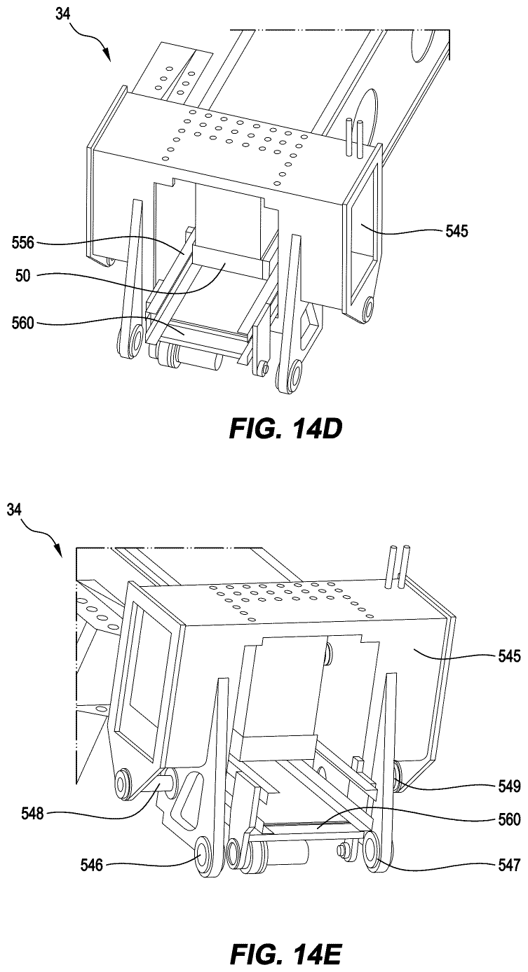

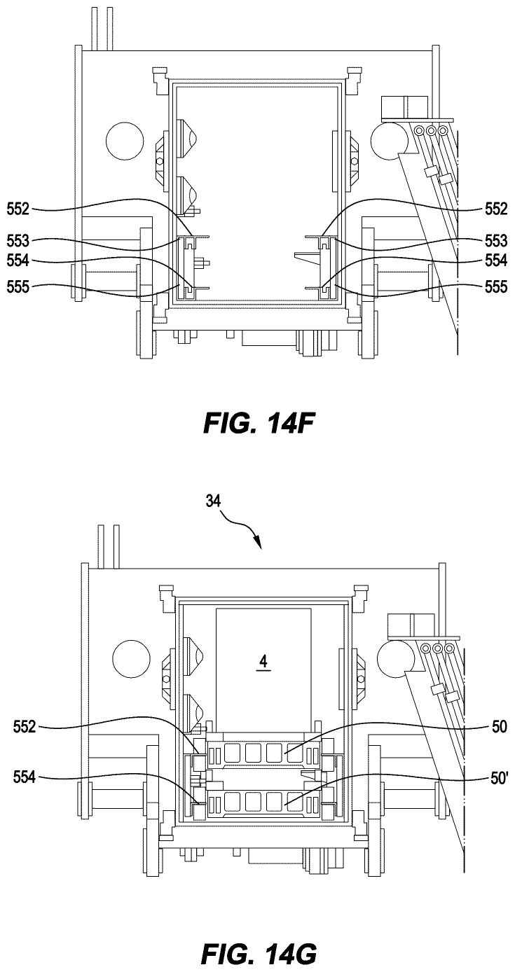

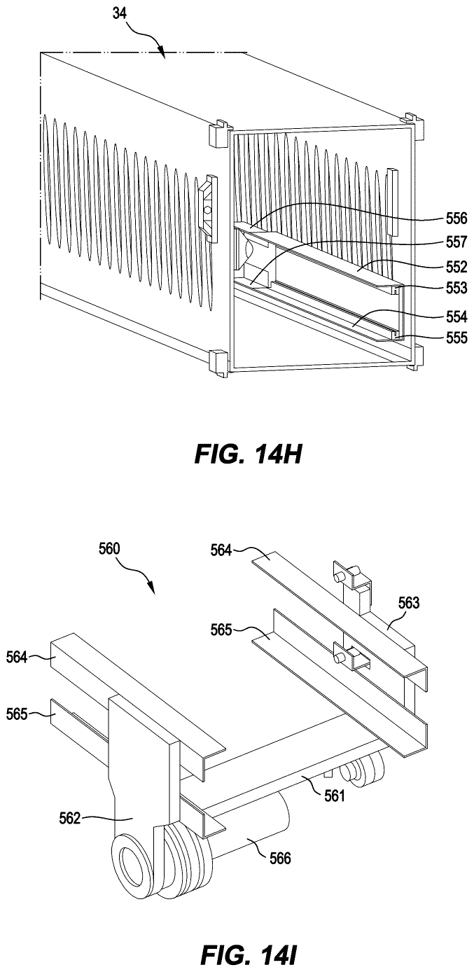

The second boom element 34 (as shown in FIGS. 14A to 14I) comprises a composite carbon fibre tube and at its tip it is bonded to a welded aluminium luff joint pivot fitting 545. The 6061-0 aluminium luff joint fitting 545 is heat treated to 6061-T6 or 6061-T4 after welding. The composite tube is constructed from four flat sandwich panels 541, 542, 543, 544 bonded to either aluminium extrusions at the corners or built-up carbon fibre angle sections. Ultra-high modulus prepreg carbon fibre is used to obtain high stiffness at low weight.

In one example, the aluminium corner extrusions have dovetail grooves that hard steel bearing strips are captured in. The corner extrusions are shaped to simplify the bonding process. In the example shown, a build-up of carbon fibre angle sections are used in the corners to bond the panels together. Steel bearing strips 546, 547 are mounted along the upper and lower corner surfaces and mechanically clamped by bevel keeper plates fastened thereto as shown in FIG. 14B.

As mentioned, the second boom element 34 is moved telescopically by chains 520 driven on sprockets 522 by geared electric servo motors 506, 507 mounted on the first boom element 32. The second boom element 34 includes a pair of adjustable chain linkage elements 548, 549 mounted to fittings installed either side of the second boom element 34. Each chain 520 is broken at this point and each end is pinned to one of the chain linkage elements 548, 549 to connect the chain to the second boom element 34. The chain linkage elements 548, 549 may be adjusted to vary the tension of the chain 520. It is thus to be appreciated that the telescoping motion of the boom elements is chain driven by redundant double chains and electric servo motors.

Along the upper and lower corners of the second boom element 34 there are hard steel bearing strips 546, 547 mounted thereto which provide bearing surfaces for the telescopic motion inside the first boom element 32. In the arrangement shown, the bearing strips 546, 547 are retained by elongate plates which are fastened to the tube about the respective corners. In an alternative arrangement, aluminium extrusions are used to bond the carbon fibre panels and the extrusions are manufactured with dovetail grooves that the bearing strips are captured in.

The second boom element 34 has internally mounted tracks including a top track 552 along which loaded shuttles 50 travel along to the block laying robot and a bottom track 554 that empty shuttles 50′ return along as shown in FIGS. 14F and 14G. The tracks form part of a C-shaped carbon fibre channel extrusion that is mounted to opposing inner surfaces of the side panels 542, 544. The extrusions capture U-shaped channel inserts 553, 555 made of acetal in their upper and lower corners proximate a web portion thereof. The web of the C-shaped carbon fibre track extrusion includes a composite core to provide strength and reduce the weight of the tracks. In use, the tracks of the first boom element 32 telescope inside of the tracks of the second boom element 34. The spigots 515, 516 (see FIG. 13C) of the tracks mounted to the first boom element 32 are received within the channel inserts 553, 555 forming part of the tracks of the second boom element 34 to facilitate telescoping motion of the respective tracks.

At a distal end of the second boom element 34 proximate the luff rotator 560, there is provided a short static track section comprising top track element 556 and bottom track element 557. This section of track provides a location for shuttles to wait until the luff rotator 560 is in alignment with the second boom element 34. This section of track also allows common telescoping tracks to be used for the boom and sticks (due to boom elements being slight longer than sticks).

The luff rotator 560 is mounted to the luff joint pivot fitting (e.g. bulkhead) 545 so that its axis of rotation is aligned with the pivot axis between second boom element 34 and first stick element 36. The luff rotator 560 is a device with upper and lower track sections that is operable to transition shuttles over the luff joint (i.e. pivot joint) between the second boom element 34 and first stick element 36 by alternately rotating to align its track sections with tracks in either the second boom element or first stick element.

The luff rotator 560 is shown in detail in FIG. 14I and includes an electric servo motor 566 driving a reduction gearbox coupled to a driving boss element 562 to which are mounted track segments 564, 565. A driven boss 563 mounting opposing track segment 564, 565 is rigidly connected to the driving boss via a plate 561. The luff rotator 560 is rotatable about its mount on the bulkhead 545.

The pivot or luff joint between the boom and stick elements uses rams pushing on an aluminium linkage to provide 180 degrees of articulation. The boom has two hydraulic luff rams having position encoder feedback. The luff rams have integral load holding valves. The luff rams are connected by hoses to a proportional valve in the base of the machine. A single proportional valve spool controls the oil to both rams. Accordingly, the boom is articulated and telescoping.

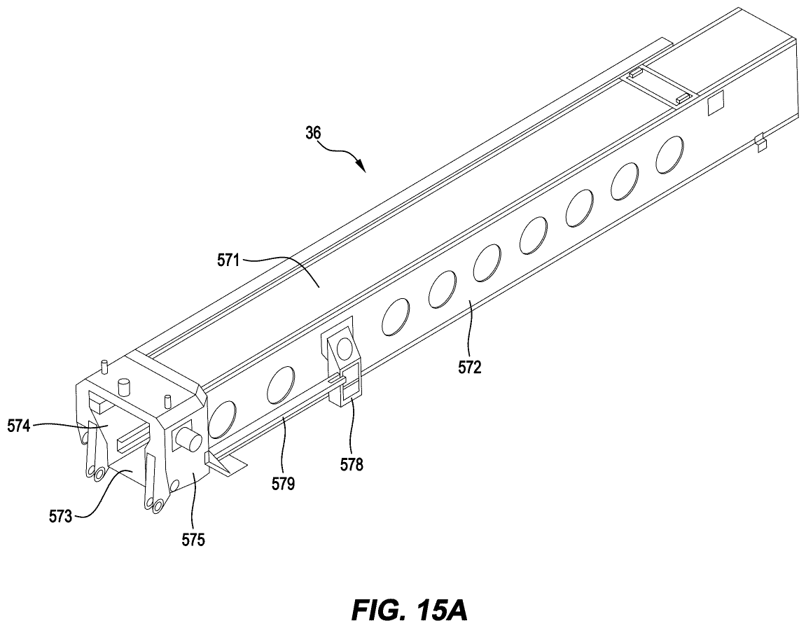

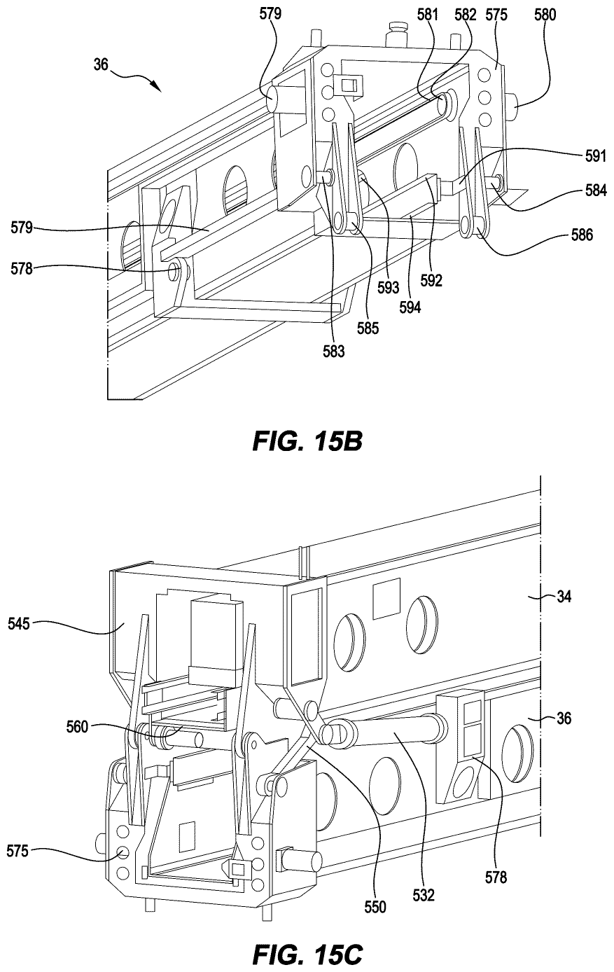

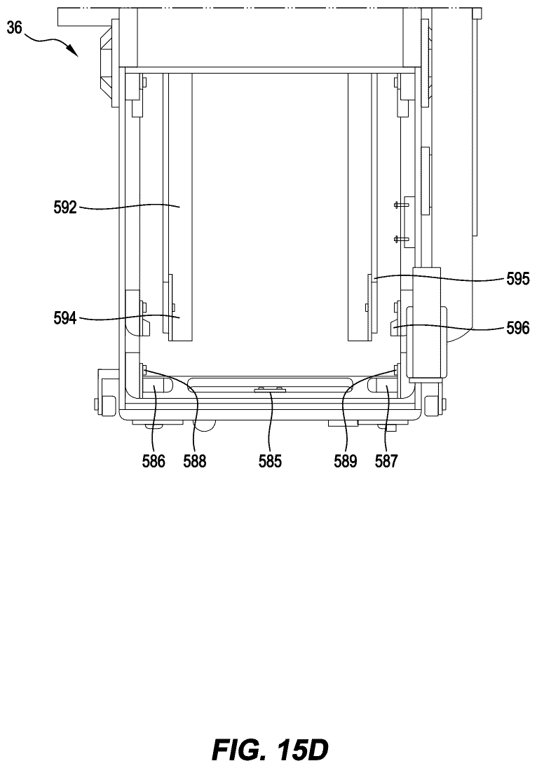

The bulkhead 545 is pivotally connected to the bulkhead 575 at the proximal end of the first stick element 36 via mounting lugs 546, 547 disposed about opposing sides of the second boom element 34. The bulkhead 545 further includes connection points 548, 549 that pin one leg of the dog bone linkage 550 coupled between the second boom element 34, first stick element 36 and hydraulic luff ram 532 as shown in more detail in FIG. 15C.

The first stick element 36, shown in FIGS. 15A and 15B, is connected to the luff joint. There is a welded and post weld heat treated aluminium 6061-T6 fitting or bulkhead 575 bonded to a composite tube. The composite tube is constructed from four flat sandwich panels 571, 572, 573, 574 bonded to either aluminium extrusions at the corners or built-up carbon fibre angle sections. Ultra-high modulus prepreg carbon fibre is used to obtain high stiffness at low weight. The luff ram pins are in double shear. The hydraulic luff rams 532 are pinned at one end to an aluminium fitting 578 bonded to the tube and spaced apart from the bulkhead 575. The other end of the rams is connected to the head of the dog bone linkage 550 with the second leg of the linkage connected to connection points 583, 584 of the bulkhead 575. The bulkhead 575 is pivotally connected to the bulkhead 545 of the second boom element 34 by pins through mounting lugs 585, 586. A composite link 579 supports fitting 578 to reduce peel stress to the panel 572.

The first stick element 36 includes a pair of internal tracks having a top track 592 and a bottom track 594. The tracks are mounted via brackets 591, 593 attached to the bulkhead 575 of the first stick element 36 so as to offset from side panels thereof. The tracks of the first stick element 36 form the inner track of the telescoping connection with a respective outer track of the second stick element 38. The tracks include upper and lower spigots 595, 596 configured for sliding interconnection with corresponding channels forming part of the tracks of the second stick element as will be described in more detail below. In the example shown, the tracks of the first stick element 36 includes a composite core that is inserted in a web section of the C-shaped carbon fibre tracks. Common track pairs are used in four locations (same assembly used on left and right in boom and stick).

As shown in FIG. 15D, the first stick element 36 supports self-aligning linear roller bearing blocks 586, 587 (e.g. bearing skates) for the telescopic motion of the second stick element 38 that telescopes inside of the first stick element 36. The bearing blocks 586, 587 are mounted to a fitting 585 installed on the inside of the tube. The first stick element 36 typically includes linear roller bearing blocks on both lower and upper sections of the stick element along which the second stick element 38 slides. Wear pads 588, 589 are also typically mounted inside the first stick element which the telescopic element slides past and which act as a sacrificial wear component and laterally locate the second stick element 38.

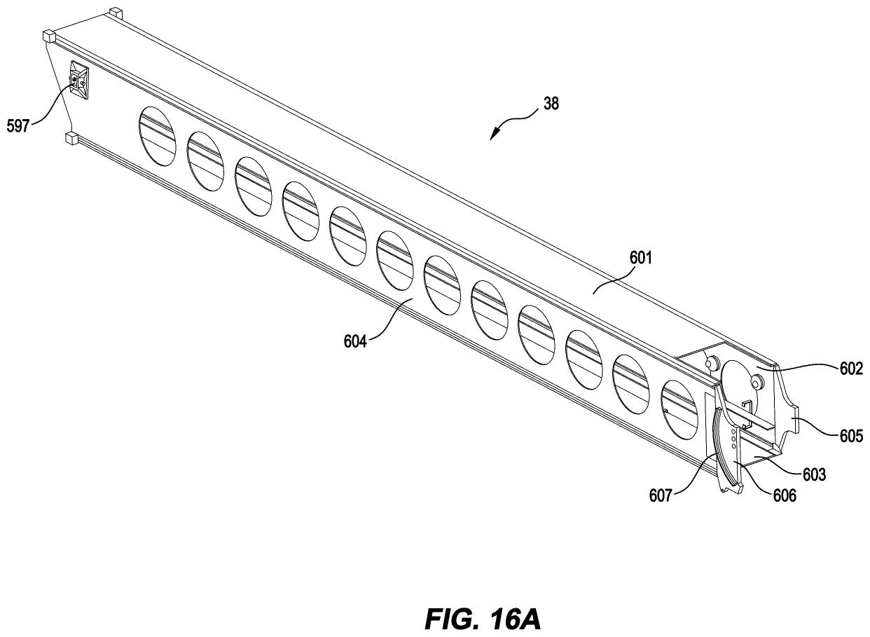

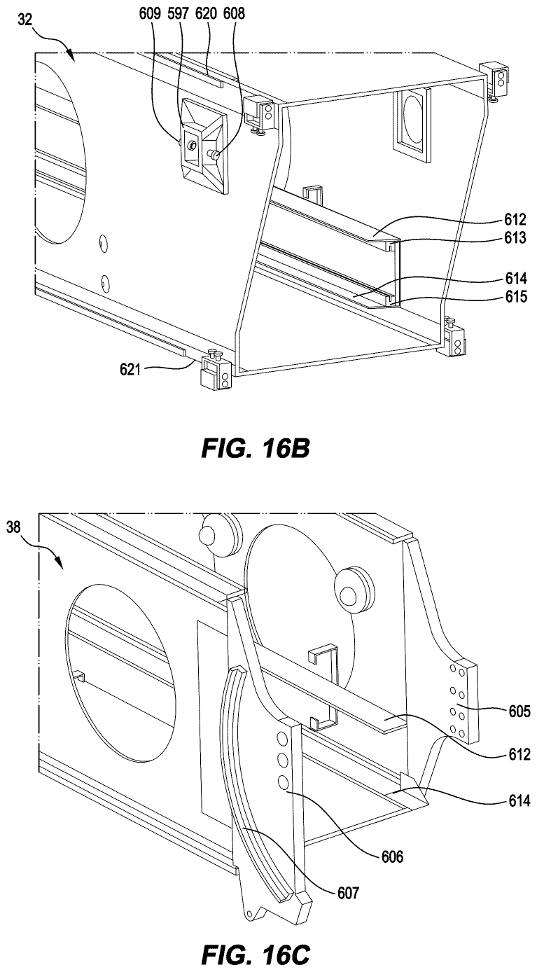

The second stick element 38 is moved telescopically by a chain 581 driven by a sprocket 582 driven by geared electric servo motor mounted on the first stick element 36. In the example shown, a pair of motors 579, 580 are mounted about opposing sides of the bulkhead 575 and each drive a sprocket 582 and chain 581 on opposing sides of the stick element. The chains 581 are coupled to the second stick element 38 via adjustable chain linkage elements mounted to fittings 597 (see FIG. 16A) on the outside of the second stick element 38 which enable the chain tension to be varied. The chain drive forms an endless loop and acts as a winch to extend and retract the second stick element. Providing a double chain arrangement provides for redundancy.

The second stick element 38 is shown in further detail in FIGS. 16A to 16C. The second stick element 38 telescopes inside the first stick element 36 and is also a composite tube constructed from four flat sandwich panels 601, 602, 603, 604 bonded to either aluminium extrusions at the corners or carbon fibre angle sections. Ultra-high modulus prepreg carbon fibre is used to obtain high stiffness at low weight. The bearing strips 620, 621 are mounted in the same manner as described for the second boom element 34 for sliding engagement with bearing skates 586, 587 mounted to the first stick element 36.

The second stick element 38 is moved telescopically by chains 581 driven on sprockets 582 by geared electric servo motors 579, 580 mounted on the first stick element 36. The second stick element 38 includes a pair of adjustable chain linkage elements 608, 609 mounted to fittings 597 installed either side of the second stick element 36 near a proximal end thereof as shown in FIG. 16B. Each chain 581 is broken at this point and each end is pinned to one of the chain linkage elements 608, 609 to connect each to the second stick element 38. The chain linkage elements 608, 609 may be adjusted to vary the tension of each chain 581. It is thus to be appreciated that the telescoping motion of the sticks is chain driven by redundant double chains and electric servo motors in a similar fashion to the telescoping boom elements.

The second stick element 38 has internally mounted tracks including a top track 612 along which loaded shuttles travel along to the block laying robot and a bottom track 614 that empty shuttles return along as shown in FIGS. 16B and 16C. The tracks form part of a C-shaped carbon fibre channel extrusion that is mounted to opposing inner surfaces of the side panels 602, 604. The extrusions capture U-shaped channel inserts 613, 615 made of acetal in their upper and lower corners proximate a web portion thereof. The web of the carbon fibre C-shaped track extrusion includes a composite core to provide strength and reduce the weight of the tracks. In use, the tracks of the first stick element 36 telescope inside of the tracks of the second stick element 38. The spigots 595, 596 of the tracks mounted to the first stick element 36 are received within the channel inserts 613, 615 forming part of the tracks of the second stick element 38 to facilitate telescoping motion of the respective tracks.

At the distal end of the second stick element 38, there are aluminium bosses 605, 607 that extend out from opposing side panels 602, 604. The support tower of the block laying robot 40 is pivotally connected to the second stick element 38 via these bosses 605, 607. Boss 607 includes a curved rack 607 mounted thereto engageable with a gear driven by a motor mounted to the support tower to articulate the support tower about the end of the second stick element 38 (e.g. during pack-up of the boom system for transport and unpack of the boom system for operation).

### Block Laying Robot

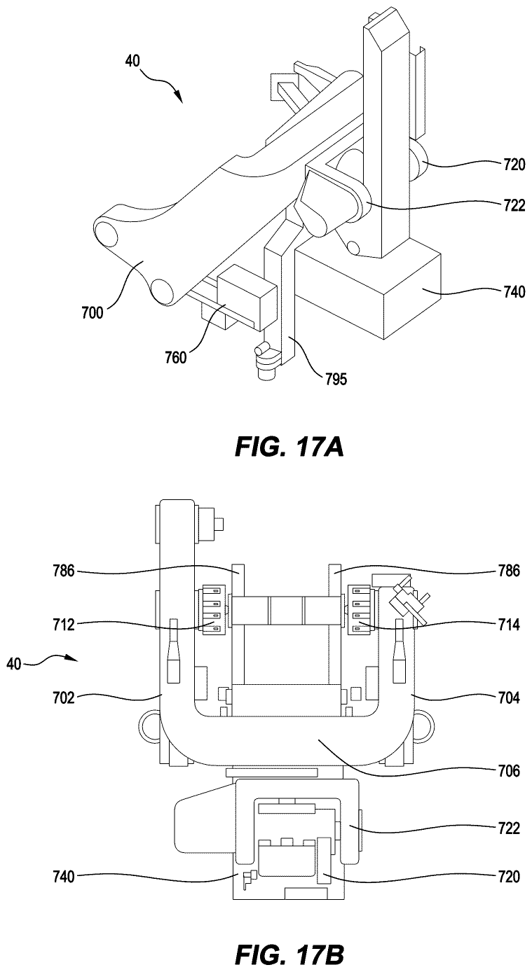

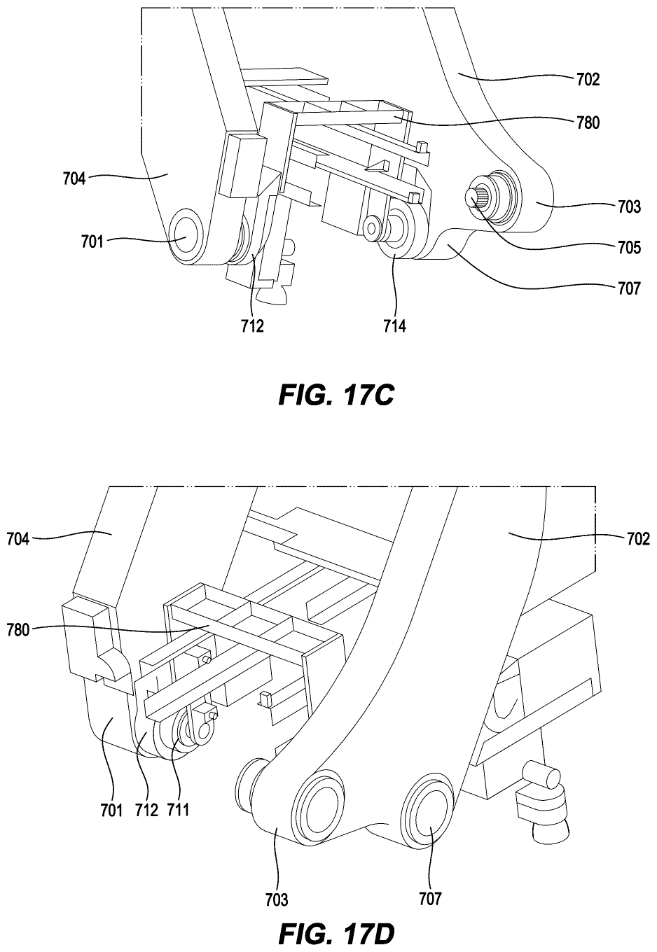

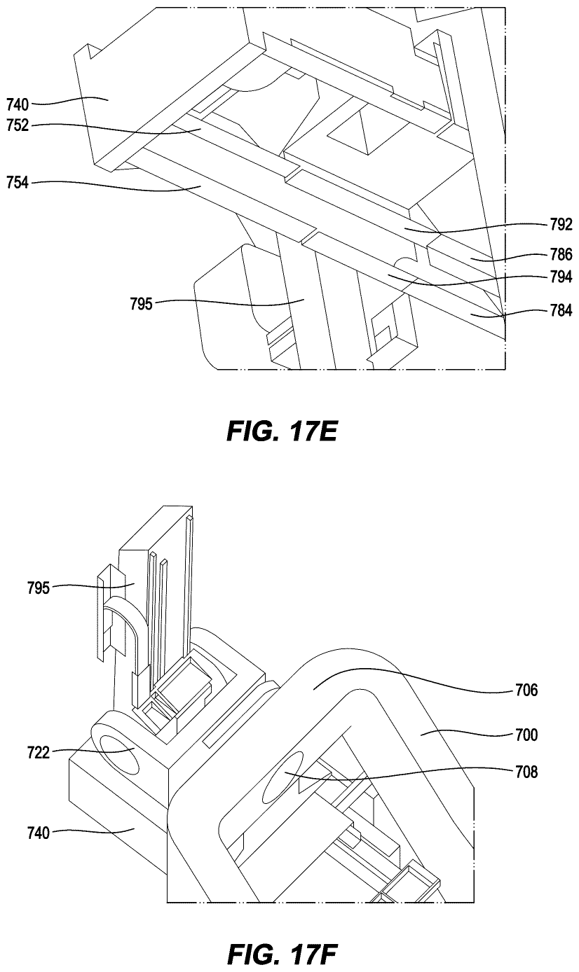

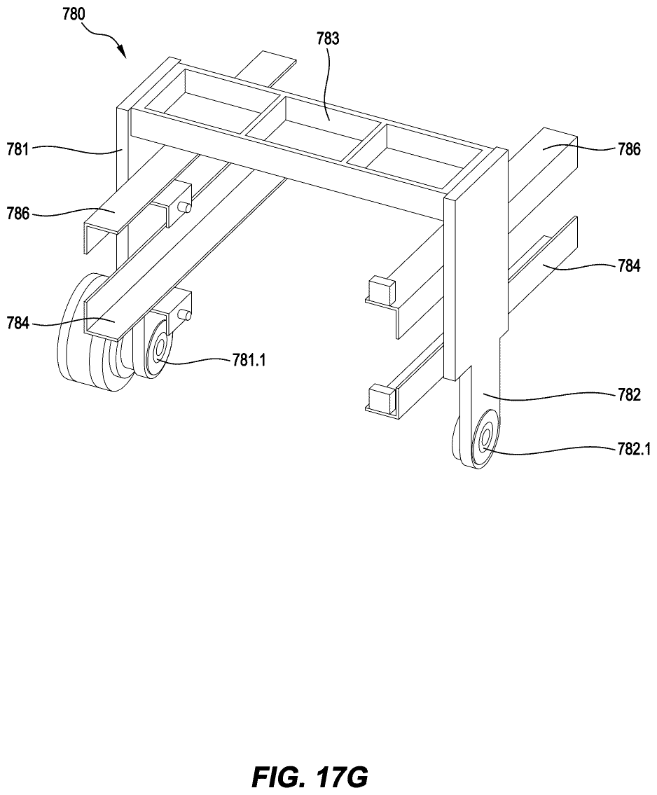

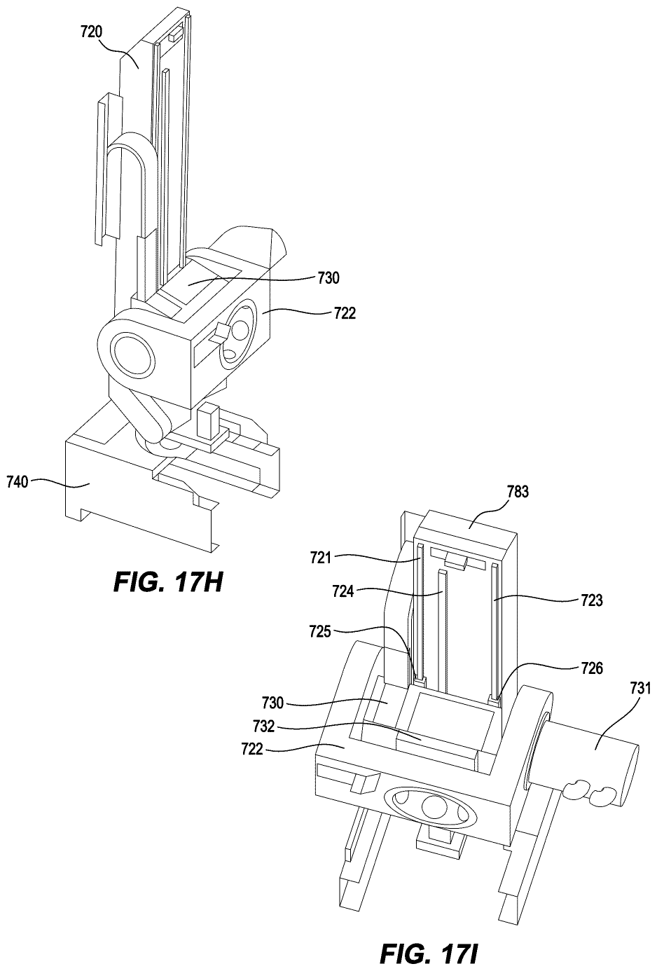

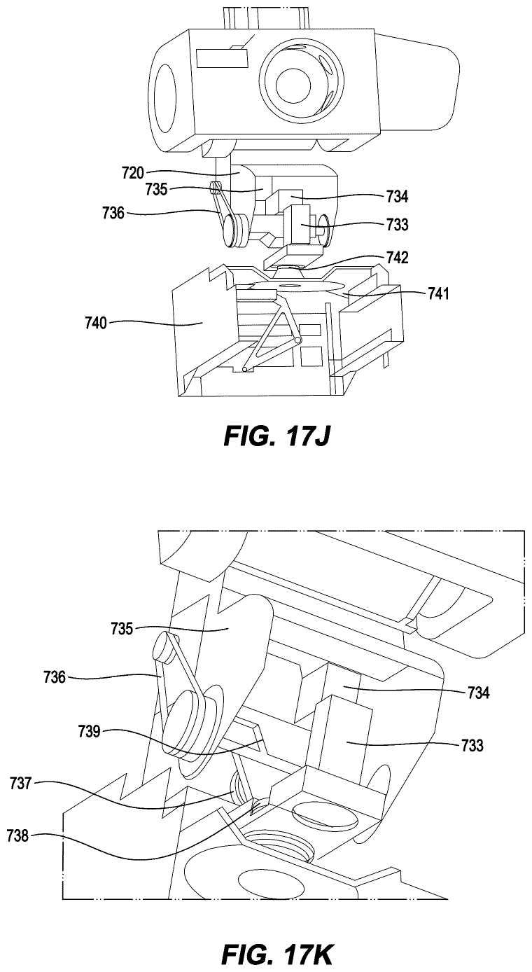

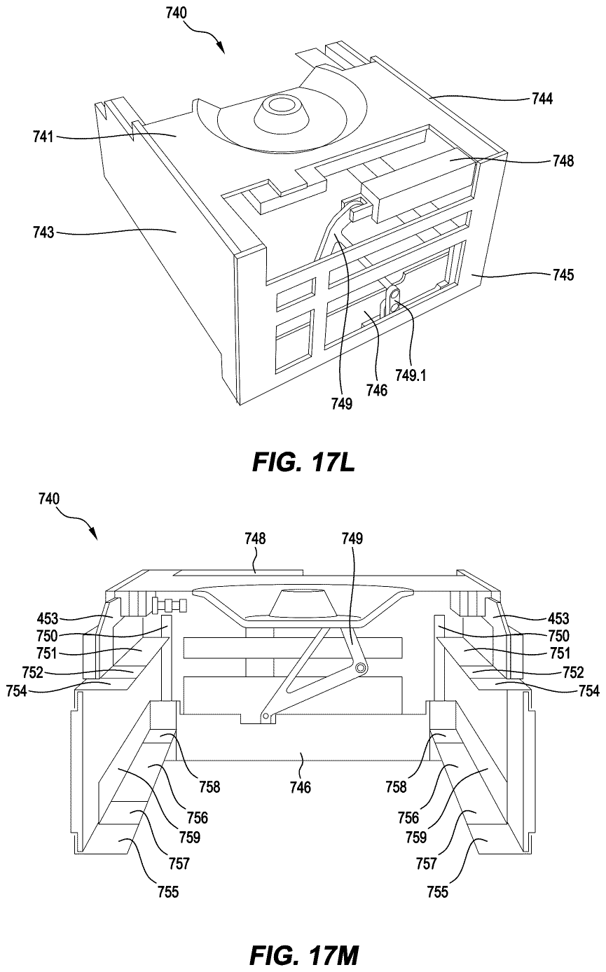

The block laying robot 40 shall now be described in further detail with reference to FIGS. 17A to 17M. The block laying robot 40 forms part of the laying head and depends from a support tower 700 that is pivotally connected to a distal end of the second stick element 38. The block laying robot 40 includes a laying arm 720 having an end effector 740 configured to receive a loaded shuttle therein. The end effector 740 is moved to a block laying location at which point the shuttle releases the block and completes a laying action. As will be described in further detail below, the empty shuttle is then elevated from a lower track section of the end effector to an upper track section of the end effector and the laying arm moves the end effector back to a neutral position to allow the empty shuttle to drive off from the end effector and for another loaded shuttle to drive on.

The support tower 700 of the block laying robot 40 comprises a clevis shaped body having a pair of arms 702, 704 via which the support tower 700 is pivotally mounted to the end of the second stick element 38 for controlled rotation relative thereto. The arms 702, 704 extend upward at an angle of inclination from the pivot with the second stick element and are joined by a bridge 706. In the example shown, the support tower 700 is of carbon fibre construction.

The arms 702, 704 terminate at their lower end in mounting lugs 701, 707 and 703. An axis through lugs 701, 707 forms the pivot axis with the second stick element. Connection plates 712, 714 are mounted to bosses 605, 606 at the end of the second stick element 38 and are rotationally coupled to the arms 702, 704 of the support tower 700. The drive to rotate the support tower is housed in lug 703 which is offset from lug 707 on arm 702. A motor via gearbox or Spinea reducer drives a pinion 705 which is engaged with curved rack 607 on boss 606 of the second stick element 38. Actuation of this drive causes the support tower 700 to pivot about the end of the second stick element 38.

As a shuttle drives from the second stick element to the block laying robot 40, it is first received on tracks of a shuttle rotator 780. The shuttle rotator 780 rotates about the pivot axis of the support tower 700 and is driven via a motor housed in lug 701 coupled to a bearing reducer 711 connected to the shuttle rotator 780. As shown in FIG. 17G, the shuttle rotator 780 includes a pair of spaced apart side plates 781, 782 connected via a bridge plate 783. Ends of the side plates 781.1, 782.1 provide mounting lugs that are pivotally connected to the support tower 700 proximate connection plates 712, 714. Upper and lower track sections 784, 786 are mounted to the side plates 781, 782 for receiving shuttles thereon. In use, a loaded shuttle drives from the second stick element 38 onto an upper track 784 of the shuttle rotator 780. In this orientation, the shuttle and block are in their normal orientation with the block above the shuttle. The shuttle rotator 780 then rotates 180 degrees so that the upper track 784 becomes a lower track and the shuttle is inverted so that the block is facing downward in a laying orientation. The inverted shuttle then drives onto a lower track of the end effector of the block laying robot 40 optionally via a fixed section of track mounted to the support tower or ancillary structure (e.g. rain cover structure 795). In reverse, an empty returning shuttle drives onto the ‘lower track’ 786 of the inverted shuttle rotator 780 and is flipped back the right way up to then drive onto a lower track 614 of the second stick element 38.

In the example shown, the block laying robot 40 is a spherical geometry robot wherein the laying arm 720 is linearly extendable (in radius) and rotationally controllable in roll and pitch via a yoke 722 whilst the end effector is controllable in roll, pitch and yaw via a wrist mount. Accordingly, six degrees of freedom (6DOF) are provided for controlling the robot to enable the end effector to be positioned with high accuracy in both position and orientation.

As shown in FIGS. 17H and 17I, the block laying robot 40 includes a yoke 722 rotationally coupled to the bridge 706 of the support tower 700. The yoke 722 is able to roll about a support tower mount 708 and is driven by a Spinea Twinspin bearing reducer driven by an electric servo motor (not shown) housed within the support tower mount 708. The laying arm 720 is slidingly coupled to a rotator 730 that is rotationally coupled between arms of the yoke 722. The rotator 730 is driven by a Spinea Twinspin bearing reducer driven by an electric servo motor 731 which is operable to control the pitch of the laying arm 720.

The rotator 730 has linear bearing blocks 725, 726 mounted to an external face which are engaged with rails 721, 723 mounted lengthwise to the rear face of the laying arm 720. A motor with brake 732 is housed within the rotator 730 which drives a pinion via a toothed belt, the pinion engaged with rack 724 mounted to the laying arm 720. Accordingly, linear movement along the Z axis is provided which enables the laying arm 720 to move up and down relative to the yoke 722.

The wrist joint of the block laying robot 40 which connects the laying arm 720 to the end effector 740 shall now be described in further detail with reference to FIGS. 17J and 17K. As previously mentioned, the wrist joint provides roll, pitch and yaw movement to the end effector 740. The end effector 740 includes a top plate 741 that is rotationally coupled to the wrist via a Twinspin bearing reducer driven by a pulley connected with a belt 738 driven by motor 733 which provides rotation in the yaw orientation. The wrist further includes motor 734 which drives a belt 737 and pulley driving a Twinspin that provides rotation in the roll direction. Rotation in pitch is provided via motor 735 which drives a belt 736 and pulley driving a Twinspin which causes a body 739 of the wrist to pitch.

In this example, the end effector 740 is an attachment on the end of the laying arm 720 that manipulates shuttles in order to lay blocks. In the example shown, the end effector 740 includes a frame depending from a wrist of the laying arm 720, the frame having a top plate 741 coupled to the wrist, the top plate 741 connected to opposing side plate members 743, 744 and an end plate 745. The frame provides a substantially box shaped structure open on two faces.

The end effector 740 includes upper and lower tracks some of which are rigidly fixed to the frame and some of which are mounted to an elevator which enables those track sections to be raised and lowered. The elevator is slidably coupled to the frame and is configured to raise an empty shuttle after it has laid a block from a lower section of track to an upper section of track. The elevator includes a cross-beam 746 that spans across the end plate 745 and which has linear bearing blocks mounted thereto slidingly coupled to spaced apart rails 750 fixed to end plate 745. The cross-beam 746 is able to travel up and down relative to the end plate 745. The elevator is rigidly connected to lower track sections 757, 758 which are spaced apart flange sections of an L-shaped channel 759 which has no bottom flange between the lower track sections 757, 758.

The movable lower track sections 757, 758 form part of the elevator and move up and down with the cross-beam 746. An actuation assembly is provided in the form of a pneumatic cylinder 748 and a bell crank 749 coupled between a piston of the cylinder 748 and the cross-beam 746, wherein the bell crank 749 pivots in response to piston extension and retraction so as to raise or lower the elevator. The bell crank 749 pivots about a pinned connection to the end plate 745 and is joined to a linkage 749.1 which is coupled to the cross-beam 746 of the elevator. Pneumatic actuation is preferable due to the speed and responsiveness with which the elevator needs to manipulate shuttles and also the simplicity of allowing vertical compliance.

Furthermore, during a laying action, the pneumatic cylinder provides vertical compliance to the end effector by venting its ram ports thereby allowing the end effector to continue to descend slightly as the block makes contact with a surface.

The lower track comprises fixed track sections 755 and 756 which are mounted to the side plates 743, 744 of the frame and movable track sections 757, 758 which are configured to move up and down with the elevator. The upper track comprises fixed track sections 751, 754 which are mounted to the frame and a movable track section 752 having an arm 753 able to pivot relative to the side plates via a spring-loaded hinge. Movable track section 752 is therefore a pivotable track section that acts like a trap door.

When the shuttle drives onto the end effector, its wheels are engaged to movable lower track elements 757, 758. After completing a laying action, the empty shuttle is raised by the elevator via the moveable lower track elements 757, 758. As the shuttle is raised, its wheels will contact the pivotable upper track section 752 causing it to pivot up about the hinge. The lower track sections 757, 758 continue to elevate until they are in alignment with the fixed upper track sections 751, 754 to form a continuous upper track that the shuttle is now on. At this point, the shuttle can drive off of the upper track of the elevator. Once the shuttle has driven off sections 757 and 758, the elevator is lowered so that another loaded shuttle can drive onto the lower track of the end effector for the next laying action. It should be noted that as a wheel moves off track section 757 onto track section 754, the track section 752 rotates back down, allowing the elevating track to descend. Once the laying arm has brought the end effector back to a neutral position whereby the tracks of the end effector are in alignment with tracks on the support tower/ancillary structure, the shuttle can drive off of the end effector.

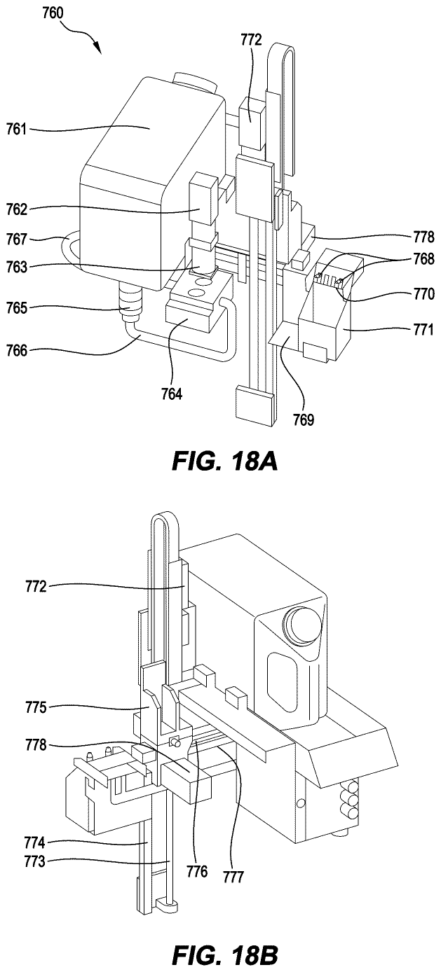

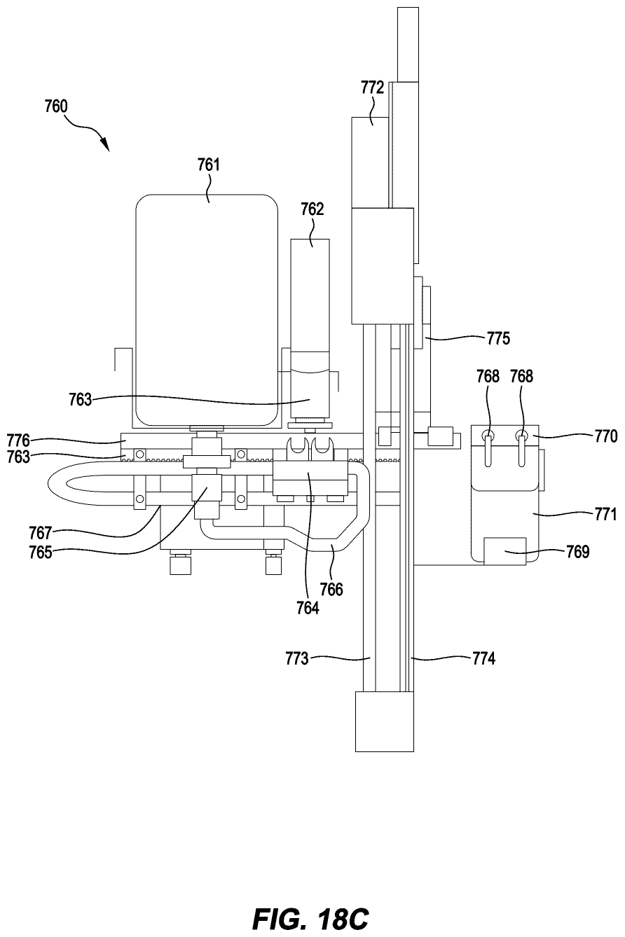

An example of an adhesive application system 760 shall now be described with reference to FIGS. 18A to 18C. The adhesive application system 760 is mounted to the support tower 700 of the block laying robot 40 and is for applying adhesive to a block just before the shuttle carrying the block drives onto the end effector.

The adhesive application system 760 includes an adhesive canister 761 with a store of adhesive. The canister may be any suitable size and in examples may hold 10L, 15L or 20L of adhesive such as 1K Polyurethane (Suprasec, Durabond, Dryfix, Sikaflex), 2K Polyurethane (Sikaflex), Polyurea, Epoxy (Araldite), Polyester (Bondo), Methacrylate (Plexus), Cyano Acrylate (Super glue, Loctite), Acrylic (Gyprock Glue), Silicone, TPU (Thermo Plastic Polyurethane) and Liquid Nails.

The canister 761 is mounted on a bracket (not shown) that is mounted to an arm of the support tower. Adhesive is fed from the canister 761 via gravity through a dry break coupler 765 (which assists in preventing the adhesive from curing prematurely if the hose or canister is disconnected) and into an inlet line 766 that runs into an inlet of a gear pump 764. An electric servo motor 762 drives the gear pump 764 via a gearbox 763 and adhesive is pumped out of an outlet of the gear pump 764 into outlet line 767 to a nozzle assembly which dispenses it onto the lower surface of a block.

In the example shown, the nozzle assembly includes a pair of nozzles 768 that are angled by slots in a guide plate 770 attached to a nozzle mount 769. A drip container 771 may be mounted to the nozzle mount 769 beneath the nozzles 768 to capture any adhesive that drips down.

The position of the nozzle assembly is adjustable in accordance with a block type. The nozzle is positioned in two axes, across the block and vertically to the correct application width and height by servo motors. A vertical servo motor 772 drives a trapezoidal threaded rod 773 whilst a horizontal servo motor 778 drives a pinion engaging in a rack 777. A carriage 775 is slidable coupled to a vertical rail 774 and configured so that actuation of the servo motor 772 causes the carriage 775 and nozzle assembly to adjust its height. The nozzle assembly is connected to a further rail 776 and rack 777 and the carriage 775 is mounted to a linear bearing block coupled to the rail 776. Actuation of the servo motor 778 mounted to the carriage 775 causes the rail 776 and nozzle assembly to move laterally.

The nozzle lateral location should be aligned with the correct rib or face shell of the block. It is anticipated that the lateral position of the nozzle will be constant for each block type. The pump motor 762 is controlled to apply adhesive in synchronisation with the shuttle carrying a block passing over the nozzle outlet. A sensor may detect the start and end of the block as the shuttle passes over the nozzle outlet which triggers the pump to dispense adhesive, or alternatively a position of the shuttle in the machine is used to trigger the pump to dispense adhesive based on timing and travel distance for the shuttle to arrive at and move across the nozzle outlet.

In order to achieve a repeatable adhesive signature, a precise dose of adhesive can be dispensed onto a block using the fixed displacement gear pump. A dispensed quantity of adhesive can be measured and/or verified for every block via a camera and lighting system that images an adhesive signature for each block and an image processor that determines the quantity of adhesive dispensed.

Other examples of adhesive application systems suitable for use with the machine are described in Applicant's co-pending applications WO2022/006635 and WO2020/047573.

### Saw Module

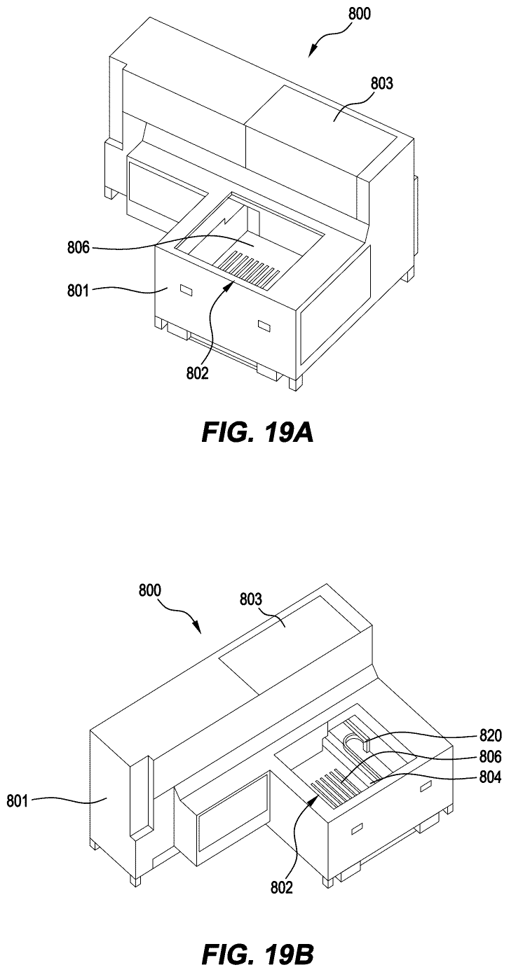

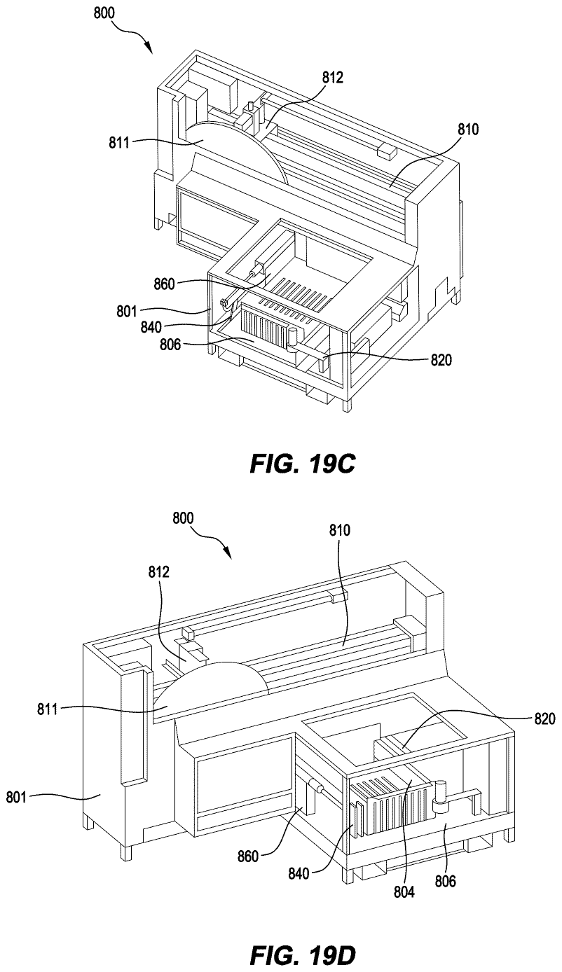

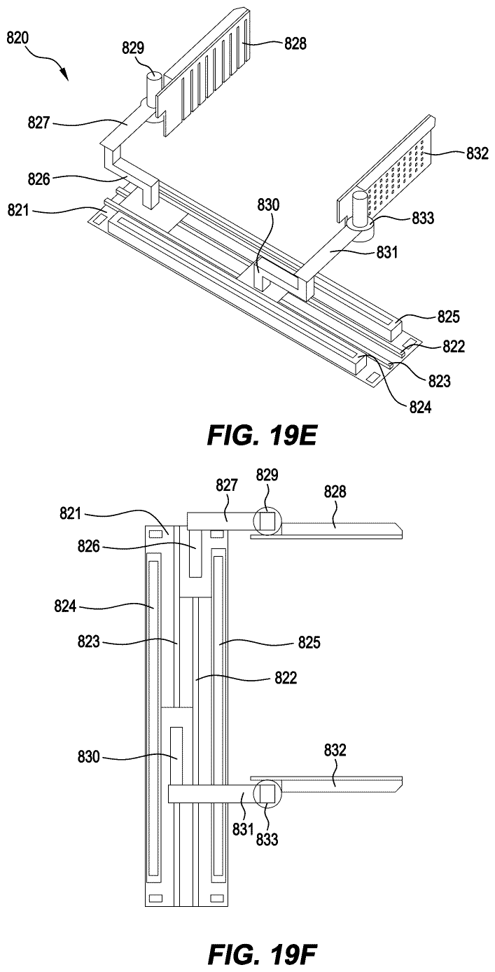

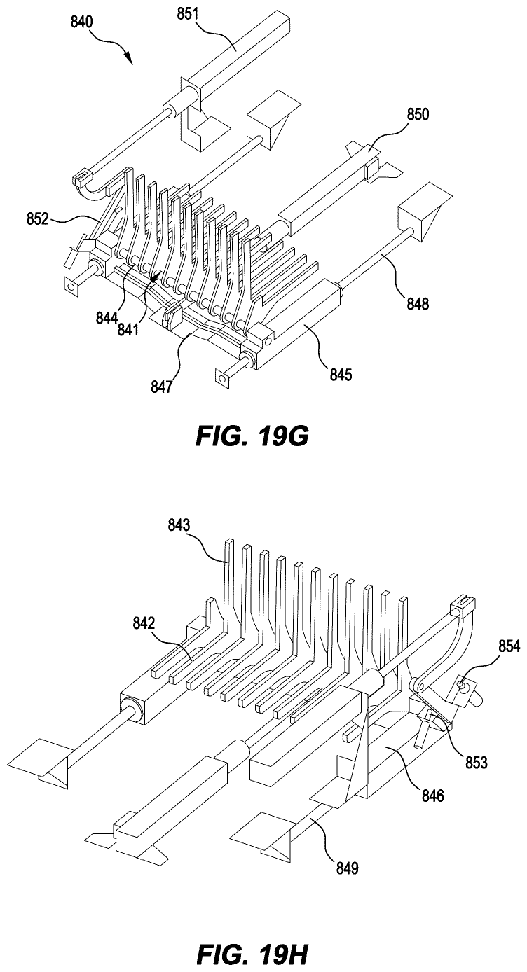

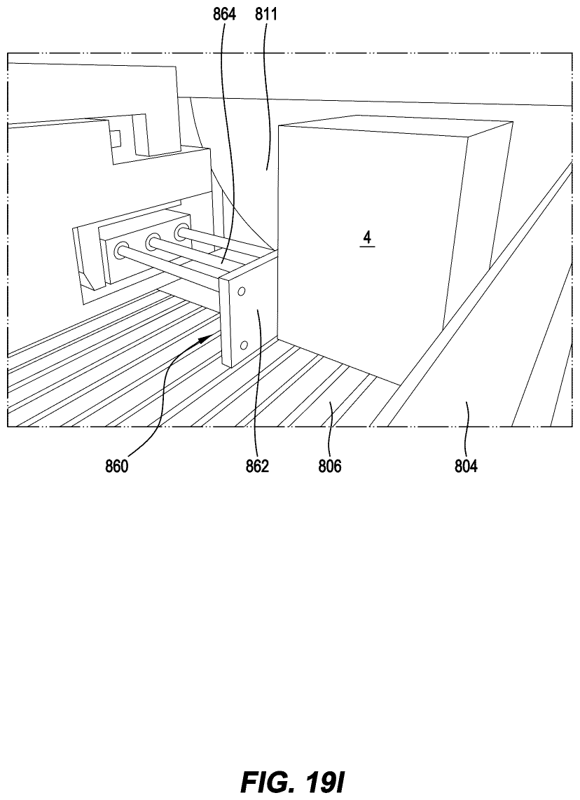

An example of an optional saw module 800 that may be installed in the base of the machine shall now be described with reference to FIGS. 19A to 19I. The illustrated saw module 800 is a multi-functional saw capable of cutting blocks square to length, with mitres, with gable mitres and it can also cut blocks to a reduced height. These cuts can be completed on blocks up to 600×300×400 mm (L×W×H).

In this example, a gantry saw is provided having a wet diamond blade of 1000 mm diameter (water cooled to remove dust and lubricate the blade to maximise blade life).

The saw module 800 includes a base frame 801 and a gantry saw including a gantry rail 810 mounted to the base frame 801 and a gantry frame 812 coupled to a saw blade 811 and motor. The gantry frame 812 is slidably mounted to the gantry rail 810 for translation therealong in the X-direction. The position of the gantry frame 812 and blade 811 in FIGS. 19C and 19D is in a home position. When actuated (e.g. by a chain drive), the gantry frame 812 and blade 811 move across to a cutting position. The frame proximate the gantry rail 810 includes a slidable door 803 which opens when the transfer robot loads a block into the saw to provide clearance for the boom or gantry of the transfer robot 60. Once the transfer robot 60 has moved away, the slidable door 803 closes again to enclose the blade 811 whilst cutting.

The saw module 800 includes a loading area 802 having a slotted cutting plate 806 disposed proximate a floor of the base frame 801 onto which blocks for cutting are placed and from which cut blocks are subsequently retrieved by the transfer robot. Once a block has been placed in the loading area 802, it is manipulated to move it into a desired position and orientation for cutting in accordance with the type of cut required.

Two block translator mechanisms are provided for this manipulation. A first block translator 820 is provided adjacent the cutting plate 806 which is operable to move the block in a direction orthogonal to the cutting direction of the saw blade 811 (i.e. a Y-direction translator). The first block translator 820 is shown in more detail in FIGS. 19E and 19F.

The first block translator 820 includes an elongate base 821 having a pair of rails 822, 823 mounted thereon. A first carriage 826 is slidably engaged onto rail 822 and is driven linearly along the base 821 via a servo pneumatic drive 825. The first carriage 826 has a first arm 827 mounted thereto. A first paddle 828 is rotationally coupled to the end of the first arm 827. The first paddle 828 is rotatable about the end of the first arm 827 via a Twinspin driven by a motor 829 mounted at the end of the first arm 827. A second carriage 830 is slidably engaged onto rail 823 and is driven linearly along the base 821 via a servo pneumatic drive 824. The second carriage 830 has a second arm 831 mounted thereto. A second paddle 832 is rotationally coupled to the end of the second arm 831. The second paddle 832 is rotatable about the end of the second arm 831 via a Twinspin driven by a motor 833 mounted at the end of the second arm 831.

The paddles 828, 832 have a generally rectangular plate like form suitable for pushing blocks along the cutting plate 806, although first paddle 828 is slotted to allow fingers of a block flipping mechanism 840 to pass through as will be described in further detail below with reference to FIGS. 19G and 19H.

The first block translator 820 is therefore able to push blocks along the cutting plate 806. When a block is loaded into the loading bay 802 of the saw module 800, the first paddle 828 is used to push the block along to position it in the correction position in the Y-direction for the cutting blade 811 of the saw to make an appropriate cut. Once the block has been cut, the second paddle 832 is used to push the cut block in the opposite direction back into the loading bay 802 for the transfer robot to pick up and remove from the saw module 800.

As described above, the paddles 828, 832 are independently movable in both linear translation and also rotation. To achieve a mitre or gable cut, the first paddle 828 will contact the block and rotate in order to change the angle of the block on the cutting plate 806 to the desired angle for the saw to make the angled cut. After cutting, the second paddle 832 can be used to rotate the cut block back to a straight orientation for pick-up.

A second block translator 860 may also be provided as shown in FIGS. 19C, 19D and 19I. The second block translator 860 is configured to push a block in the X-direction of the saw (i.e. direction of travel of the saw blade 811). The second block translator 860 includes a push plate 862 (see FIG. 19I) driven by a pneumatic cylinder 864 and guide rods which extend the push plate 862 in and out across the cutting plate 806. Typically, the saw module 800 includes a hard fence 804 that runs alongside the cutting plate in the Y-direction of the saw (orthogonal to cutting direction of the saw blade). The second block translator 860 is used to push a block up against the fence 804 which provides support to the block during cutting. The second block translator 860 may remain extended during cutting to effectively clamp the block against the fence to ensure it is restrained from moving.

As shown in more detail in FIGS. 19G and 19H, the saw module 800 further includes a block rotating mechanism 840. The block rotating mechanism 840 is located in the loading area 802 and used to rotate a block standing on its base over onto its side. In this way, a block can be oriented on its side to allow the saw blade 811 to cut the block along its height (i.e. a horizontal cut as opposed to a vertical cut to length). This mechanism may also be used for gable cuts with the block rotated by the paddles 828, 832.

The block rotating mechanism 840 includes a finger assembly 841 comprising a plurality of spaced apart L-shaped fingers rigidly coupled to a rotator bar 844. Each of the L-shaped fingers includes first and second elongate members 842, 843 that extend orthogonally away from the rotator bar 844. The finger assembly 841 is rotationally mounted to bushings 845, 846 coupled to opposing ends of the rotator bar 844. The bushings 845, 846 are joined by a bracket 847 and are translatable along guide rods 848, 849. A first pneumatic cylinder 850 is used to control translation of the block rotating mechanism 840 in the Y-direction.

A second pneumatic cylinder 851 is coupled to a lever arm 852 connected to the rotator bar 844. Actuation of the cylinder 851 causes the finger assembly 841 to rotate. The rotation is limited by stops 853, 854 that contact the lever arm 852.

The finger assembly 841 is aligned with the slots in both the cutting plate 806 and also the first paddle 828 so that it can freely travel through these parts. Typically, part of its fingers are horizontally disposed beneath the cutting plate 806 whilst part of its fingers protrude through the cutting plate 806 and are vertically disposed. In use, if a block needs to be rotated, the cylinder rod of the first cylinder 850 is retracted which translates the finger assembly 841 whilst concurrently causing the lever arm 852 to pivot and rotate the finger assembly 841 so that the vertically disposed finger elements are part way along the cutting plate 806. The block is then placed onto the cutting plate 806 between the vertically disposed finger members and the first paddle 828. The cylinder rod of the second cylinder 851 is then retracted which pivots the lever arm 852 causing the finger assembly 840 to rotate the block onto its side. The same process happens in reverse when a cut block is rotated back upright as it is being returned to the loading bay for pick-up.

Typically, the saw module 800 also includes a reject chute to eject waste offcuts and another block rotating mechanism to automatically empty offcuts into the reject chute.

### Hydraulic System

The machine uses hydraulic actuation to move high loads.

In one example, the machine has a hydraulic system which operates the outrigger deployment, boom lift and luff.

The hydraulic system includes a main variable displacement piston pump that is driven by either the diesel engine or by an electric motor. In diesel engine driven mode, the diesel engine drives a gearbox mounted Power Take Off (PTO) connected to a long driveshaft which in turn drives the pump and also an electric motor/generator to generate electric power.

In electric motor driven mode, shore power (e.g. site power at a building site) turns the electric motor/generator which drives the hydraulic pump. In this mode, the PTO is isolated from the turning drive shaft by a clutch because the PTO bearings and PTO internal clutch plates are not designed to function with a stationary motor and turning drive shaft because they require pressurised oil for lubrication, which is supplied by the gearbox which must be turned by the engine to provide oil pressure.

The machine has a proportional hydraulic system and the pump can operate in either Load Sense (LS) mode or Constant Pressure (CP) mode. Each function has only a single proportional control valve.

The hydraulic system has comprehensive safety features to provide a CAT 3 safety architecture with monitored double block and bleed valves for pressure isolation and load holding valves mounted on relevant cylinders.

The outrigger movement is controlled by a machine operator with direct lever actuated proportional valves. This significantly simplifies and improves the operation and safety of the outriggers compared to the PLC controlled outriggers used on Applicant's earlier machine.

The hydraulic components are combined onto a single module (as much as possible). The module includes the electric motor/generator, pump, cooler, controlled proportional valves, filter and oil tank.

### Electrical System

The electrical system includes a generator driven by the truck diesel engine. The electrical system can be powered by the diesel generator or by shore power. The hydraulic pump can be run by an electric motor as described above. The machine can operate completely electric and hydraulic without the diesel engine running.

The electrical system is distributed across the modules. The modules are designed to be able to operate as independently as possible. The main power distribution is in an electrical cabinet mounted in the base of the machine along with an additional switch board.

The generator can act as a motor to power the hydraulic pump. The generator is connected to a Siemens Variable Speed Drive (VSD) for using it in motor mode and it is connected to an Inverter for using it in generator mode. In one example, the servo drives for the motors are Elmo Twitter drives. The twitter drives are more compact than the Whistle and Guitar drives and include Functional Safety Over EtherCAT (FSOE).

The various modules, drives and Input/Output (IO) communicate by EtherCAT. There are multiple Beckhoff TwinCAT masters running on multiple IPCs. As far as is practicable, modules are connected by hybrid cables that carry 170 VDC, 24 VDC and EtherCAT communications in a single cable. In one example, connectors are bayonet fittings. An additional Ethernet communication channel is provided by Xingterra communication over powerline carried by the 24 VDC distribution.

A cooling system may also be installed in the base to provide chilled water to cool electronics. The cooling system typically has a tank, a pump and a refrigerated chiller. The machine typically has chilled water plumbed to electrical enclosures and cabinets. Some enclosures are inconvenient to supply with chilled water and in these areas, cooling is provided by thermo-electric (Peltier) coolers.

### Control System

In one example, the machine uses a soft Programmable Logic Controller (PLC) and Computer Numeric Control (CNC) architecture provided by Beckhoff. The Beckhoff TwinCAT control system includes TwinCAT PLC, TwinCAT CNC and TwinSAFE components.

In one example, the machine uses the TwinCAT PLC soft PLC. The PLC is implemented as software on an IPC (Industrial PC). The PLC includes Numeric Control (NC) functionality to allow simple point to point motion. The PLC handles IO and logical sequencing.

The machine uses eight TwinCAT 3 PLCs and an Arduino Raspberry Pi CM4 PLC running PiCAT with IgH EtherCAT Master for each shuttle. Modules operate as independently as is practicable and communicate with a supervisory PLC running on a supervisory IPC. The supervisory IPC runs a database server which communicates information to and from the supervisory PLC.

Module PLCs communicate with the supervisory PLC via interfaces which share common elements and also have custom elements as required. Communication is via the MQTT protocol running over Ethernet carried by Xingterra communication over powerline operating on top of the 24V power distribution. Realtime data is communicated by EtherCAT.

Modules that have CNC functionality run or create their required G code programs. The machine uses the TwinCAT CNC soft CNC. The CNC is implemented as software on an IPC (Industrial PC). The CNC functionality implements complex motion. The above described machine is modular and the modules that have TwinCAT CNC are the transfer robots, boom and block laying robot.

The machine uses the Applicant's core Dynamic Stabilisation Technology (DST) which corrects the pose of a robot so that the end effector is positioned and orientated accurately in a work coordinate system, regardless of the position and orientation of the robot base and regardless of deflection or dynamic movement of the robot structure. DST measures the six degree of freedom (6DOF) position and orientation of the support tower of the block laying robot (or the end effector itself). The position and orientation is measured by data received from a laser tracking system and optionally data from an Inertial Measurement Unit (IMU). In one embodiment, the position and orientation data is fed to the control system which combines the measurement data with a state model in a Kalman filter. The control system compares the actual position and orientation with a desired position and orientation and calculates a movement correction which is applied by the block laying robot in order to minimise positioning error and therefore stabilise the end effector in real time. DST enables construction robots with long booms to stabilise end effectors on robots at the end thereof in challenging outdoor environments.

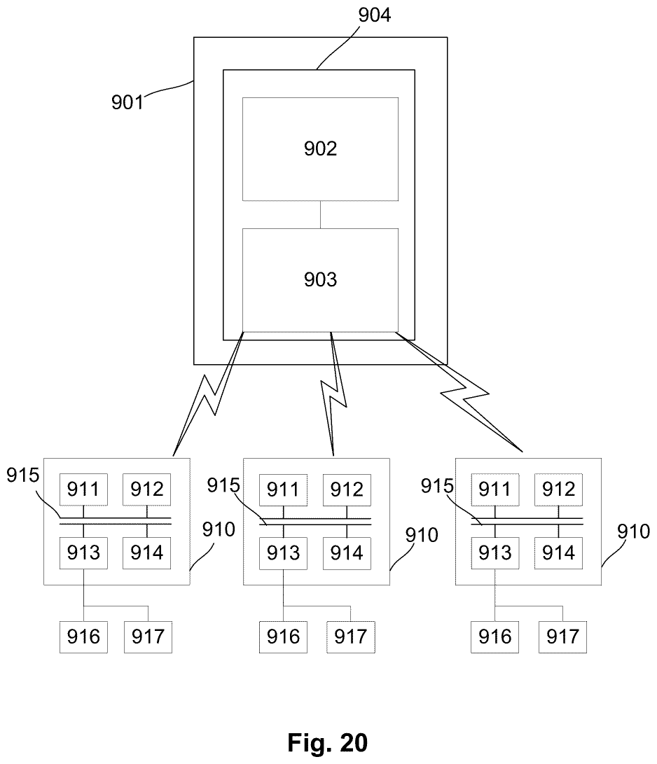

Referring now to FIG. 20, there is shown an example of a schematic diagram of a control system for controlling a fleet of shuttles for use in the robotic block laying machine. The control system includes a supervisory IPC (Industrial PC) 901 running a soft supervisory PLC (programmable logic controller) 904 implemented as software (e.g. Beckhoff TwinCAT PLC). The supervisory PLC 904 includes a central controller 902 configured to manage a schedule of jobs that the robotic block laying machine is required to perform for a given build. The central controller 902 issues job requests to modules and coordinates movement of shuttles and tracks. The central controller 902 issues job requests to a shuttle fleet controller 903 which is a software module running on the supervisory PLC 904 and implemented as a collection of TwinCAT PLC code objects (Function Blocks, Functions etc.).

The shuttle fleet controller 903 receives instructions indicative of job requests for shuttles from the central controller 902 and provides shuttle status information to the central controller 902. Furthermore, the shuttle fleet controller 903 sends instructions to a shuttle to perform the job requested by the central controller 902 and receives status information from each shuttle 910. The shuttle fleet controller 903 is therefore responsible for managing the network of shuttles and coordinating motion thereof in conjunction with the central controller 902 which is responsible for sequencing tasks and moving tracks etc.

The shuttle fleet controller 903 communicates with each shuttle 910 in the system over a wireless communication network such as Wi-Fi. Data is sent between the shuttle fleet controller 903 and each shuttle 910 via an MQTT broker. An MQTT broker is an intermediary entity that enables MQTT clients to communicate. Specifically, an MQTT broker receives messages published by clients, filters the messages by topic, and distributes them to subscribers. Accordingly, MQTT brokers enable the publish/subscribe communication model which makes this a highly efficient and scalable protocol suitable for shuttle communications in a fleet of up to 30 shuttles.

The supervisory IPC additionally includes an SQL database server 905 which includes a shuttle manager database 906 used by the shuttle fleet controller 903 to manage movement of the fleet of shuttles and store variables such as shuttle position, last known reference, shuttle charge status etc.

In the example shown in FIG. 20, the shuttle 910 includes an electronic processing device 911 forming part of a processing system including the electronic processing device 911, such as a microprocessor, a memory 912, input/output (1/0) device 123, such as I/O cards for sensors 916 (e.g. proximity and collision avoidance sensors) and actuators 917 such as clamps and motors, and one or more interfaces 914, interconnected via a bus 915. The interfaces 124 may be of any form and can include a wireless receiver and transmitter enabling the shuttle 910 to communicate with the shuttle fleet controller 903 over a wireless communication network such as Wi-Fi, a Universal Serial Bus (USB) port, Ethernet port etc. In use, the processing device 911 receives instructions from the shuttle fleet controller 903 via the interface 914, optionally storing these in the memory 912. The processing device 911 then processes the signals in accordance with instructions stored in the memory 912, for example in the form of software instructions, to thereby control the shuttle and execute clamping and motion tasks for example to execute shuttle loading, datuming, travel and laying.

However, this is for the purpose of example only, and it will be appreciated that the electronic processing device 911 can include any form of electronic processing device that can receive and process signals from the shuttle fleet controller 903. Accordingly, the electronic processing device can include any one or more of a microprocessor, microchip processor, logic gate configuration, firmware optionally associated with implementing logic such as an FPGA (Field Programmable Gate Array), a suitably configured computer system, or any other electronic device, system or arrangement capable of receiving and processing the signals. In one example, each shuttle includes an Arduino Raspberry Pi microcontroller.

The processing device 911 is a primary controller for implementing most shuttle local control tasks. In some embodiments, the shuttle further includes a secondary controller configured to control power supply to the primary controller and brake the drive motor in case of primary controller unavailability.

It will be appreciated that the processing device 911 is configured to wirelessly receive instructions from the shuttle fleet controller 903 indicative of a movement request; control a drive system on-board the shuttle to execute the movement request; and, wirelessly send status information back to the shuttle fleet controller 903 at least in part indicative of a status of the movement request.

Furthermore, the processing device is configured to cause clamps to open or close in accordance with instructions received from the shuttle fleet controller. For example, the shuttle may receive a command to move to a loading location in the storage bay and once at the loading location open its clamps ready to receive a block of a designated size. It will then receive an instruction that the loading job has been completed enabling it to close its clamps to thereby grip the block. Accordingly, the processing device 911 is configured to one of: open a clamp to a specified width; and close the clamp to a specified width and clamp a block to a specified force.

In use, the shuttles travel along tracks disposed between the base and block laying robot. The tracks comprise send and return tracks to accommodate shuttles travelling to the block laying robot and returning to the base. In one example, the tracks comprise fixed and movable track sections, wherein the movable track sections comprise tracks that one of translate or rotate (such as the elevators and translator in the storage bay and carousel, tower, luff and shuttle rotator at the laying head). As the shuttle travels through the system, it constantly sends status information back to the shuttle fleet controller 903 indicative of its position on the track system to enable the central controller 902 to coordinate shuttle movement with the movable tracks. If a track is not ready to receive a shuttle, a stop or wait command will be requested causing the shuttle to decelerate and stop until further commanded. If the movable track section is ready to receive a shuttle, then the shuttle will be commanded to continue travelling for one or more further track sections towards its final destination.

Typically, each shuttle has wheels which h engage the track sections, and the drive system includes one or more motors that actuate the wheels. The processing device 911 sends signals to the motor drive to cause the motor to turn and thereby move the shuttle along the track in accordance with instructions from the shuttle fleet controller 903.

Each shuttle includes one or more sensors 916 including sensors for use in referencing a shuttle position along the track, the sensors detecting striker targets distributed along the track wherein the detection causes the one or more processing devices 911 to capture an encoder position of a shuttle drive motor. As previously described, the one or more sensors are one of: an inductive proximity sensor on each shuttle that detects metallic striker targets installed along the track, and, an optical sensor on each shuttle that detects reflective striker targets installed along the track.

Typically, the shuttle 910 reports its position to the shuttle fleet controller 903 as distance travelled relative to the last position reference it captured. As previously described, each position reference has a unique identifier and a movement request indicative of a move from a current position to a final position includes a list of position reference identifiers including a starting position reference identifier, a requested final position reference identifier and any intermediate position reference identifiers that the shuttle will detect between its current position and its final position. As the shuttle executes its movement request, each position reference it senses will be stored in memory 912 and communicated to the shuttle fleet controller 903, thereby enabling the shuttle fleet controller 903 to keep track of every shuttle in the network.

The processing device 911 is further configured to manage charging of batteries on-board the shuttle and report charge status information to the shuttle fleet controller 903. Every cycle through the machine, shuttles typically receive charge whilst in the storage bay which has charging rails contactable with an electrical pick-up on each shuttle.

Whilst travelling in the system, each shuttle monitors any objects in its path (both forward and rear) using collision avoidance sensors and the processing device 911 is configured to: monitor signals received from the collision avoidance sensors; and, control the drive system to modify speed or brake the motor in accordance with the received signals to ensure that collisions with other shuttles or objects are avoided.

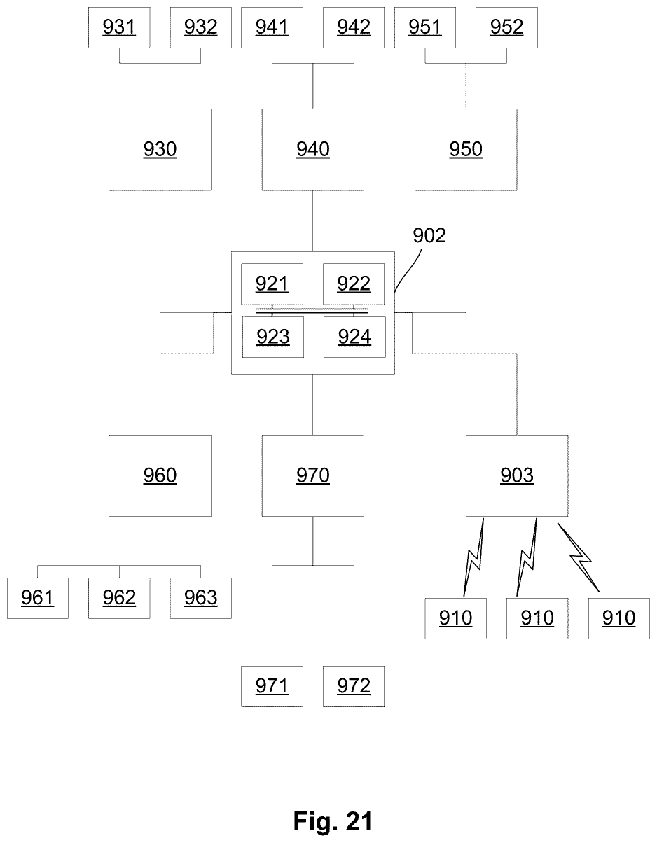

Referring now to FIG. 21, there is shown a schematic diagram of a control system for use in controlling the robotic block laying machine.

In this example, a central controller 902 is provided in communication with a shuttle fleet controller 903 which in turn communicates wirelessly with a fleet of shuttles 910 as previously described. The central controller 902 further communicates with each module controller 930, 940, 950, 960, 970 in the machine which receives instructions and executes commands locally at each module. For simplicity, not all modules are shown in this diagram and only some modules will be described for purpose of illustration only. As shown, the control architecture is distributed with each module controlling its own functions independently from the others and executing job requests from the central controller 902. The system is therefore highly modular enabling modules to be interchangeable without impacting any other part of the system.

As previously described, the control system includes a supervisory IPC (Industrial PC) running a soft supervisory PLC (programmable logic controller) implemented as software (e.g. Beckhoff TwinCAT PLC). The supervisory PLC includes the central controller 902 configured to manage a schedule of jobs that the robotic block laying machine is required to perform for a given build.

In the example shown in FIG. 21, the central controller 902 includes an electronic processing device 921 forming part of a processing system including the electronic processing device 911, such as a microprocessor, a memory 921, input/output (1/0) device 923, and one or more interfaces 924, interconnected via a bus 925. The interfaces 124 may be of any form and can include a Universal Serial Bus (USB) port, Ethernet etc. In one example, the central controller 902 communicates with each module via EtherCAT to enable real time communications. In use, the processing device 921 sends instructions to the module controllers 930, 940, 950, 960, 970 and shuttle fleet controller 903 via the interface 924 indicative of job requests required to sequence tasks for a build, and receives signals indicative of status information from each module, optionally storing this in the memory 912 or database server (not shown). The processing device 921 then processes the received signals in accordance with instructions stored in the memory 922, for example in the form of software instructions, to thereby control the modules and shuttles to ensure jobs are sequenced correctly.

In one example, the control system includes one or more electronic processing devices configured to: control a shuttle to cause the shuttle to move from the base to the block laying robot via the boom to thereby transport a block to the block laying robot; control the boom to cause the boom to move the block laying robot to a position required to lay a block; control the block laying robot to cause the block laying robot to: position an end effector adjacent a distal end of the boom to receive the shuttle; position the shuttle proximate a block laying location so that the shuttle can release the block and thereby lay the block; position the end effector adjacent the distal end of the boom to allow the shuttle to return to the boom; and, control the shuttle to cause the empty shuttle to return along the boom to the base.

In one example, the one or more processing devices includes a: central controller 902 configured to manage a schedule of jobs that the robotic block laying machine is required to perform for a given build; and, a shuttle fleet controller 903 that: communicates with the central controller 902 including: receiving instructions indicative of job requests for shuttles; providing shuttle status information to the central controller 902; and, communicates wirelessly with each shuttle 910 in the fleet including: sending instructions to a shuttle to perform the job requested by the central controller 902; and, receiving status information from the shuttle 910.

As previously described, the one or more processing devices further include at least one shuttle controller provided in each shuttle, the at least one shuttle controller being configured to control the shuttle 910 in accordance with commands from the shuttle fleet controller 903. The at least one shuttle controller is configured to control a drive system on-board the shuttle to execute a movement request, cause clamps to open or close in accordance with instructions received from the shuttle fleet controller 903, and manage charging of batteries on-board the shuttle and report charge status information to the shuttle fleet controller 903.

The at least one shuttle controller causes status information to be provided to the shuttle fleet controller 903 including information derived from one or more sensors for referencing a shuttle position along the track, the sensors detecting striker targets distributed along the track wherein the detection causes the shuttle controller to capture an encoder position of a shuttle drive motor. Additionally, the control system may include sensors that detect a position of the shuttle in the machine, and wherein the one or more processing devices are configured to control the shuttles in accordance with signals from the sensors. In one example, the sensors are distributed along the tracks and used to confirm a presence of a shuttle at a designated location. These sensors may communicate data to the central controller 902 over EtherCAT.

The central controller 902 in the control system may further include a boom controller 930 configured to control the boom in accordance with commands from the central controller 902; and, a block laying robot controller 940 configured to control the block laying robot in accordance with commands from the central controller. The boom controller 930 controls one or more boom actuators 931, 932 in the form of hydraulic cylinders and servo motors controlling lift, luff and boom and stick extension to cause the boom to move to a desired position. Typically, control of the boom is via CNC control with boom DST stabilisation controlled via PLC. The block laying robot controller 240 controls one or more laying arm actuators in the form of servo motors which control the respective axes of the block laying robot. Typically, control of the block laying robot is via CNC control with laying arm DST stabilisation controlled via PLC.

The one or more processing devices are further configured to control the at least one transfer robot to: pick individual blocks from a pack of blocks; and transfer each block to a respective one of the plurality of shuttles located at a loading position in a base of the machine. In one example, a pair of transfer robots are provided to concurrently pick blocks from packs and transfer them to shuttles. The one or more processing devices include transfer robot controllers 950, 970 configured to control transfer robot actuators 951, 952, 971, 972 such as servo motors and the like of the transfer robot in accordance with commands from the central controller 902. Typically, control of the transfer robot is via CNC control with clamping control via NC.

The one or more processing devices are further configured to control the plurality of pack conveyers that move packs of blocks forward in the base of the machine to an empty pack station. The one or more processing devices include a pack conveyer controller 960 configured to control pack conveyer actuators 961, 962, 963 to move the pack conveyers in accordance with commands from the central controller 902. Typically, control of the pack conveyers is via PLC/NC control.

Although not shown, the one or more processing devices may further include: at least one shuttle elevator controller configured to move a shuttle between levels of the storage bay in accordance with commands from the central controller; and, a shuttle translator controller configured to move shuttles into and out of the storage bay. Additionally, there may be provided a carousel slew controller configured to control rotation of the carousel about the tower; and; one or more carousel rotator controllers configured to control rotation of the carousel rotators to enable transfer of shuttles between the carousel and tower and shuttle translator respectively. The pallet ejector and saw modules may also have respective controllers to execute commands from the central controller 902.

Accordingly, the above describes a robotic block laying machine and a number of different features and configurations thereof. This provides a number of different arrangements which can be used independently and/or in conjunction.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciated that numerous variations and modifications will become apparent. All such variations and modifications which become apparent to persons skilled in the art, should be considered to fall within the spirit and scope that the invention broadly appearing before described.

1) A control system for a robotic block laying machine used in constructing a block structure, the robotic block laying machine including a plurality of shuttles that transport blocks from a base of the machine to a block laying robot via a boom, the control system including one or more processing devices configured to:
a) control a shuttle to cause the shuttle to move from the base to the block laying robot via the boom to thereby transport a block to the block laying robot;
b) control the boom to cause the boom to move the block laying robot to a position required to lay a block;
c) control the block laying robot to cause the block laying robot to:
i) position an end effector adjacent a distal end of the boom to receive the shuttle;
ii) position the shuttle proximate a block laying location so that the shuttle can release the block and thereby lay the block; and,
iii) position the end effector adjacent the distal end of the boom to allow the shuttle to return to the boom; and,
d) control the shuttle to cause the empty shuttle to return along the boom to the base.

2) The control system according to claim 1, wherein the shuttles travel along tracks disposed between the base and block laying robot.

3) The control system according to claim 2, wherein the tracks comprise send and return tracks to accommodate shuttles travelling to the block laying robot and returning to the base.

4) The control system according to claim 2 or claim 3, wherein the tracks comprise fixed and movable track sections.

5) The control system according to claim 4, wherein the movable track sections comprises tracks that one of translate or rotate.

6) The control system according to claim 5, wherein the one or more processing devices includes a:
a) central controller configured to manage a schedule of jobs that the robotic block laying machine is required to perform for a given build; and,
b) a shuttle fleet controller that:
i) communicates with the central controller including:
(1) receiving instructions indicative of job requests for shuttles; and,
(2) providing shuttle status information to the central controller; and,
ii) communicates wirelessly with each shuttle in the fleet including:
(1) sending instructions to a shuttle to perform the job requested by the central controller; and,
(2) receiving status information from the shuttle.

7) The control system according to claim 6, wherein the one or more processing devices further include at least one shuttle controller provided in each shuttle, the at least one shuttle controller being configured to control the shuttle in accordance with commands from the shuttle fleet controller.

8) The control system according to claim 7, wherein the at least one shuttle controller is configured to control a drive system on-board the shuttle to execute a movement request.

9) The control system according to claim 7 or claim 8, wherein the at least one shuttle controller is configured to manage charging of batteries on-board the shuttle and report charge status information to the shuttle fleet controller.

10. The control system according to any one of claims 7 to 9, wherein the at least one shuttle controller is configured to cause clamps to open or close in accordance with instructions received from the shuttle fleet controller.

11. The control system according to any one of claims 7 to 10, wherein the at least one shuttle controller causes status information to be provided to the shuttle fleet controller.

12. The control system according to claim 11, wherein the control system includes sensors that detect a position of the shuttle in the machine, and wherein the one or more processing devices are configured to control the shuttles in accordance with signals from the sensors.

13. The control system according to claim 12, wherein the sensors are distributed along the tracks and used to confirm a presence of a shuttle at a designated location.

14. The control system according to claim 13, wherein each shuttle further includes one or more sensors for use in referencing a shuttle position along the track, the sensors detecting striker targets distributed along the track wherein the detection causes the shuttle controller to capture an encoder position of a shuttle drive motor.

15) The control system according to claim 14, wherein the one or more sensors are one of:
a) an inductive proximity sensor on each shuttle that detects metallic striker targets installed along the track, and,
b) an optical sensor on each shuttle that detects reflective striker targets installed along the track.

16) The control system according to claim 14 or claim 15, wherein status information including shuttle position is sent from each shuttle to the shuttle fleet controller which provides this information to the central controller to enable it to coordinate movement of track sections and other modules of the machine.

17) The control system according to claim 16, wherein the shuttle further includes:
a) a wireless transmitter used to send the status signal to the shuttle fleet controller over a wireless communication network such as Wi-Fi; and,
b) a wireless receiver used to receive commands from the shuttle fleet controller over a wireless communications network such as Wi-Fi.

18. The control system according to claim 17, wherein the shuttle reports its position to the shuttle fleet controller as distance travelled relative to the last position reference it captured.

19. The control system according to claim 18, wherein each position reference has a unique identifier and wherein when the central controller issues a job request for a shuttle to move from its current position to a final position, the central controller provides to the shuttle fleet controller a list of position reference identifiers including a starting position reference identifier, a requested final position reference identifier and any intermediate position reference identifiers that the shuttle will detect between its current position and its requested final position.

20. The control system according to claim 19, wherein during movement, the shuttle controller tracks which position reference identifier was most recently detected and the list of position reference identifiers it is expected to detect whilst completing a current movement request.

21) The control system according to any one of claims 6 to 20, wherein the one or more processing devices further include:
a) a boom controller configured to control the boom in accordance with commands from the central controller; and,
b) a block laying robot controller configured to control the block laying robot in accordance with commands from the central controller.

22) The control system according to any one of the claims 6 to 21, wherein the one or more processing devices are configured to control at least one transfer robot to:
a) pick individual blocks from a pack of blocks; and
b) transfer each block to a respective one of the plurality of shuttles located at a loading position in a base of the machine.

23. The control system according to claim 22, wherein a pair of transfer robots are provided to concurrently pick blocks from packs and transfer them to shuttles.

24. The control system according to claim 22 or claim 23, wherein the one or more processing devices include a transfer robot controller configured to control the transfer robot in accordance with commands from the central controller.

25. The control system according to any one of claims 6 to 24, wherein the one or more processing devices are configured to control a plurality of pack conveyers that move packs of blocks forward in the base of the machine to an empty pack station.

26. The control system according to claim 25, wherein the one or more processing devices include a pack conveyer controller configured to control the pack conveyers in accordance with commands from the central controller.

27. The control system according to any one of claims 6 to 26, wherein the one or more processing devices are configured to control a shuttle sequencing system provided in the base of the machine, the shuttle sequencing system including a shuttle storage bay including multiple levels of tracks on which shuttles are driven and stored when not in use; one or more shuttle elevators controlled to move shuttles to a different level track of the storage bay; and, a shuttle translator controlled to move shuttles into and out of the shuttle storage bay.

28) The control system according to claim 27, wherein the one or more processing devices include:
a) at least one shuttle elevator controller configured to move a shuttle between levels of the storage bay in accordance with commands from the central controller; and,
b) a shuttle translator controller configured to move shuttles into and out of the storage bay.

29. The control system according to claim 27 or claim 28, wherein the robotic block laying machine includes:
a) a tower rotatably mounted to the base about a boom slew axis, the tower supporting the boom and wherein the boom is pivotally connected to the tower; and,
b) a carousel aligned concentrically with the boom slew ring at the base of the tower, the carousel being rotatable about the tower and including a plurality of radially spaced apart carousel rotators, each configured with two pairs of tracks, wherein the control system is configured to control the rotators to:
i) receive a loaded shuttle from the shuttle translator and enable the loaded shuttle to drive onto a tower track section; and,
ii) receive an empty shuttle from a tower track section and enable the empty shuttle to drive onto the shuttle translator.

30. The control system according to claim 29, wherein the one or more processing devices include:
a) a carousel slew controller configured to control rotation of the carousel about the tower; and;
b) one or more carousel rotator controllers configured to control rotation of the carousel rotators to enable transfer of shuttles between the carousel and tower and shuttle translator respectively.
